(19) United States
(12) Patent Application Publication
(10) Pub. No.: US 2009/0183254 A1
(43) Pub. Date: Jul. 16, 2009

(54) Computer Session Management Device and System

(75) Inventors: Solomon Franco, Tel-Aviv (IL); Monique Franco, Tel-Aviv (IL); Clifton Herman Hicks, JR., Northville, MI (US); Vycheslav Ivanov, Farmington Hills, MI (US); Joseph Rogozinski, Ramat-Gan (IL); Steve Nolan, Huntington Woods, MI (US); Richard Ross, Brighton, MI (US); Avsholom Elimelech, Tel-Aviv (IL); Jason Price, Medina, OH (US); Bob Miller, Cleveland, OH (US)

Correspondence Address: MARTIN D. MOYNIHAN d/b/a PRTSI, INC., P.O. BOX 16446, ARLINGTON, VA, 22215, US

(73) Assignee: Atomynet Inc., Farmington Hills, MI (US)

(21) Appl. No.: 12/087,124

(22) PCT Filed: Dec. 27, 2006
(86) PCT No.: PCT/IL2006/001497

§ 371 Date: Nov. 17, 2008

Related U.S. Application Data
(60) Provisional application No. 60/753,395, filed on Dec. 27, 2005.
(60) Provisional application No. 60/850,253, filed on Oct. 10, 2006.

(30) Foreign Application Priority Data
Dec. 27, 2005 (IL) PCT/IL2006/000117

(51) Int. Cl. H04L 9/32; G06F 21/00; H04L 9/00; G06F 21/22

(52) U.S. Cl. 726/17; 710/300; 713/182; 713/193; 714/E11.121; 726/26

(57) ABSTRACT

A portable session management device configured for insertion into an input on a host computer, the portable session management device comprising: an authentication unit configured to obtain authentication of the user portable session management device with respect to the host computer; and a safe access unit operatively associated with the authentication unit and configured to facilitate safe access to at least one computer-based application in conjunction with the host computer.

### FIELD AND BACKGROUND OF THE INVENTION

The present invention relates to portable computer session management data devices. More specifically, the present invention relates to portable computer session management devices that are configured, inter alia, to: provide single point safe access to at least one computer-based application in conjunction with a host computer, encrypt data on the host computer, facilitate data backup, provide parameters for child computer use, provide parameters for computer use by members of a group and/or provide secure data transfer between remotely located members of a group.

Handheld solid state memory storage devices that plug into a USB computer port, herein portable session management devices, have become an important addition to present-day computer devices, offering fast, on-the-fly download, transfer and/or backup of data. Portable session management devices, however, are not problem free.

If a portable session management device is stolen, sensitive data can fall into the wrong hands. Additionally, data maintained on a portable session management device that is lost may present the user with an irreplaceable loss of data.

Further, a portable session management device may be plugged into a computer to rapidly download, and thus steal, confidential files, presenting a tremendous security risk.

Encryption software that potentially prevent data theft from computers and/or portable session management devices, are known. However, software packages that provide backup functions are typically packaged separately from software packages that provide data encryption and each requires its own user setup, configuration and management; a rather cumbersome approach to securing data.

Portable session management devices that incorporate encrypted partitions are known: U.S. patent application Ser. No. 10/304,772 (Ziv, et al), filed 27 Nov. 2002, now published as US 2004/0103288; and U.S. Provisional Patent Application 60/643,150, (Oh, et al) filed 13 Jan. 2005 and now published as U.S. 2006/0156036, teach portable data storage devices having encrypted and non-encrypted memory storage partitions, but fail to provide backup protection of the data.

A problem associated with computers in general is transferring data to remote locations, for example through a wide area network or the Internet. When data encryption is used, encryption codes that are formulated at a home location must be transferred to user computers at remote locations; facilitating interception by unauthorized recipients. The intercepted codes are then used to track, highjack and unencrypt transferred data.

Additionally, computer-resident Trojan horse programs are capable of unencryption and transferring data to unauthorized recipients, thereby allowing, for example, access to sensitive military data by unauthorized organizations that may compromise public safety.

In general, portable session management devices:
fail to provide a single point for safe access to computer-based applications in conjunction with a host computer;
lack adequate protection of data stored on the device;
present an identification problem when transferring encrypted files and/or encryption codes; and
present a theft hazard to computer storage systems containing sensitive data.

In addition to the above problems with portable session management devices, there are multiple problems that specifically affect Internet users:

1) Protection from Internet scams; and

2) Limiting user access to Internet web sties, for example preventing staff from wasting company time or preventing children from accessing adult web sites.

With respect to Internet protection, following a typical Internet session, there is a record of temporary Internet files and cookies that serve as beacons to attract computer scammers, junk mail, and computer viruses, as well as providing a forensic trail to allow third parties to investigate the internet browsing of a given computer user.

Software programs that erase Internet records from storage devices are known. However, such programs are generally limited in their ability to completely hide browsing history.

With respect to Internet access, software that limits access by children to adult Internet sites is known. However, because the software resides on the computer, it is often a tempting and easy target for circumvention by a computer-savvy child.

There is thus a widely recognized need for solving a wide range of problems associated with session management devices, data transfer, and Internet access, and it would be highly advantageous to provide devices configured to be devoid of the above limitations.

### SUMMARY OF THE INVENTION

The present invention successfully addresses the shortcomings of present known devices by providing a portable session management device comprising an authentication unit configured to provide authentication of its user on a host computer and, conditional upon authentication of the user, to safely access at least one computer-based application in conjunction with the host computer.

In embodiments, to facilitate authentication of the user identity, the user is provided with an activation screen on the host computer in which unique user identifiers are input. Following authentication, the portable device is configured to substantially seamlessly manage data sessions, including: providing safe access to at least one computer-based application in conjunction with the host computer; encrypting and decrypting data on the host computer; and safely backing up data.

Additionally, in secure internet surfing embodiments, the portable session management device of the present invention is configured to maintain all temporary Internet files and cookies on the management device during the Internet session, thereby protecting the host computer from Internet scams and viruses.

Following the session, the entire surfing record is concealed and/or encrypted on the portable session management device, thereby retaining the record virtually invisibly, and thus inaccessible, to an unauthorized user of the portable device, with no record left on the computer.

In a secure data transfer embodiment, the present invention provides a coupling device configured to download a common encryption code setting to multiple portable session management devices, for example, to members of a select group. The portable session management devices are later used to download and transfer encrypted data between group member devices located in remote locations.

By maintaining all encryption codes and engines on the portable session management devices, and not on the host computer, the encryption codes, and associated transferred data, cannot be hijacked, for example, by Trojan horses.

In an embodiment in which parameters for use of a computer by a child are provided, the present invention provides a parent portable session management device that configures a child portable session management device to restrict computer child access to Internet sites, instant messaging, chat rooms and e-mails.

In embodiments, the child host computer cannot be accessed without insertion of the child portable session management device, thereby preventing the child from circumventing the parent restriction parameters.

In further embodiments, the parent device configures a memory device to maintain a history of visited Internet sites, chat rooms, instant messaging, blogs and/or e-mails for review by the parent. Additionally, the parent device is optionally configured to send alert messages to the parent and/or shut down the host computer when the child violates restriction parameters.

In still further embodiments, the parent device is configured for use by an administrator of a group and the child device is configured for use by members of the group. The group devices are configured by the administrator device with guidelines for using the computers into which the member devices are inputted.

In embodiments, the guidelines comprise time restraints, for example related to Jewish religious observance of Sabbath and Holy days when active use of the computer is proscribed and responsible persons may wish to restrict computer usage.

According to an aspect of the instant invention, there is provided a portable session management device configured for insertion into an input on a host computer, the portable session management device comprising: an authentication unit configured to obtain authentication of the user portable session management device with respect to the host computer; and a safe access unit operatively associated with the authentication unit and configured to facilitate safe access to at least one computer-based application in conjunction with the host computer.

In embodiments, the portable session management device includes a concealed encryption engine configured to operate with the host computer on encryption of user-selected data thereon.

In embodiments, the portable session management device includes a concealing engine configured to operate with the host computer on concealing a portion of data thereon.

In embodiments, the condition comprises concealing the portion of data after expiration of authentication by the authentication unit.

In embodiments, the portable session management device is configured to reveal the concealed portion upon re-authentication.

In embodiments, the concealed portion of data comprises a data partition configured by the device.

In embodiments, the portable session management device further comprises a concealed encryption engine configured to encrypt at least a portion of the data.

In embodiments at least a portion of the data is encrypted.

In embodiments, the portable session management device is configured to unencrypt the encrypted data on the host computer provided the user authentication is in force.

In embodiments, the portable session management device includes a backup manager configured, conditionally upon the user authentication, to open communication with a remote server through the host computer to allow data backup operations on the remote server.

In embodiments, the portable session management device includes a backup manager configured, conditionally upon the user authentication, to open communication with a server through the host computer to allow data backup operations on the server.

In embodiments, the backup is continuous while the authentication is in force. In embodiments, the portable session management device is configured to conceal at least a portion of the data on the server.

In embodiments, the portable session management device is configured to encrypt at least a portion of data on the server.

In embodiments, the data backup operations are based upon user-selected parameters. In embodiments, the at least a portion of the data backup operations are provided incrementally.

In embodiments, the portable session management device is configured to establish a connection with a proxy server. In embodiments, the server is located at a remote location with respect to the host computer.

In embodiments, the portable session management device is configured to communicate with the server at the remote location using at least one of a wide area network, an Internet channel, a server, and a proxy server. In embodiments, the authentication includes a digital string comprising at least one of: a session management device identifier, a user login name, and a user password.

In embodiments, the portable session management device is configured to hash the digital string on at least one of: the portable session management device, the host computer, a proxy server, and the server.

In embodiments, the portable session management device is configured to register the digital string with a registration entity.

In embodiments, the device authentication is configured to be optionally invalidated by the registration entity.

In embodiments, the portable session management device is further configured to conceal a session of Internet surfing from an inspection carried out from the host computer.

In embodiments, the portable session management device is further configured to authorize payment for at least one item to be purchased electronically using funds from a digital banking station.

In embodiments, the portable session management device is further configured to provide at least one of funding a digital banking station with funds from a user-designated digital funding source, and supply a physical location to receive shipment of the at least one item.

In embodiments, the portable session management device is configured to shut down the host computer when the authentication is not obtained.

In embodiments, the portable session management device is configured to maintain a record of access when the authentication is not obtained.

In embodiments, the record is maintained on at least one of: a portable session management device, the host computer, a proxy server, and a server.

According to another aspect of the present invention, there is provided a coupling device for coupling a plurality of portable session management devices. The coupling device comprises multiple inputs for two portable session management devices, one first session management device, and at least one second session management device, each of the two portable session management devices having a respective concealed encryption engine, a common encryption engine setting transfer unit operatively associated with the multiple inputs, and configured to transfer a common setting from the one first session management device to the at least one second session management device.

In embodiments, the coupling includes an authentication unit configured to determine the identities of the at least two session management devices for future authentication.

In embodiments, the coupling device is configured so that the one first session management device is set up as an administrator device configured to issue the settings to the at least one second session management device.

In embodiments, the coupling device includes an operating function to wipe settings therefrom after use.

In embodiments following removal of the two session management devices from the coupling device, the two session management devices are configured to communicate during a first meeting using the common setting, and communication takes place between locations that are remote from each other.

In embodiments during the first meeting, the two session management devices are configured to generate a second common setting, thereby enabling a second meeting from multiple remote locations.

In embodiments, the coupling device includes a rechargeable power source connected to an input configured to removably connect to a charge-providing source that recharges the rechargeable power source.

According to a further aspect of the present invention, there is provided a portable session management device configured as a parent management device that enables a child session management device. In embodiments, the enabling comprises providing parameters for a computer session on a host computer into which the child session management device is inserted, and recording a history of the computer session.

In embodiments the history is stored on at least one of: the host computer, the child device, the parent device, and a remote server.

In embodiments, the parent session management device is configured to access the history using at least one of: a wide area network, an Internet channel, a local server, and a proxy server.

In embodiments, the child session management device is configured to recognize parameter violations during the computer session.

In embodiments, the recognized parameter violations are in the form of at least one of: digital text key word input, password input, secondary Internet sites reached via a primary Internet site, periodically taken screen shots, and video streaming throughout the session.

In embodiments, the recognized parameter violations are in the form of characters displayed on a graphic interface.

In embodiments, the recognized parameter violations are included in at least one of an Internet site, a chat room, instant messaging, a blog, and an e-mail.

In embodiments, the recognized parameter violations are established through at least one of: the parent device, and a rating service.

In embodiments when a parameter violation is recognized, the child session management device is configured to provide at least one of: shut down the host computer, and shut down at least one of the Internet site, chat room, instant messaging, blog, and the e-mail.

In embodiments when a parameter violation is recognized, the child session management device is configured to generate a warning message to the parent session management device.

In embodiments, the child session management device is configured to request a change in at least one parameter to the parent device.

In embodiments, the parent session management device is configured to change at least one parameter using at least one of: the wide area network, the Internet channel, the local server, the parent session management device, and the proxy server.

In embodiments, the parent session management device is configured to change at least one parameter while the child session management device and the parent device are connected to the host computer.

In embodiments, the parent session management device is configured to provide at least one time parameter during which the child session management device activates the host computer.

In embodiments, the parent session management device is configured to provide a least one goal parameter whose attainment allows the child session management device to activate a reward from the group comprising: extended computer use, access to designated computer games, and access to designated Internet sites.

In embodiments, the parameters include allowing access to at least one of: an Internet site, a chat room, instant messaging, a blog, and an e-mail.

In embodiments, the parameters include preventing access to at least one of: an Internet site, a chat room, instant messaging, a blog, and an e-mail.

In embodiments, the portable session management device includes multiple child session management devices issued to multiple members of a group, and the parent session management device is issued to a group administrator.

In embodiments, the group administrator session management device is configured to prevent at least one of the multiple members of the group from receiving communications during a period of time.

In embodiments, the session management devices of the multiple members are configured to prevent receiving communications during a period of time.

In embodiments, the group administrator session management device is configured to prevent at least one of the multiple members of the group from transmitting communications during a period of time.

In embodiments, the period of time is related to religious observance.

According to still another aspect of the present invention, there is provided a method of providing session management, comprising the steps of plugging a portable session management device into a host computer, obtaining authentication that the portable session management device is allowed to access the host computer, and accessing at least one computer-based application using the host computer, conditionally upon the authentication.

According to still another aspect of the instant invention, there is provided a method for providing session management between portable session management devices, the method comprising: providing a setting exchange device having multiple inputs for communication between multiple portable session management devices, inserting multiple portable session management devices into the multiple inputs, each of the devices having a concealed data encryption engine, and configuring each concealed data encryption engine with a common encryption setting for concealed communication between the portable session management devices or hosts thereof.

According to a further aspect of the instant invention, there is provided a method for monitoring computer use, comprising: providing a portable parent session management device, configuring a portable child session management device using the parent session management device, inputting the portable child session management device into a host computer thereby to guide use of the host computer using the configured parameters.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

As used herein, the terms “comprising” and “including” or grammatical variants thereof are to be taken as specifying the stated features, integers, steps or components but do not preclude the addition of one or more additional features, integers, steps, components or groups thereof. This term encompasses the terms “consisting of” and “consisting essentially of”.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.
The term “method” refers to manners, means, techniques and procedures for accomplishing a given task including, but not limited to, those manners, means, techniques and procedures either known to, or readily developed from known manners, means, techniques and procedures by practitioners of the computer science arts.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The inventions described herein include portable session management devices that are configured, inter alia, to hide and/or encrypt data on a host computer and provide data backup; provide parameters for child computer use; and provide secure data transfer between remotely located members of a group; are herein described, by way of example only, with reference to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A shows components of a typical portable session management device;

FIG. 1B shows the portable session management device of FIG. 1A being plugged into a computer;

FIGS. 1C-1F show an overview of the functions of the portable session management device, provided through the computer of FIG. 1B, in accordance with embodiments of the invention;

FIG. 2 shows networking and connection options of the portable session management device and computer of FIG. 1B, in accordance with embodiments of the invention;

FIGS. 3-10 show displays of user options provided by the portable session management device and computer of FIG. 1B, in accordance with embodiments of the invention;

FIGS. 11-22B show flowcharts of options presented in FIGS. 1C-10, in accordance with embodiments of the invention.

FIGS. 23A-23D show flowcharts implementing parental computer supervision over a child, in accordance with embodiments of the invention;

FIGS. 24-30 show a portable session management device registration process, in accordance with embodiments of the invention;

FIG. 31 shows implementation of standard backup, in accordance with embodiments of the invention;

FIG. 32 shows implementation of incremental backup, in accordance with embodiments of the invention;

FIG. 33 shows implementation of a Secure PC lock, in accordance with embodiments of the invention;

FIG. 34 shows implementation of session management, in accordance with embodiments of the invention;

FIG. 35 shows implementation of anonymous surfing, in accordance with embodiments of the invention;

FIG. 36 shows implementation of parental control lock, in accordance with embodiments of the invention;

FIGS. 37-39 show implementation of anonymous subscription service, in accordance with embodiments of the invention;

FIGS. 40-42 show implementation of an anonymous Internet purchasing service, in accordance with embodiments of the invention;

FIG. 43 shows implementation of a secure instant messaging feature, in accordance with embodiments of the invention;

FIG. 44 shows implementation of a multi-factor authentication, in accordance with embodiments of the invention;

FIG. 45 shows receipt and activation of a replacement portable session management device, in accordance with embodiments of the invention;

FIGS. 46-47 show implementation of a system to notify a user of unauthorized computer use, in accordance with embodiments of the invention;

FIGS. 48-51 show a data exchange process between group members using secure session management, in accordance with embodiments of the invention;

FIGS. 52-58 and 60, 61 show the coupling device used in ensuring the secure session management of FIGS. 48-51, in accordance with embodiments of the invention;

FIG. 59 shows implementation of anti-virus features, in accordance with embodiments of the invention; and

FIGS. 62-73 show implementation of a system of computer use monitored by an administrator, in accordance with embodiments of the invention.

### DESCRIPTION OF THE PREFERRED EMBODIMENTS

The present embodiments relate to portable session management devices that provide single point safe access to a variety of computer-based applications; provide secure data transfer between remotely located members of a group; and provide parameters and monitoring of computer use by a child.

The principles and uses of the teachings of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

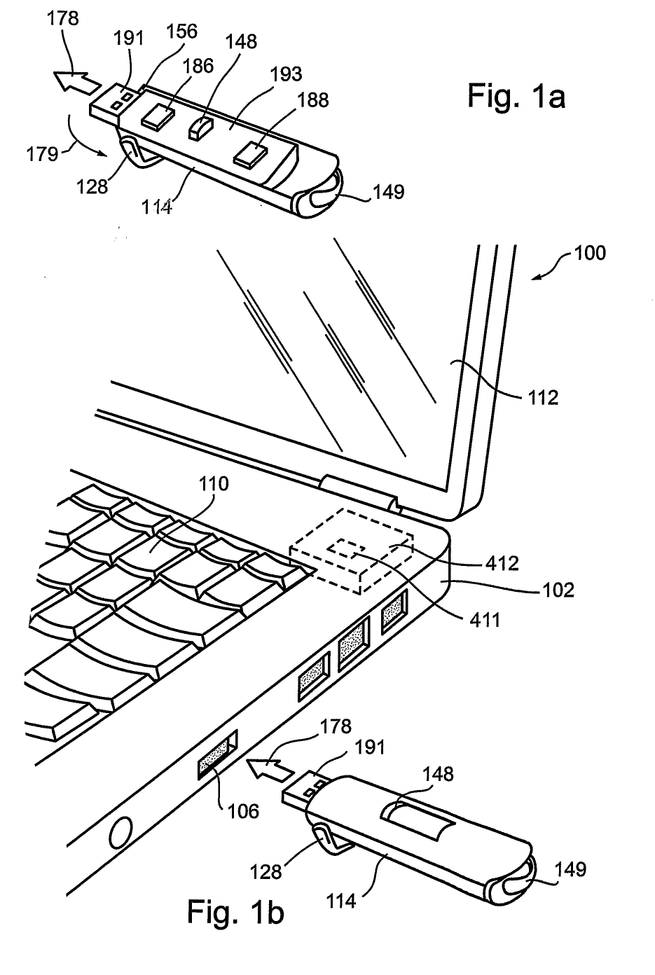

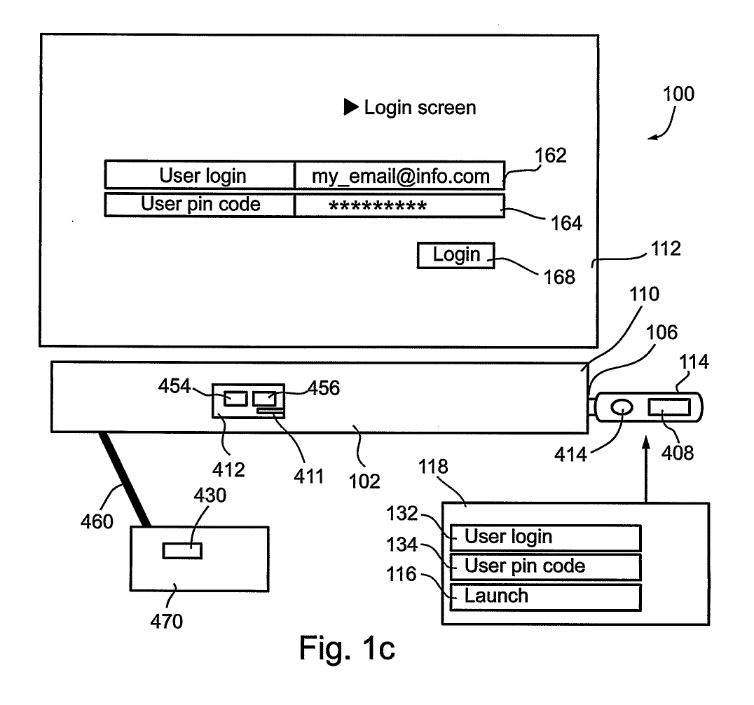

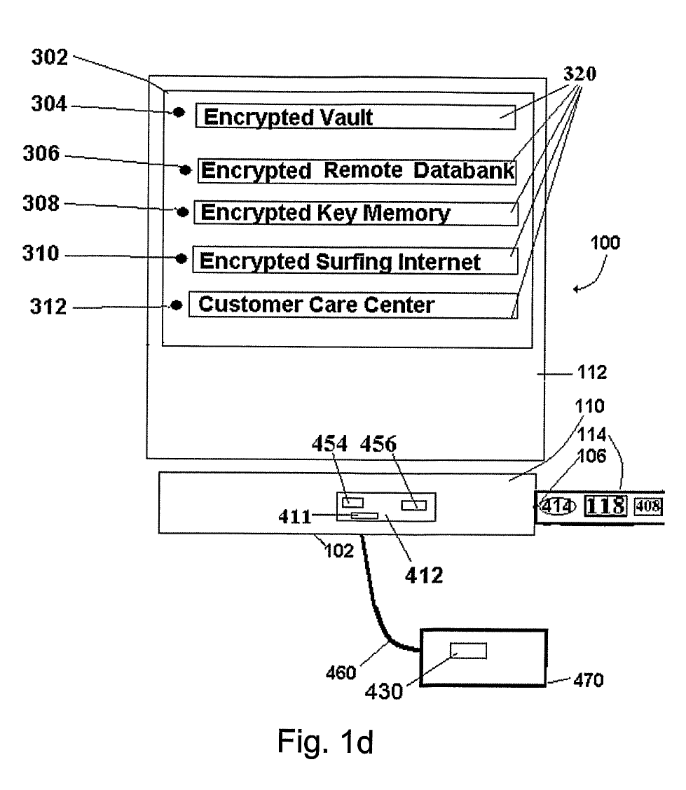

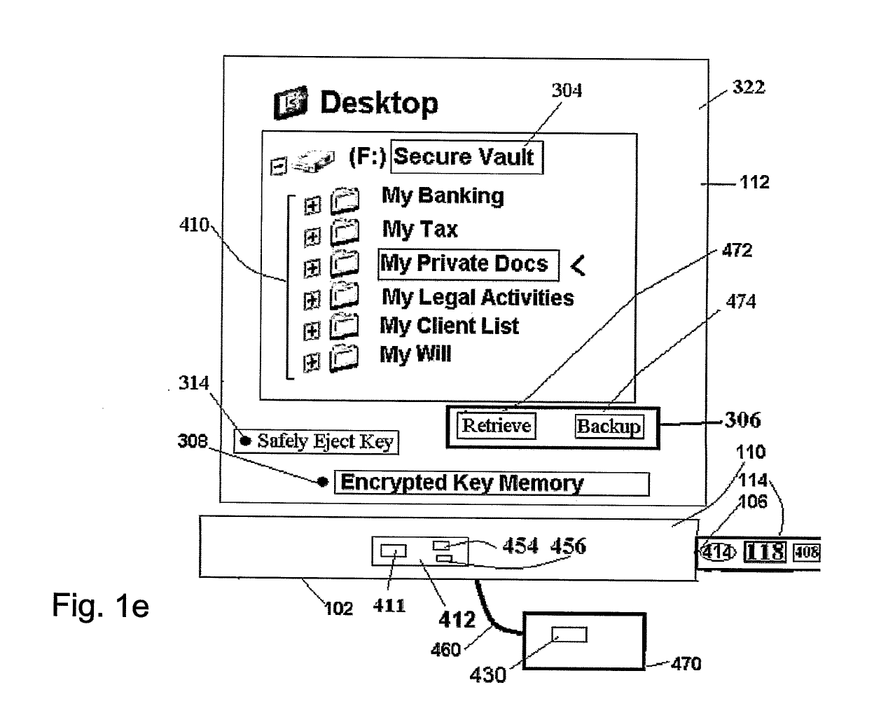

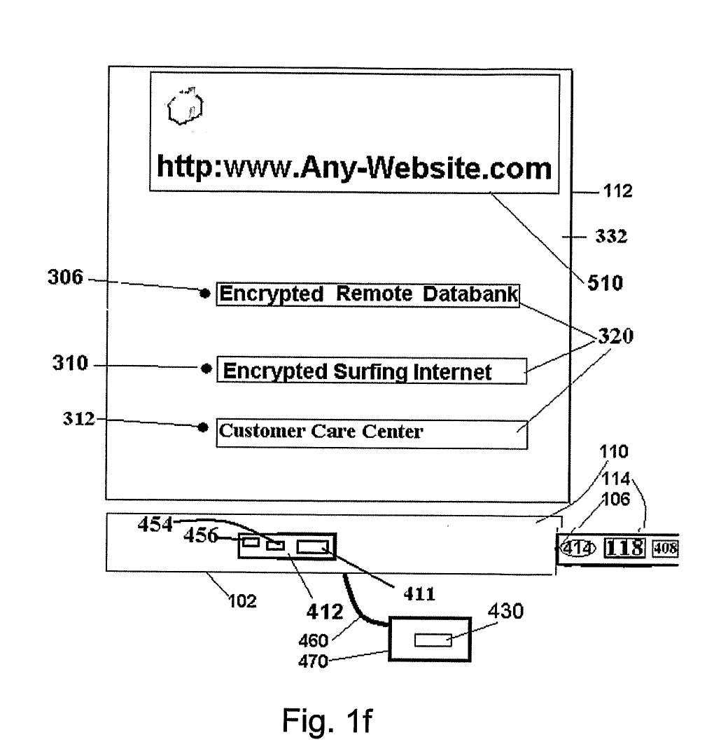

Referring now to the drawings, FIG. 1A shows an embodiment of a portable session management device 114 of the present invention, alternatively referred to herein as USB session management key 114 and/or USB key 114.

### Portable Session Management Device Overview

### Some Portable Session Management Device Features

Portable session management device 114 typically has a key ring connector 149 configured to hang on a key chain and a swivel cover 128 that, when in a forward position covers and protects a USB connector 191. With cover 128 in the downward position, a slide button 148 is pushed forward in a direction 178, for example with a thumb movement, thereby bringing USB connector 191 forward to a connection-ready position.

Portable session management device body 193 is connected to USB connector 191 and typically comprises, inter alia, a controller 186 and a flash memory 188.

In non-limiting embodiments, portable session management device 114 comprises a USB key manufactured by Acer®; the many options and manufacturers of portable session management devices 114 being well-know to those familiar with the art.

In non-limiting embodiments, the instant invention presents a portable session management device comprising a user USB device interface comprising portable session management device 114 optionally using a flash memory and/or USB protocol. However, USB is only one of the many user interfaces and protocols that may be used with computer 102, computing device, and/or any computer memory device. The scope of the present invention includes a priori, all available user interfaces, memory devices and protocols available today or in the future.

FIG. 1B shows a computer 100 comprising a laptop computer 102 having a keyboard 110, a screen 112, a memory storage 412, for example a hard drive, and portable session management device 114 input into a USB port 106. In embodiments, computer 102 comprises, for example, a Lenovo ThinkPad laptop or any portable and/or non-portable computing device available today or in the future.

In embodiments, session management device 114 includes an authentication unit 118, alternatively referred to as user access module 118, which obtains authentication that user portable session management device 114 is registered with host computer 102. Upon the authentication of the user, portable session management device 114 provides safe access to computer-based applications in conjunction with host computer 102.

As used herein, a “computer-based application” comprises, inter alia, use of any type of computing device to: execute and/or use any software program, transfer data between computing devices, encrypt data, backup data, provide safe surfing of the Internet, and/or authorize digital payment of funds. Further, as used herein, a “computer-based application” includes transfer of data via a wide area network, an Internet channel, a server and/or a proxy server.

As used herein, the term “safe”, with respect to accessing a computer-based application refers to substantially preventing access by, inter alia, Internet scams, spyware, spying, junk mail, computer viruses, and/or access by unauthorized users on computer 102, session management device 114, or any alternative computing device or computer memory device wherein session management device 114 has been authenticated.

While the input of computer 102 comprises USB port 106, the input could alternatively comprise a serial port, an infrared reception input, wireless communication port and/or any communication means existing today or in the future that facilitates communication between a so-configured portable session management device 114 and a computing means.

### Device Login

FIG. 1C shows a schematic diagram of portable session management device 114 plugged into computer 102. User access module 118 includes a user device login module 132, alternatively referred to a name module 132 that records a user login name; and a user device password code module 134, alternatively referred to as a password module 134 that records a user password.

User device login name module 132 and user device password code module 134 are encoded into user access module 118 during an initial set-up of portable session management device 114 as explained below.

Additionally, portable session management device 114 includes a unique device identifier 414 that is encoded into portable session management device 114 by the manufacturer as a resident digital string 454. Resident digital string 454, optionally together with the user login name and user password, is transferred to memory storage 412 during set-up of portable session management device 114. In embodiments, portable session management device unique device identifier 414 comprises a string of numbers and digits, whether encrypted or not.

Upon connection of portable session management device 114 to USB port 106, user access module 118 compares unique device identifier 414 with resident digital string 454 on memory storage 412, thereby preventing access to computer 102 by another portable session management device 114 that has not been registered with computer 102.

Upon successful match up between resident digital string 454 and unique device identifier 414, user access module 118 launches a display 302 (FIG. 1D) on computer screen 112, via a launcher module 116, that requests input of a display login name 162 and input of a display password code 164.

Following input of display login name 162 and display code 164, access module 118 compares display login name 162 with portable session management device user login name 132; and display password code 164 with portable session management device user password code 134.

Following successful matching, the user is prompted to press a “Login” button 168, thereby successfully logging into computer 102. Upon login, user access module 118 signals launcher module 116 to open a window 302 on screen 112, as seen in FIG. 1D.

In alternative embodiments, access module 118 associates with the auto run feature of Windows XP operating system by Microsoft Corporation to provide display 302.

In accordance with the embodiments of the present invention, once the user has been authenticated through the identification of the display login name 162 and display password code 164, any encryption or decryption process associated with the portable session management device 114 stores a hash value 456 along with each data packet, as explained below.

As used herein, the term “hash” refers to the creation of an encryption code associated with a portion of digital data.

As used herein, the terms “encrypt” and “encryption” refer to the coding of at least a portion of data, using at least one algorithm so as to prevent unauthorized inspection of the data. In further embodiments, inspection of the data is facilitated by an unencryption code comprising the same algorithm used in the coding of the data.

As used herein, there term “inspection” refers to accessing, reviewing, or determining information from any digital string or data portion stored on a computing device and/or memory storage device.

As used herein, the terms “conceal” and “concealing” refer to any obfuscation, encryption, or coding of data to prevent unauthorized inspection of the data.

As used herein, the terms “authentication” and/or “authenticate”, refer to, inter alia, verifying the integrity of a digital message or portion of data, and/or verifying the identity of a user who accesses a computing device and/or network; the verification including use of any password, biometric parameter, digital certificate, code and/or digital string.

In embodiments of the present invention after generation of hash value 456, the value is encrypted and stored on portable session management device 114, for example in a device memory storage 408.

In embodiments, hash value 456 associated with portable session management device 114 is sent, for example via a secure VPN connection, to a server 470, for example in a remote location, for storage in a secure encrypted user accessible vault 430.

In embodiments, launcher module 116 comprises a protocol written using the “.Net” platform program marketed by Microsoft Corporation, of Seattle, Wash. Alternatively, launcher module 116 comprises a U3 launching pad manufactured by the U3 Corporation of California, USA.

In alternative embodiments, launcher module 116, comprises one or more software programs, including software modules, software components, software libraries and/or software DLLs that, in turn, include computer instructions for the relevant operations that operate in conjunction with user access module 118 to provide the many services of portable session management device 114, some of which are detailed below.

The software programs operative with user access module 118 are optionally written in accordance with embodiments in the C, C++, C#, Java or other programming languages, and executed in connection with one or more operating systems, including but not limited to, Windows, Linux, or Unix platforms.

As seen in FIG. 1D, in a non-limiting embodiment, a window 302 on screen 112 provides the user with the following options via display buttons 320:
Access to a Secure Encrypted Vault 304;
Access to a Remote Storage Databank 306;
Access to a Secure Encrypted Device Memory 308;
Access to a Secure Surfing on the Internet 310; and
Access to a Customer Care Center 312.

The user selects one of the options on window 302, for example “Secure Vault” 304, and screen 112 displays the opening display associated with secure vault 304.

### Secure Vault

Secure vault 304, seen in FIG. 1E, displays a display vault 410 that contains folders and files contained in a secure vault 411 in computer memory storage 412. Secure vault 411 is accessible, herein mounted, hence readable on screen 112, as display vault 410, only as long as portable session management device 114 remains connected to computer 102.

Following successful login with portable session management device 114, secure vault 411 is retrieved by pressing a “Retrieve” button 472, following which the user can modify secure vault 411 by accessing display vault 410.

Upon opting to end a given session, including allowing and/or facilitating expiration of authentication during a given session, the user presses a “Safely Eject Key” button 314. After pressing button 314, all changes to display vault 410 are encrypted to secure vault 411 on memory storage 412, remaining totally invisible to anyone else accessing computer 102. In embodiments, secure vault 411 is defined on memory storage 412 by physical start and end addresses.

In embodiments, File Allocation Table (FAT) files and/or New Technology File System (NTFS) files are encrypted using a concealed encryption engine within the device so that there is no way that the computer can find the vault data without the device. The result is that virtually no vestige is left of any information having been entered into computer 102. In a further embodiment secure vault 411 and associated start and end addresses are encrypted upon disconnection of portable session management device 114. A reference remains to space used on memory storage 412 that includes the size of vaults 411, so that other programs do not inadvertently overwrite the data.

### Remote Databank

Remote Databank 306 ensures that data from secure vault 411, or any data chosen by the user, is backed up to server 470 as a backup file on remote vault 430 that is accessible only through successful login of portable session management device 114 in computer 102. Server 470 is located, for example, in a different city and is accessible through an Internet connection 460.

In embodiments, portable session management device 114 compares information and files in secure vault 411 on computer memory storage 412 with remote vault 430 at server 470 periodically throughout a given session. In embodiments, even when the user has not specifically chosen to access remote databank 306, files in secure vault 411 that have been changed are automatically backed up to secure vault 411 and/or remote vault 430.

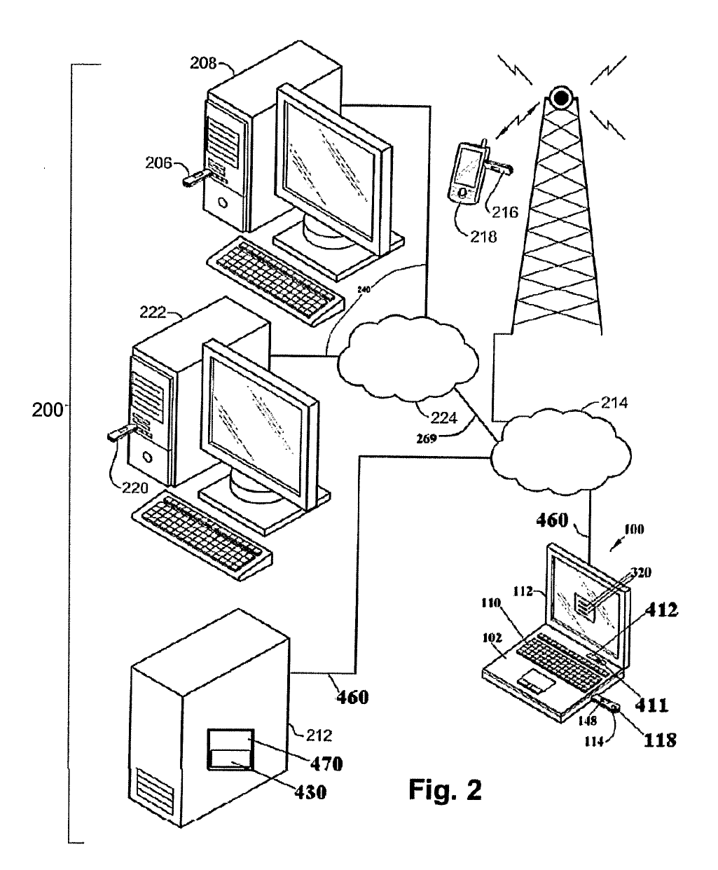

As used herein, the term “server” refers to any storage device employing magnetic, optical or alternative media, including, inter alia, server 470 and/or server 212 (FIG. 2), located locally and/or at a remote location; herein a remote server.

In embodiments, a window 322 apprises the user during a given session of all files and folders in secure vault 411 that are to be backed up either in secure vault 411 or in server 470. At the beginning of a following session, the user is optionally apprised of secure vault 411 changes that were changed in the first session.

In further embodiments, the user optionally configures portable session management device 114 to backup changes in displayed vault 410 to secure vault 411 on memory storage 412 and server 470 throughout a given session incrementally. Incremental backup allows significantly reduced communication between computer 102 and server 470, thereby maintaining computer 102 at optimal speed.

In other embodiments, at the end of the session, portable session management device 114 optionally queries the user whether to save changed files in secure vault 411 to remote vault 430 or to save secure vault 411 under new names in server 470. The latter option prevents overwriting of files in secure vault 411 that were present at the beginning of the session.

The information contained in server 470 is optionally retrieved on any computer 102 to which portable session management device 114 has been successfully logged into. In embodiments, following successful login, the user has the option to activate “Retrieve” button 472 to retrieve files from server 470.

The retrieval from server 470 is optionally used, for example, when the user is on vacation wherein computer 102 comprises a previously unregistered desktop computer with respect to portable session management device 114. The unregistered computer 102 may be located in a hotel or at any Internet provider site, for example an Internet café, or other locations.

During the session, portable session management device 114 continuously encrypts data. Upon finishing a given session, the user selects “Safely Eject Key” option 314 and data either in encrypted form or unencrypted form, is backed up to remote secure vault 430 and portable session management device 114 safely removes from computer 102. If the user wishes, secure vault 411 and associated display vault 410 are deleted from unregistered computer 102 so that when the user leaves an Internet café, there is no trace of any data from the user session on host computer 102.

In embodiments, if memory storage 412 becomes defunct, for example through what is referred to as a crash, the user accesses remote vault 430 and places data on a new memory storage 412 or another computer 102, thereby protecting and restoring all folders and files on secure vault 411 in spite of the crash.

### Key Memory

In embodiments, the user may use the “Secure Device Memory” 308 option to back up to secure vault 411 and/or backup secure vault 411 to encrypted device memory storage 408 in portable session management device 114. Data in device memory storage 408 is not accessible to anyone who cannot successfully log onto computer 102. Vault, files, and information from device memory storage 408, however, are available for the user to download on any computer 102 at any location following successful logon. If portable session management device 114 is lost or stolen, the user does not need to worry that sensitive information has fallen into the wrong hands due to encryption protocols, noted above, on portable session management device 114.

Optionally, device memory storage 408 is downloaded and encrypted to server 470 automatically through connection 460. When the user logs into computer 102 following replacement of lost device 114, even recently modified files in device memory 408 may be retrieved from server 470, thereby preventing loss of data following loss of portable session management device 114.

Moreover, portable session management device 114 provides the user the opportunity to work on files from device memory 408 even in a location that has no internet connection 460, for example during a vacation to a remote village.

### Customer Care Center

In the event the user has forgotten device login name 132 or device password code 134, the user optionally contacts Customer Care Center 312, seen in FIG. 1F, as displayed on a window 332. Alternatively, the user calls an operator located at Customer Care Center 312.

In embodiments, the user is required to provide either device login name 132 or device password code 134, optionally with device unique device identifier 414 and/or unique personal identification, for example the user's mother's maiden name. Upon successfully providing identification, the user is provided with prior device login name 132, prior device password code 134. Alternatively, Customer Care Center 312 allows the user to enter a new device login name 132 and/or device password code 134.

If portable session management device 114 is missing, following proper identification, a new portable session management device 114 that includes user login name 132 and user password code 134 is optionally issued. In embodiments, the user then uses new portable session management device 114 to enter encrypted remote databank 306 to retrieve files and folders from server 470 to computer 102.

In embodiments, new portable session management device 114 is optionally provided with a replacement unique device identifier 414 and the original unique device identifier 414 is invalidated.

In this manner, if the user lost, for example, a briefcase containing both the portable session management device 114 and also his note pad with the login name and password code, a would-be imposter could not access secure vault 411. In embodiments, access program compares portable session management device unique device identifier 414 to identification information stored in memory storage 412 and, following rejection of an unauthorized device, maintains a record to apprise the user.

The user is apprised that unregistered portable session management device 114 has been plugged into laptop computer 102 and, optionally, the identity and time of the unauthorized plug-in.

Additionally, the user has the option to contact Customer Care Center 312 where additional measures may be taken, for example deactivating the unauthorized device until the unauthorized user is notified and/or admonished with respect to the unauthorized access.

### Secure Internet Surfing

Portable session management device 114 allows the user to securely surf websites on the Internet. In embodiments, following login and opting for secure surfing 310, a specially configured internet browser is launched from the device which stores session information such as cookies and site history in a way that the information cannot be inspected without the device.

Preferably the data is stored on the device. That is to say history, of each site 510 visited by the user and any downloaded information or communications during a given surfing session are entered into portable session management device 114.

As used herein, the term “history” with respect to management device 114, refers to any record of digital and/or analogue information and/or communications via the Internet, chat rooms, blogs, and/or e-mail.

### Secure Computing Environment

FIG. 2 shows an optional computing environment 200 in which portable session management devices 114, 206, 216 and 220 are connected to computing devices comprising laptop computer 102, desktop computers 222 and 208, and a handheld device 218 respectively.

In embodiments, portable session management device 114, for example, is inserted into laptop computer 102 that is connected to a server 212 via a local area network 214 and activated by user access module 118.

Additionally, desktop computers 208 and 222, having portable session management devices 206 and 220 respectively, are connected via a local area network 240 via a connection 269 to a wide area network 224 and communicate with server 212 and computer 102.

In still further embodiments, portable session management device 216 is connected to a handheld device 218, for example cell phone 218, which is connected to server 212 via network 214.

As used herein, any reference to connections between computers 102, 222 and 208, computer storage, for example server 212, and or handheld computing devices 218 and/or methods and protocols for connecting therebetween, includes a priori, all available methods, devices and/or protocols available today or in the future. The many options for connection between laptop computer 102, desktop computers 208 and 222, handheld computing device 218, and server 212 are well known to those familiar with the art.

Further, as used herein, the term “computer” 208 refers to any computing device having a USB connection. Persons skilled in the art will further appreciate that portable session management devices 114, 206, 216 and 220 are optionally connected to computing devices 102, 208, 218, 222 and/or server 212, directly or via various networks configurations, 214 and 224 and/or computer communication protocols currently available or later developed.

In embodiments described below, backup to remote memory storage uses the example of backup to server 470 and/or to remote vault 430 contained therein. However, as used herein, any reference to server 470 and/or remote vault 430, refers to any computer and/or storage available today or in the future.

As non-limiting examples, laptop computer 102, or any computing device, including inter alia, computers 208, 218 and/or 222, may back up files to any one of computers 102, 220 and 208, server 212 and/or handheld device 218 using the presently presented protocol of portable session management device 114 or any protocol developed in the future.

In embodiments, server 212 generates a hash value for each of portable session management devices 114, 206, 216 and 220 based upon individual user login name 132 (FIG. 1C), user password code 134 and/or portable session management device unique device identifier 414 that are optionally stored on each of portable session management devices 114, 206, 216 and 220 and/or in memory storage associated with computing devices 102, 208, 218, and 222 and/or server 212.

### Device Setup

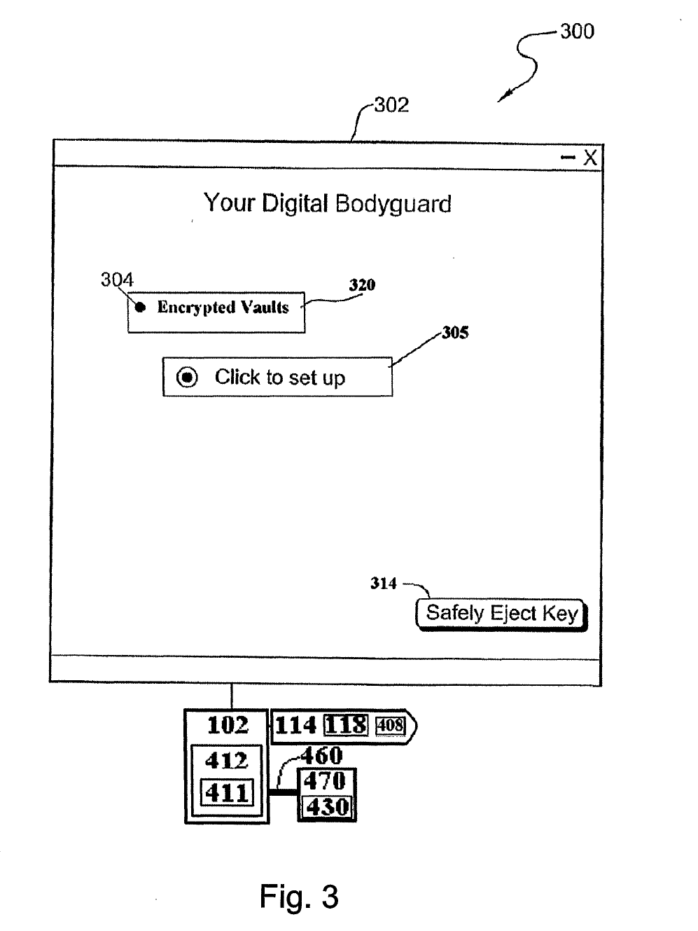

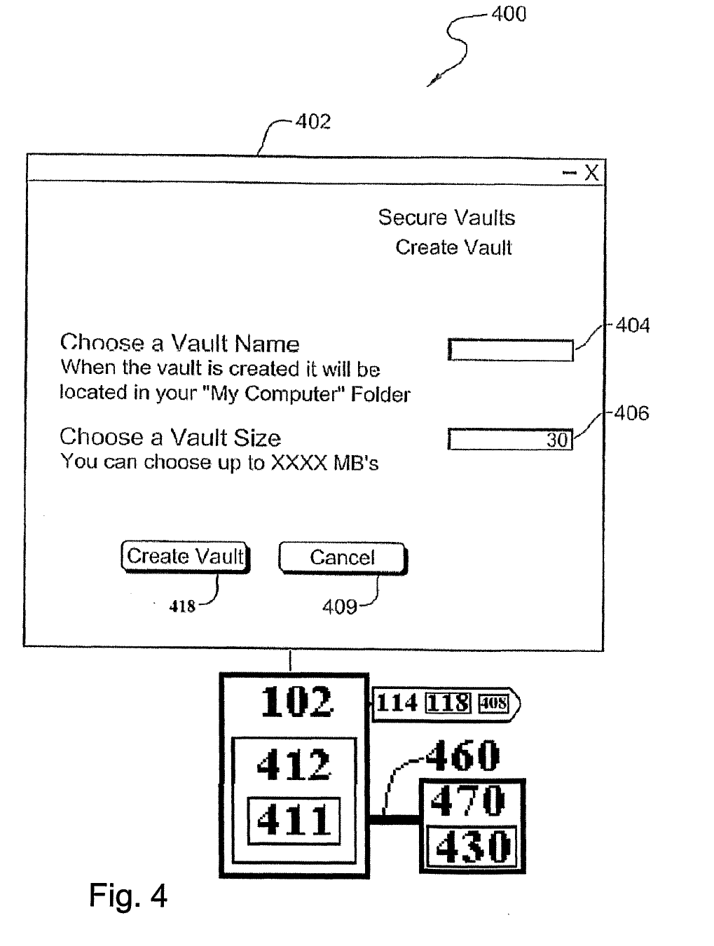

FIG. 3 shows window 302 on a display 300 in which the user has selected to set up encrypted vault 304 by clicking on an “Encrypted Vault” setup button 305. FIG. 4 shows a secure vault window 402 on a display 400 that follows choosing “Encrypted Secure Vault” option 304 (FIG. 3). The user selects a “Create Vault” button 418 and inputs a vault name 404 to be created.

As used herein, the words toggle, click, choose, select and grammatically related words and/or words having similar connotations, refer to choices that are executed by the user using, inter alia, a keyboard, mouse, touch screen, and/or pen.

Vault name 404 optionally comprises any identification string that identifies vault 411 in computer storage 412 and/or vault 430 in server 470. The user optionally chooses vault name 404 that is connected with the utility of created vault 418, for example drive “F”, followed by “documents” or the identification of the user, for example “John” as explained below.

In a box 406 the user selects the default size of vault 404, for example 30 megabytes, though any other number designating a given size of vault 404 may be inputted in box 406. The size of vault 404 is limited only by the ability of the operating system to create files or folders that fit into the chosen size 406.

In embodiments, the user optionally changes vault size 406 any time after creating vault 404. In alternative embodiments, vault size 406 is set to be dynamic, so that vault size 406 changes depending on various predetermined parameters including, inter alia, the available storage space in computer storage 412, user preferences, the user's preferences with respect to computing device 102 or server 470, and/or the volume of files and information stored in vault 411.

The user clicks button 418 to create vault 411 or clicks button 409 to cancel the operation and return to previous window 300. Upon pressing the “Create Vault” button 418, user access module 118 instructs the operating system of computer 102 to create a secure vault 411 on memory storage 412 and/or on another predefined storage, for example remote vault 430 on server 470.

Secure vault 411 is encrypted using conventional encryption protocols. In a non-limiting embodiment, the encryption protocol comprises TrueCrypt encryption scheme by TrueCrypt Foundation; the many encryption protocols and methods for encryption being well known to those familiar with the art.

### Drive Setup

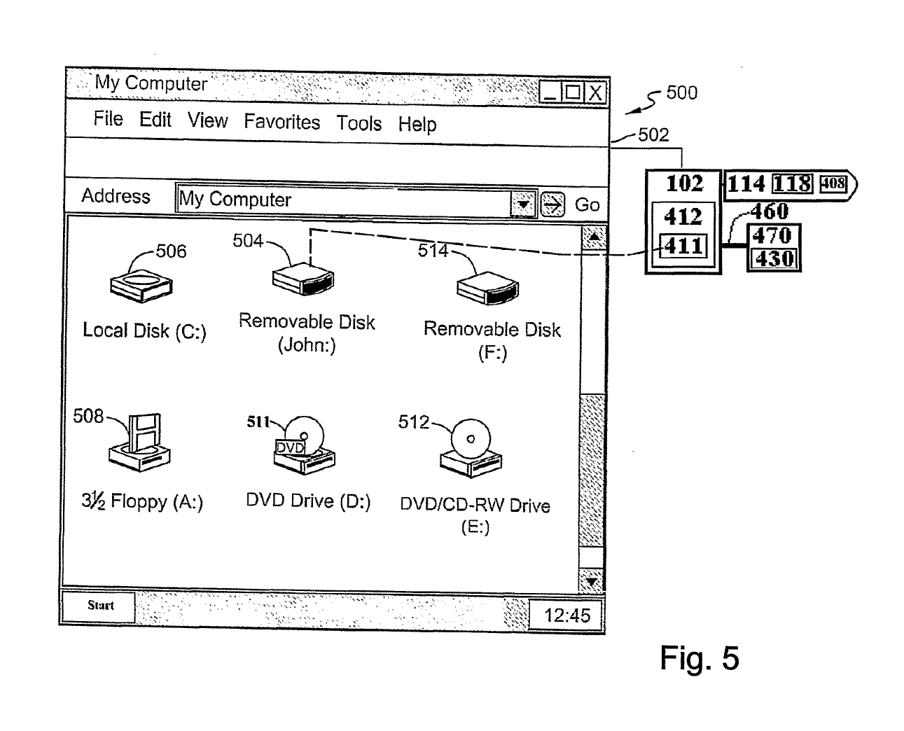

FIG. 5 shows a computer screen display 500 with a window 502 depicting various drives on computer 102. Displayed vault 410 generated by module 118 is stored in secure vault 411 within memory storage 412, and is shown to the user on browser window 502, for example as a displayed vault 504 designated as a removable disk that has been named “John”, by the user. Drives 506, 508, 511, 512, 514 are also shown to the user on window 502.

In embodiments of the present invention, while portable session management device 114 is connected to computer 102, displayed vault 504 remains viewable and available for storage of files and information. As long as secure vault 411 is open, the user optionally saves files and information into secure vault 411, by copying or saving files and pressing the button of displayed vault 504.

In alternative embodiments of the present invention, the user may drag and drop files or information into displayed vault 504 that are then encrypted into secure vault 411. Files and information of displayed vault 504 are encrypted along with the user's hash value that is contained in user access module 118 and/or in memory storage 412 and saved into secure vault 411.

### Drive Status

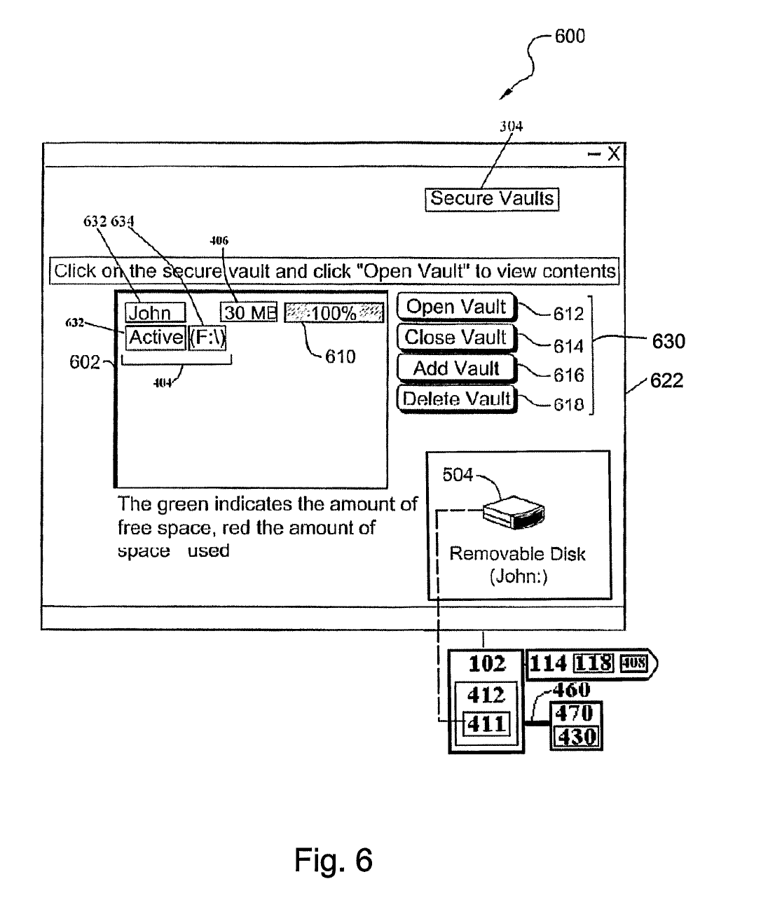

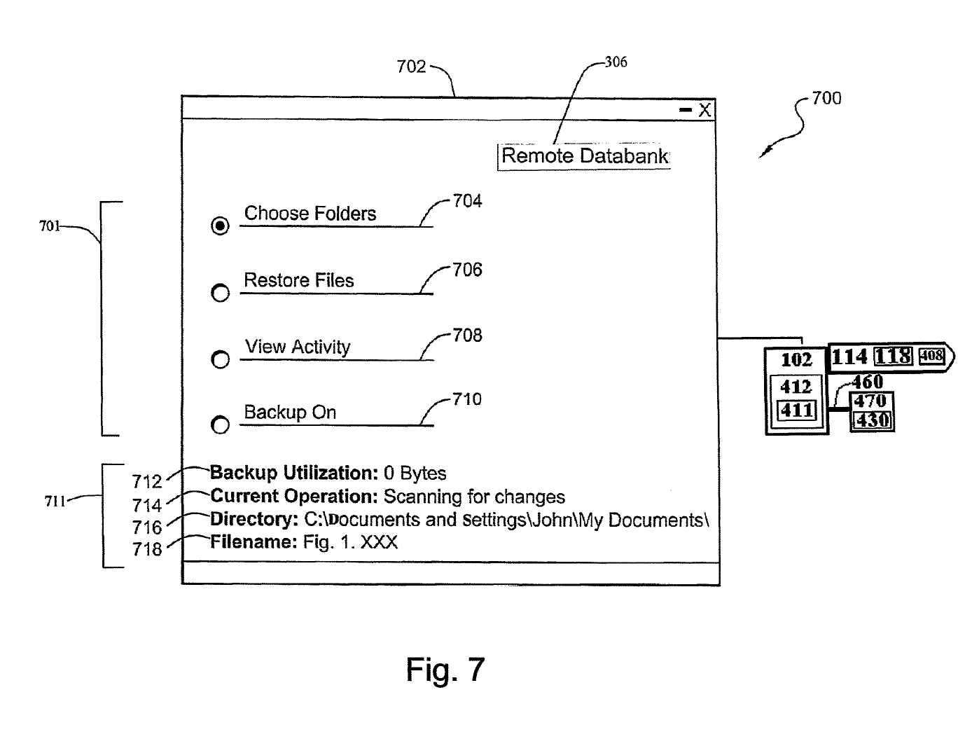

FIG. 6 shows a window 622 on a display 600 related to the status and options associated with displayed vault 504. Displayed vault 504 is opened by default upon launching of access module 118. Open displayed vault 504, referred to herein as being “mounted” as secure vault 411 on memory storage 412, is available for receiving data.

Closed displayed vault 504 unmounts vault 411 so that neither memory storage 412 nor displayed vault 504 are viewable by the user and vault 411 cannot be accessed.

A window 602 depicts a status 404 of displayed vault 504, having a title “John” 632. Displayed vault 504 is designated as being mounted on computer storage 412 as vault 411 by a designation “active” 632 and assigned a drive indication 634, in this case a letter “F”.

Display 622 additionally shows size box 406 showing the size of secure vault 411 and a colored bar indicating the amount of free space 610 still available for use in secure vault 411. In other embodiments, alternative depictions of vault size 406 and amount of free space 610 are optionally displayed, for example a pie chart depiction; the many options for graphics associated with display 622 and/or components such as free space 610, are well known to those familiar with the art.

While displayed vault 504 is represented singly, it will be readily appreciated that many additional vaults are optionally depicted in a similar manner alongside displayed vault 504.

A number of buttons 630 are available to the user so as to manage displayed vault 504. A button 612 enables user to mount vault 411 on memory storage 412, even while displayed vault 504 is closed and vault 411 is unmounted. A button 614 enables user to close displayed vault 504, thereby unmounting vault 411 in memory storage 412. A button 616 enables user to add a vault, described in connection with FIG. 4 above; and a button 618 enables user to delete a vault.

### Secure Databank

A display 700 (FIG. 7) shows a window 702 with a selection menu presenting user options 701 following selection of remote databank option 306.

In embodiments, when the user selects the option of accessing secure databank 306, window 702 presents selection menu 701. Selection menu 701 allows the user to choose folders to be backed up 704. As used herein, the term “folder” refers to any created storage component that comprises any created data, individual files, multiple files, individual folders and/or multiples folders. Menu 701 additionally presents the user with choosing folders to restore 706, and viewing activity of folders 708.

Additionally, the user optionally toggles a “Backup” button 710 to see backup information 711. In embodiments, a backup information section of the display 711 includes, inter alia, a backup utilization count 712, a field stating the current operation being performed 714, a name of the directory in which the relevant file is located 716, and a name of the file being backed up or restored 718.

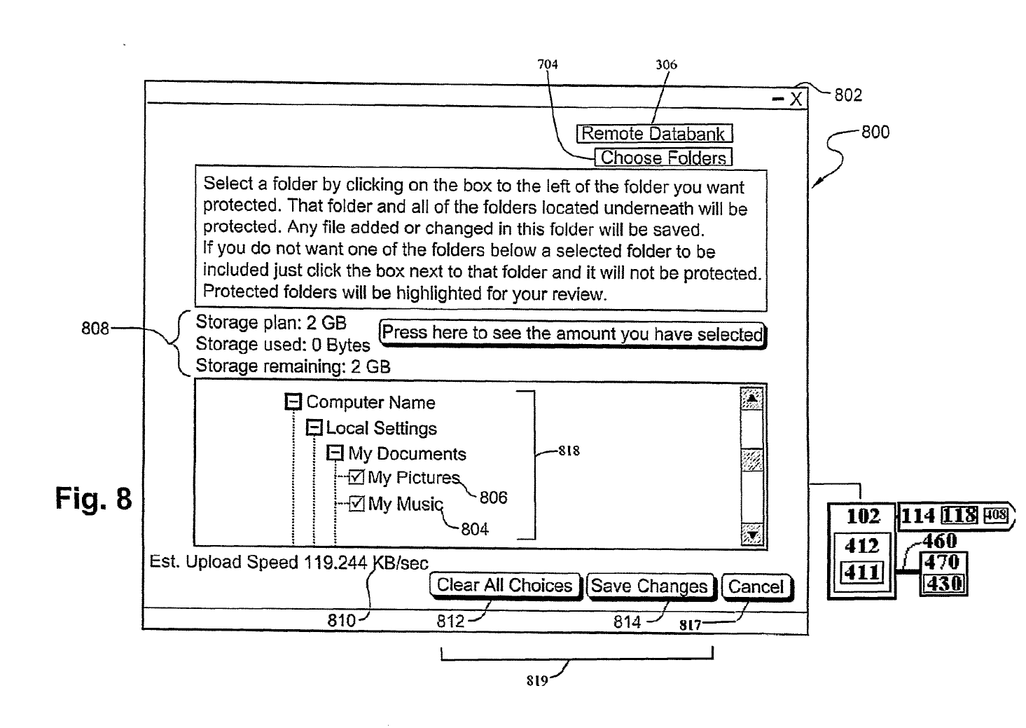

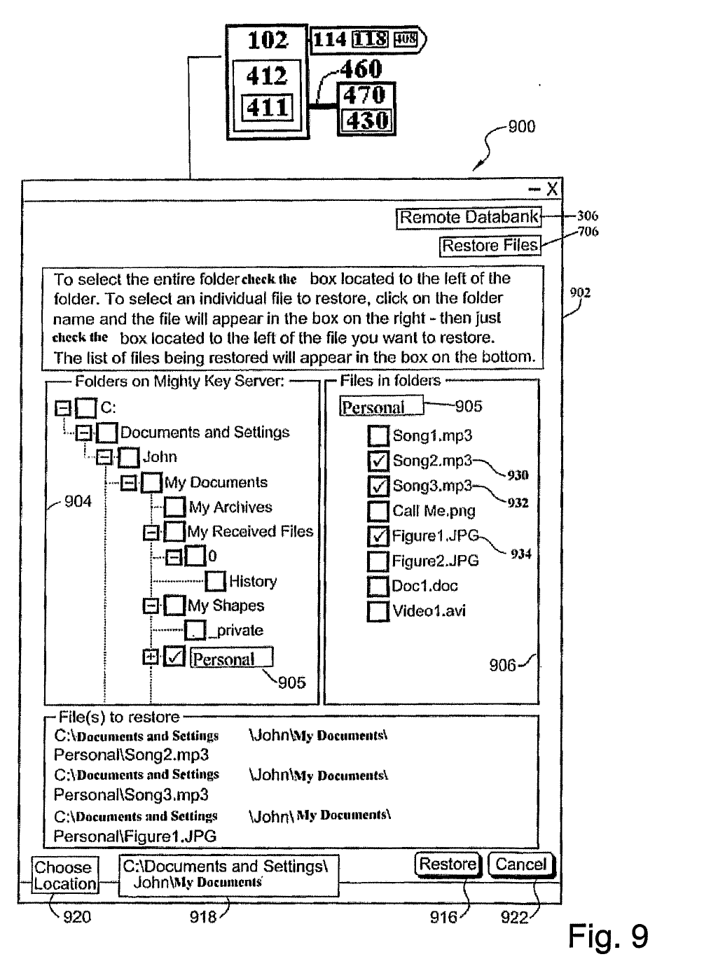

FIG. 8 shows a display 800 in which a window 802 appears in response to the user selecting Choose Folders 704. Window 802 provides the user with folders to choose from, for example, in the form of a directory tree 818. Directory tree 818 includes, for example all folders, for example 804 and 806 that are under the control of portable session management device 114.

The user optionally selects one or more folders to work on, for example My Music 804 and My Pictures 806 for backup. Upon selection, folders 804 and 806 are highlighted and a storage summary 808 is presented. Storage summary 808 optionally provides information on the amount of storage available, in this example 2 gigabytes, the amount of storage used, in this example 0 gigabytes, and the amount of storage remaining, in this example 2 gigabytes.

### Backup

A backup speed 810, herein designated as upload speed 810 and shown in this example as 119.224 kilobytes per second, is optionally presented to the user. Additional options include, for example, a “Clear All Choices” button 812, a “Save Changes” button 814, and a “Cancel” button 817, which cancels actions and returns user to window 702 (FIG. 7).

Upon selection and execution, folders 804 and 806, or any other data selected by the user, are stored in computer vault 411 and/or remote vault 430 either as encrypted or unencrypted files. In embodiments, the option to backup encrypted files or unencrypted files in vault 411 is an option chosen by the user.

Following storage, restoration of folders 804 and/or 806 to computer 102 will only be allowed via use of portable session management device 114 after authentication, as described above.

In emergencies, the user has the option to notify Customer Care Center 312 and request that data from backup 810 be made available for downloading to computer 102, without using portable session management device 114. Such emergency backups become extremely valuable when, for example, there is a computing error on computer 102 that makes it impossible to login with device 114.

### Restore

A display 900 (FIG. 9) shows a window 902 in which user has selected the “Restore Files” option 706.

A window 904 provides the user with the option to select which folders are to be restored from server 470, for example a personal folder 905. In embodiments, the user is shown a window 906 showing the list of encrypted files in folder 905. In the example shown, the user has selected for restoration: a file “Song2.mp3” 930, a file “Song3.mp3” 932 and a file “Figure1.JPG” 934.

The user then selects a target location 918 to which files 930, 932, and 934 will be restored, for example C:\Documents and Settings\John\My Documents on memory storage 412. The user alternatively manually enters another suitable path in box 918, for example remote vault 430 on server 470. Alternatively, the user optionally accesses browser window 502 (FIG. 5) and browses until finding target location 918.

Upon selecting a “Restore” button 916, files 930, 932 and 934 are restored to target location 918. Alternatively, the user selects a “Cancel” button 922 to return to window 702 (FIG. 7).

### Account Activity

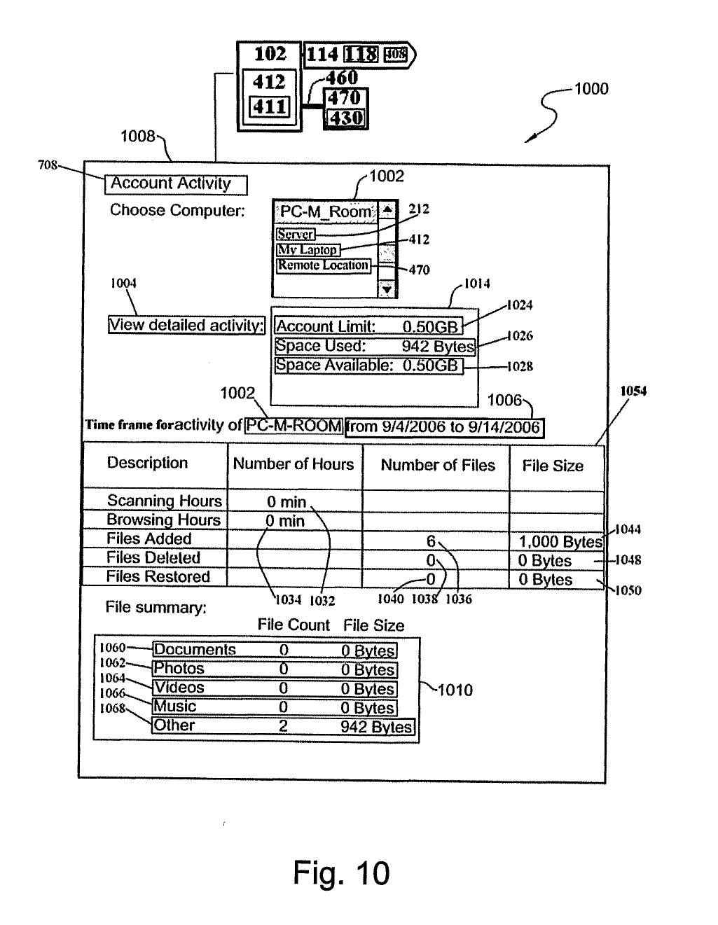

A display 1000 (FIG. 10) shows a window 1008 that provides the user with options following selection to view “account activity” 708. Account activity 708 displays information associated with the backup and restore operations of storage devices, including memory storage 412 and server 470.

The user selects a drop down report menu window 1002 that displays storage devices for example, shows information on a group of storage devices titled “PC-M_Room”, including server 212, memory storage 412 of computer 102 and server 470. The user then clicks the device 212, 412, or 470 about which a detailed activity report 1004 will be displayed.

The selection of PC-M_Room in window 1002 is shown as display 1006. Optionally the user selects a time frame of activity 1006 for PC-M Room 1002, which in this example is shown as “from Sep. 4, 2006 until Sep. 14, 2006”.

Following user input of account activity and preferences noted above, the user chooses “View detailed activity” display 1004 which provides a window 1014 showing a maximal storage space 1024, an amount of storage space used 1026 and an amount of storage space still available 1028.

In accordance with embodiments of the present invention, an activity window 1054 provides the user with the activities performed by one of the storage devices in window 1002, for example server 470, or all devices in PC-M_Room 1002.

Such description includes, inter alia, a number of scanning hours 1032, a number of browsing hours 1034, a number of files added 1036, and a number of deleted files 1038.

Additionally, window 1054 shows size of files added 1044, size of files deleted 1048 and size of files restored 1050. Additionally, window 1010 shows a file summary of the file types stored or handled, for example by, for example, server 470, or all devices in PC-M_Room 1002 for the time frame shown in activity display 1006.

In the example shown, the file types include documents 1060, photos 1062, videos 1064, music 1066 or “other” file types 1068,

### Flowcharts of Device Operation

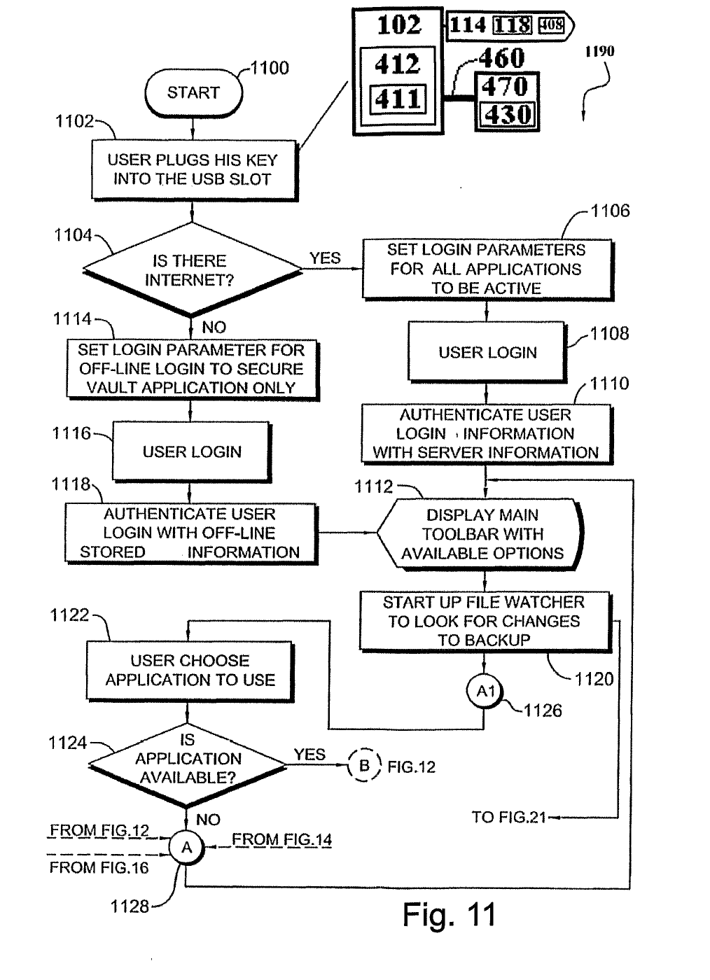

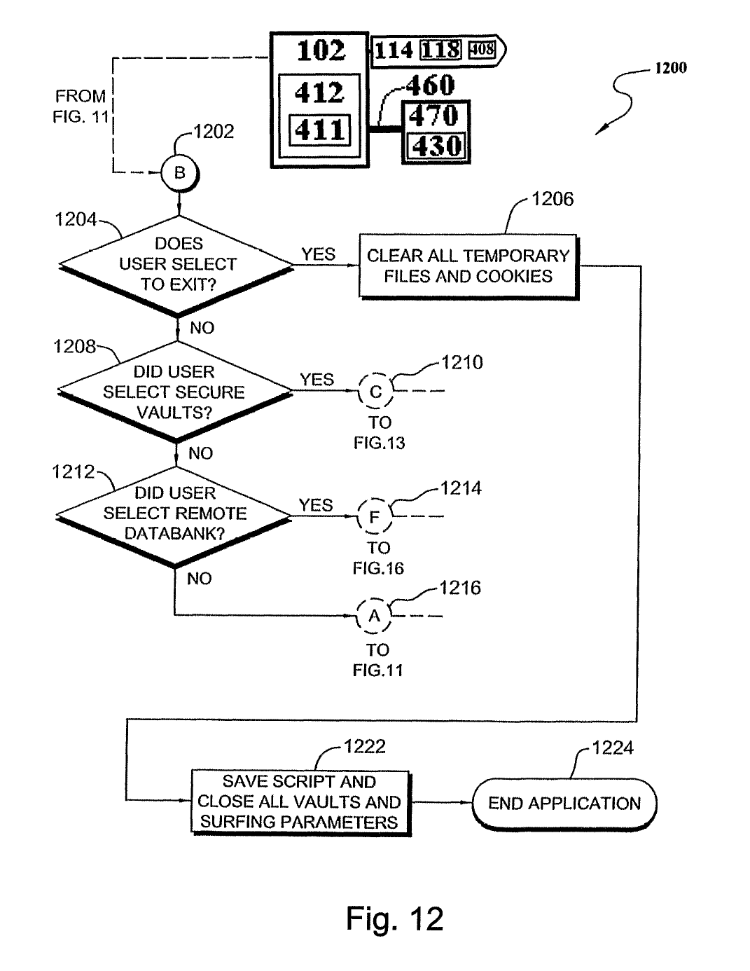

A flowchart portion 1190 (FIG. 11) shows secure login and authentication performed by module 118, starting from a stage 1100. In a connection stage 1102, the user plugs portable session management device 114 into computer 102. In a network stage 1104, access module 118 determines whether a network connection was established between computer 102 and server 470.

With a proper network connection, the user proceeds to an activation stage 1106 wherein all applications become active. In a login stage 1108 the user logs in by providing display login name 162 and display password code 164 (FIG. 1C) and in a device communication stage 1110, access module 118 communicates this input with server 470, along with unique device identifier 414.

Server 470 performs a look up of user login name 162; user password code 164 and unique device identifier 414 and determines if the user login is authentic. Upon authentication in stage 1110, a toolbar 1112 is displayed. Toolbar 1112 is shown in FIG. 3 as window 302.

In embodiments, if there is no connection to server 470 or a VPN connection is not present, access module 118 informs the user that connection must be made to continue operation. The user is referred to an offline stage 1114 that, with proper input of parameters, allows connection to secure vault 411 only. The user may additionally opt to log in, performed in a login stage 1116.

In a stage 1118 user authentication is performed by matching user input login name 132 and input user password code 134 with information stored on portable session management device 114.

In a stage 1120 user access module 118 launches a file watcher program to look for changes to folders, for example “My Pictures” 806 and “My Music” 804, (FIG. 8) Information regarding such changes is preferably communicated via mechanisms such as Windows Status message boxes.

### Ending a Session

In a flowchart portion 1200 (FIG. 12), beginning with a junction 1202, the user proceeds to an exit stage 1204. Upon choosing to exit, the user proceeds to a clear stage 1206 where all temporary files and cookies are cleared. In an unmounting stage 1222 access module 118 ensures that all data on memory storage 412 are unmounted and that any connections to server 470 are disconnected. In a device removal stage 1224 access module 118 unmounts data so that portable session management device 114 safely removes from computer 102 and the session is closed.

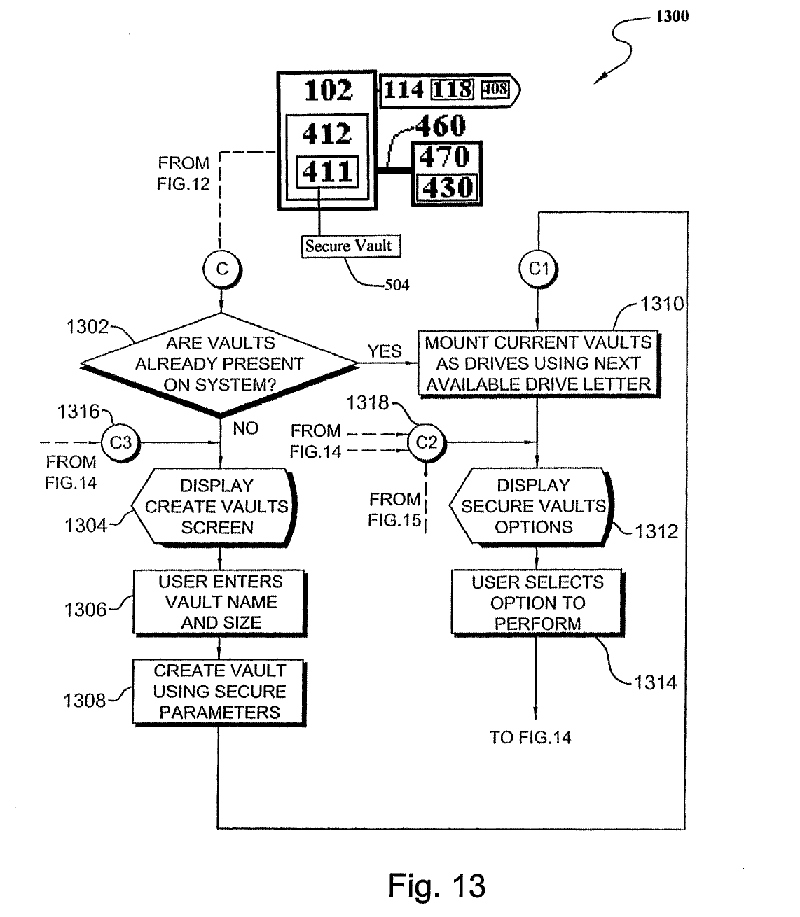

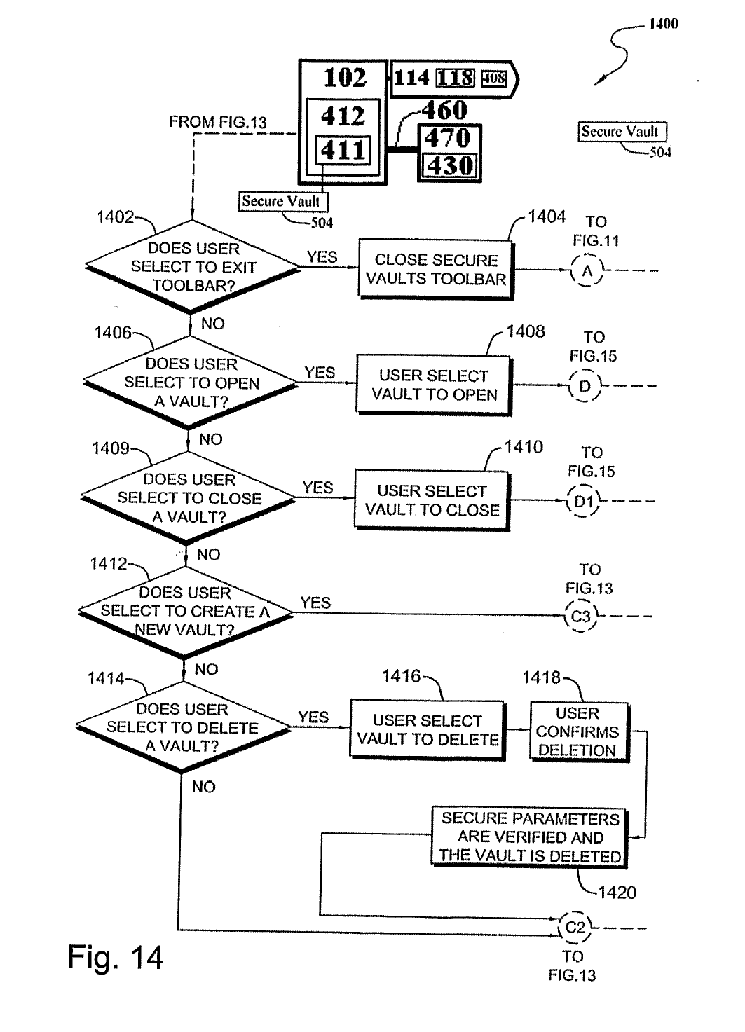

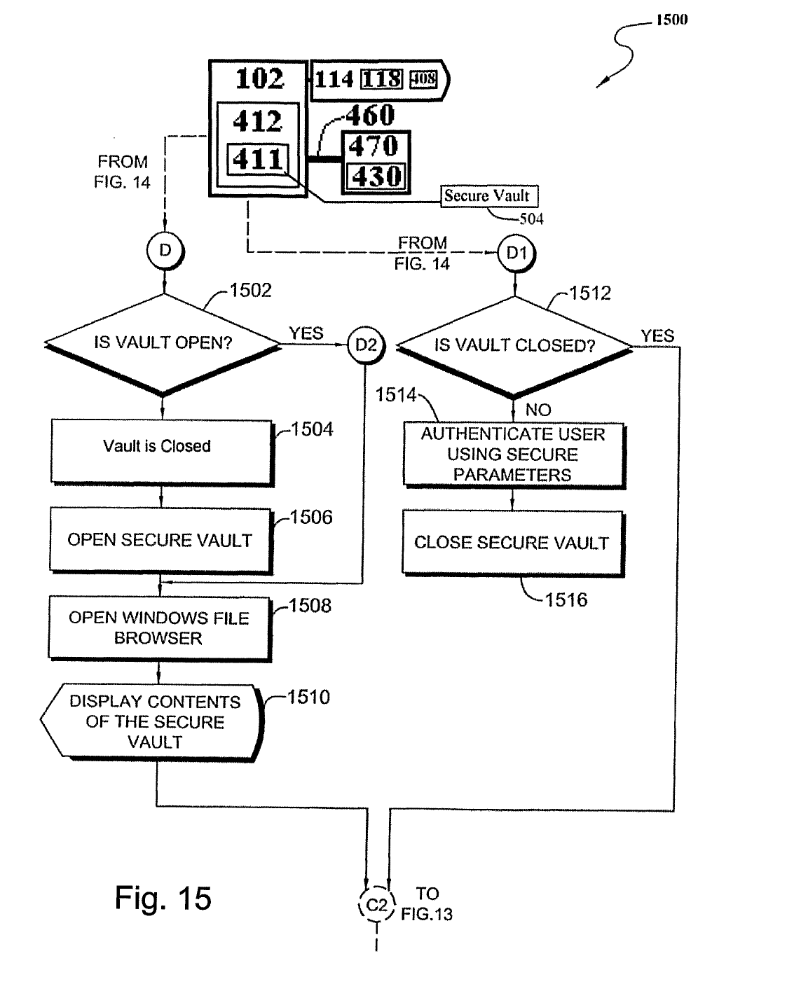

If the user selects to access a secure vault stage 1208, rather than exit stage 1206, access module 118 accesses secure displayed vault 504 as described below and proceeds via a junction 1210 to FIG. 13.

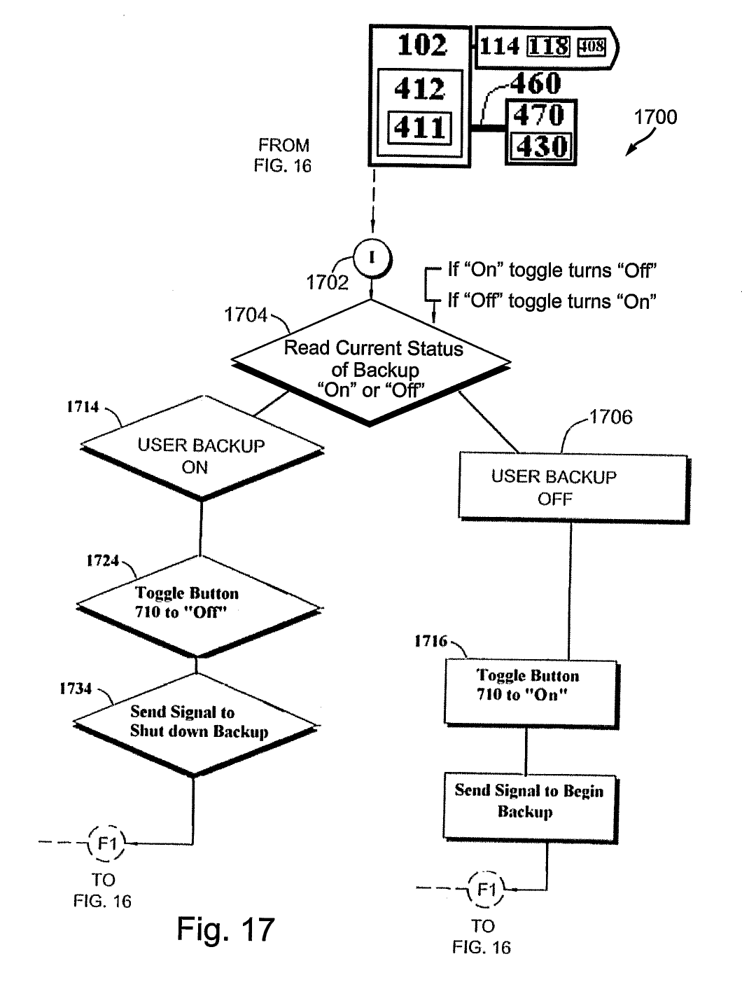

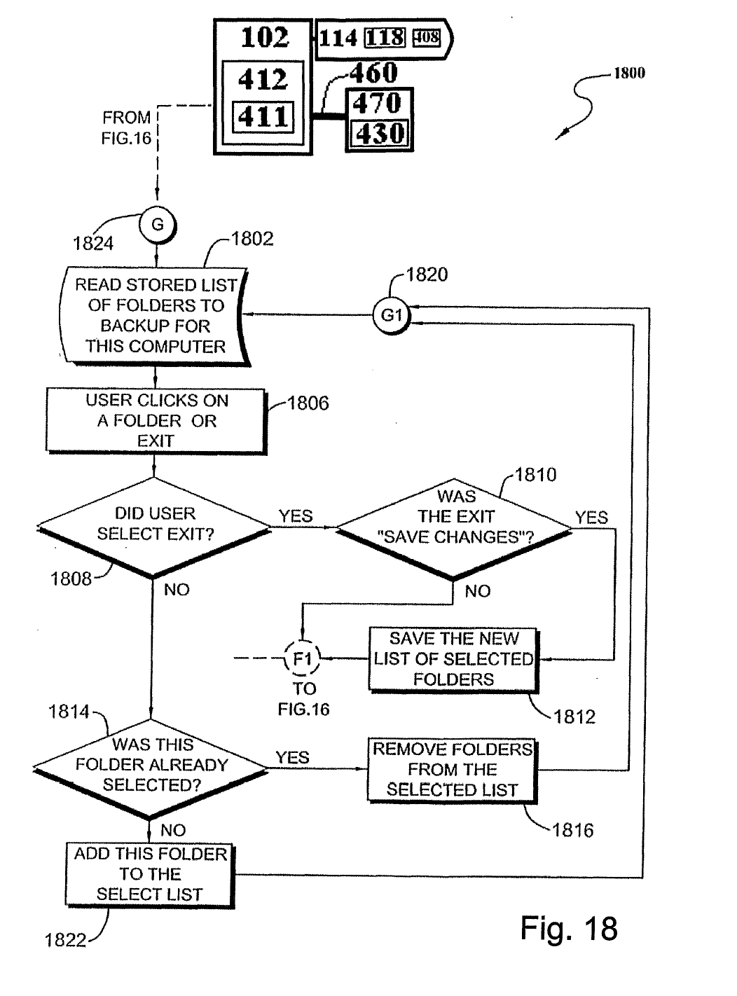

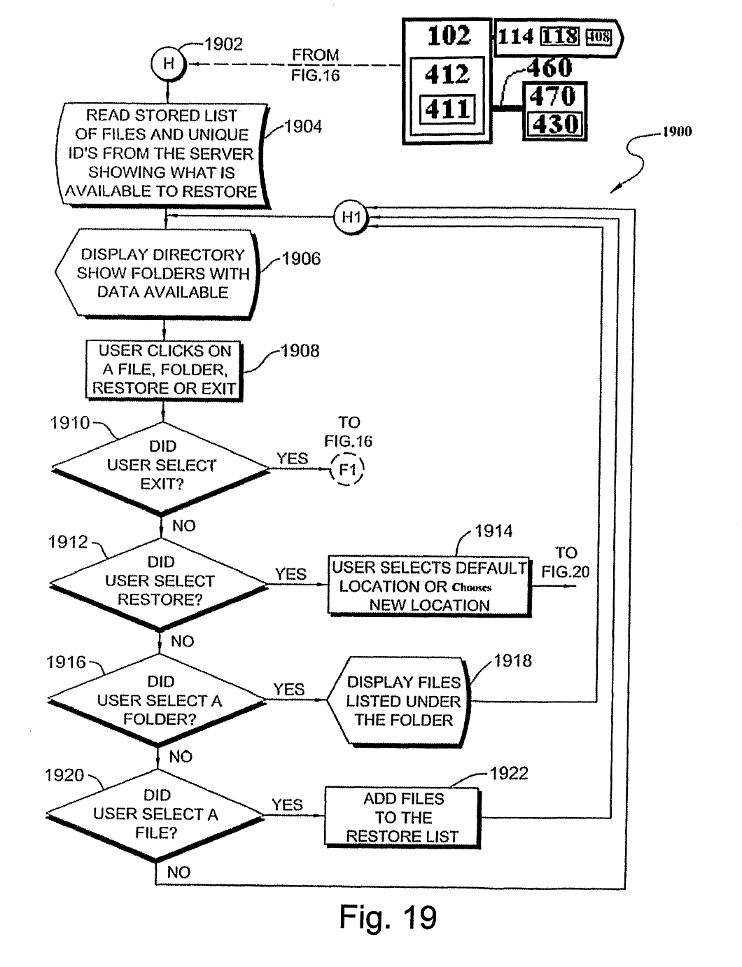

If the user selects to access remote data bank located for example in server 470, in a stage 1212, access module 118 proceeds to a junction 1214 described in FIG. 16. If the user chooses not to access the remote databank in server 470, access module 118 proceeds through a junction 1216 and the user is returned to a junction 1128 of FIG. 11.

### Creation and Management of Vaults

A flowchart portion 1300 (FIG. 13) shows management of secure vault 411. In a determination stage 1302 access module 118 determines whether there are secure vaults 411 previously defined and present on computer 102 and displays secure vault icon 504 seen in FIG. 5. If no secure vaults 411 were previously created, in a display stage 1304 access module 118 causes computer 102 to display create vault screen 402 (FIG. 4).

In a vault configuration stage 1306 the user enters vault name 404 and vault size 406 (FIG. 4) and in a stage 1308 displayed vault 504 (FIG. 5) is shown.

If in stage 1302, unmounted secure vault 411 is available for mounting on computer 102, in a mounting stage 1310, secure vault 411 is mounted and displayed as displayed vault 504.

In a stage 1312 secure vault options toolbar buttons 320 (FIG. 6) is shown to the user. Access module 118 awaits a selection to be entered by the user in a stage 1314. The available selections are shown in a flowchart portion 1400 (FIG. 14).

In an exit stage 1402 the user selects to exit secure vault options toolbar 304. Access module 118 closes and dismounts open secure vault 411 in a stage 1404 and returns to junction 1128 of FIG. 11. In alternative embodiments, in stage 1404 secure vault 411 is closed but is not dismounted until portable session management device 114 is removed from computer 102.

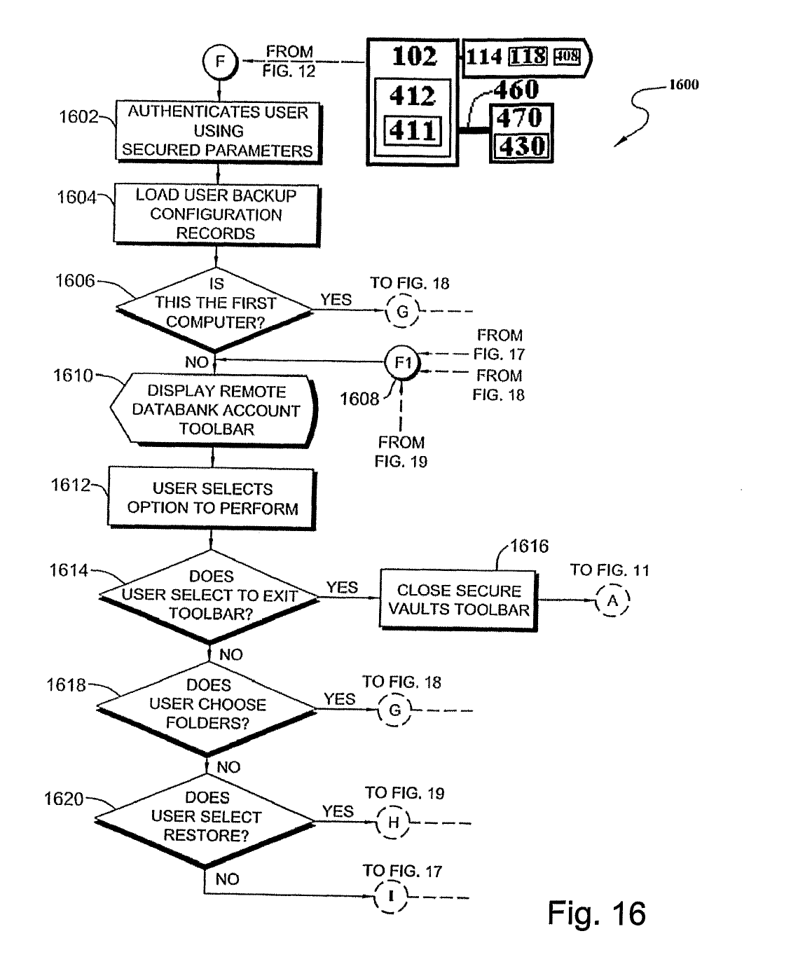

In a stage 1406 access module 118 determines if the user has selected secure vault 411 to open and if so, in a stage 1408 access module 118 identifies which secure vault 411 the user has selected for opening and proceeds to a stage 1502 of FIG. 15 (flowchart 1500) where access module 118 determines whether selected secure vault 411 is open or not. If secure vault 411 is not open, in a stage 1504 access module 118 will authenticate the user by performing a look up in server 470 to authenticate that entered user login name 162 and user password code 164 match device login name 132 and device password code 134 on portable session management device 114 plugged into computer 102.

Alternatively, when a network connection is not available, the authentication described above is performed on portable session management device 114. If the lookup is successful, in a stage 1506 access module 118 opens and mounts selected secure vault 411 and displays displayed vault 504 on display 502 (FIG. 5).

Portable session management device 114 provides the hash value associated with secure vault 411 as well as for mounting secure vault 411 that is available to the user. Optionally, in a stage 1510 the content of secure vault 411 is displayed to the user.

In a stage 1409 access module 118 determines if the user has selected to close secure vault 411 and if so, in a stage 1410 access module 118 identifies which secure vault 411 or portion thereof, the user has selected for closure and proceeds to FIG. 15. In a stage 1512 of FIG. 15 it is determined whether displayed vault 504 is already closed. If displayed vault 504 is closed, then the flow returns to stage 1312 of FIG. 13.

Alternatively, if secure vault 411 is open, as shown in flowchart 1500 (FIG. 15), a stage 1514 authenticates the user by comparison of input identification against identification on portable session management device 114. In a stage 1516, using the hash value, secure vault 411 is closed and unmounted and it cannot be accessed or seen by the user or other users of computer 102.

In FIG. 14, in a new vault creation stage 1412 access module 118 determines if the user has selected to create a new secure vault 411. If so, control is transferred to a junction 1316 of FIG. 13. In a stage 1414 access module 118 determines if the user has selected to delete new secure vault 411 and if so, in a stage 1416 access module 118 identifies which secure vault 411 the user has selected for deletion.

Optionally, in a stage 1418 the user is required to confirm his wish to delete displayed vault 504. Authentication of the user is then performed as is described in association with stage 1504 of FIG. 15. If the user is authenticated, then secure vault 411 is deleted and control is returned to a junction 1318 of FIG. 13.

### Backup and Storage

FIGS. 16-22B show backup and restore flowcharts that are executed by access module 118.

A flowchart portion 1600 (FIG. 16) shows a stage 1602 authenticates the user as in stage 1514 of FIG. 15. In a loading stage 1604 the user backup configuration records are loaded. The backup configuration records include the user-defined parameters including the list of files and folders the user wishes to back up. In a stage 1606 it is determined whether computer 102 and portable session management device 114 are properly matched.

In embodiments there are multiple computing devices 102 and/or memory storage devices 412, associated with portable session management device 114, as seen in FIG. 2. In embodiments, computer 102 into which portable session management device 114 is plugged is defined as primary computer 102 for back up and secure. In accordance with this embodiment, primary computer 102 and its associated memory storage devices 412 are the default storage.

In a flowchart portion 1800 (FIG. 18), the user defines additional computing devices and storage devices for back up and restore procedures. A backup stage 1802 is highlighted, awaiting user input as to which folders are be encrypted on computer 102. The user is shown a display of remote databank 306 (FIG. 8). The chosen folders are then stored in files located on server 470.

In a selection stage 1806, the user selects folders for backup or exits the display in a stage 1808, at which time changes to the folders list are saved in a save stage 1812. A junction 1608 of FIG. 16 is then highlighted.

If the user did not select to exit in exit stage 1808, a determination stage 1814 is highlighted and if a folder was already backed up to server 470 in a removal stage 1816, the already backed-up folder is removed and a junction 1820 is highlighted awaiting user input to loop back through the stage of flowchart 1800.

Alternatively, in determination stage 1814, if the folder selected was not previously stored, in an additions stage 1822 the selected folder is added to the list of folders for backup.

Referring back to FIG. 16, in a toolbar stage 1610, toolbar for remote databank 306 is displayed and in an access stage 1612 access module 118 awaits the user's selection from a list of options. If the user selects to exit account toolbar for remote databank 306 in an exit stage 1614, then in a close down stage 1616 the account toolbar of remote databank 306 is closed and a junction 1128 of FIG. 11 is highlighted.

If the user selects folders for back up in a backup stage 1618 then a junction 1824 (FIG. 18) is highlighted and user input is awaited.

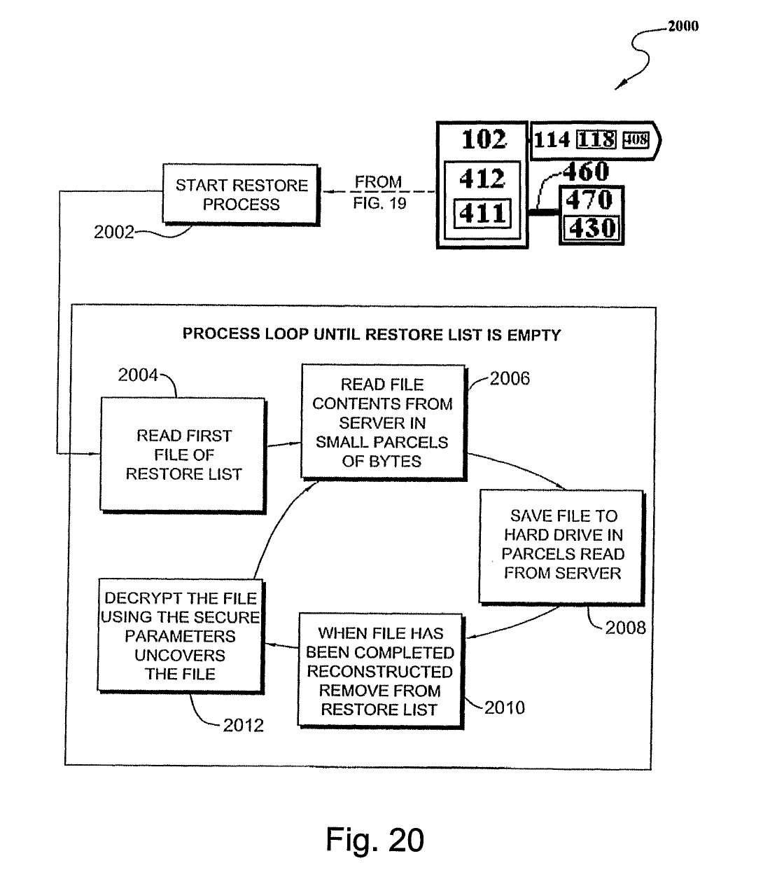

If the user selects a restore folders stage 1620 then a junction 1902 is highlighted awaiting input (FIG. 19).

If no folders are chosen, a junction “I” 1702 is highlighted (FIG. 17) in flowchart portion 1700, awaiting user input. If a backup “on” determination 1714 is made, the user goes to a toggle stage 1724 and toggles button 710 (FIG. 7) to “off. A shutdown stage 1734 sends a signal to junction “F1” in FIG. 16 to shut down the backup process.

Alternatively, if a backup “off” determination 1706 is made, the user goes to a toggle stage 1716 and toggles button 710 (FIG. 7) to “on. A begin backup stage 1726 sends a signal to junction “F1” in FIG. 16 to begin backup.

The user is returned to flowchart 1600 through junction 1608 with backup shut down or backup ready to begin and the user proceeds to opening data bank tool bar 1610 and is provided with option performance stage 1612, awaiting user input.

Selection of restore option 1620 brings the user to junction 1902 of a flowchart portion 1900 (FIG. 19). In a display stage 1904 the list of folders and unique identifications are read. Unique file identification refers to files that are stored on computing devices other than computer 102.

The user optionally assigns each computing device its own identification and the unique identification is stored on portable session management device 114 associated with remote vault 430.

A display stage 1906 displays folders and files that are available for restore from server 470 as seen in FIG. 9. In a choose folder stage 1908 access module 118 awaits user selection of which folders and files to restore. In an exit stage 1910 it is determined whether the user has made a selection to exit the display of FIG. 9 and if so junction 1608 of FIG. 16 is highlighted.

In a stage 1912 it is determined whether the user has made a selection to restore folders and files from server 470 which are associated with computer 102 and portable session management device 114. If so, optionally, in a target stage 1914 the user chooses the target location and path to which the selected folders or files are to be restored.

In a selection folder stage 1916 if selection of folders has taken place, display folders 1918 displays the files related to the folders (FIG. 9). In a file selection stage 1920, if files have been selected, in an add files stage 1922, files are added by the user to the restore list. Restore list 1922 contains the list of files to be restored during the next restore operation.

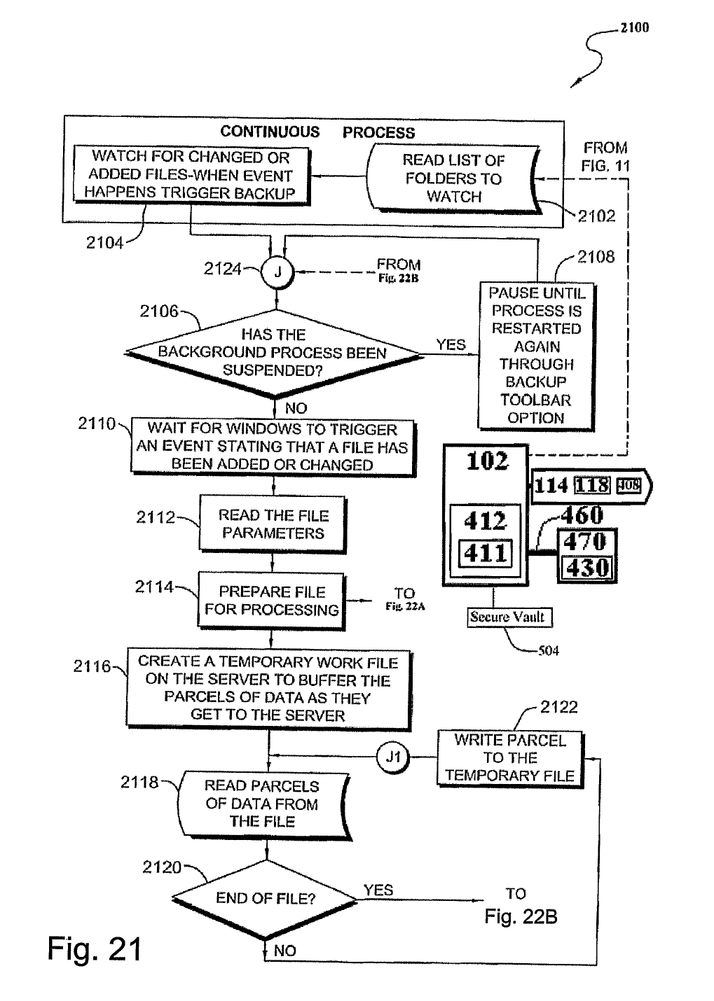

A flowchart portion 2000 (FIG. 20) shows a start stage 2002 where the restore procedure is started. Start stage 2002 initiates a loop that stores each file until the restore list on list stage 1922 is empty.

In a stage 2004 the name and other parameters of a first file to be restored are read from server 470. The first file is divided into small parcels, for example at least about 64 bytes in size and encrypted with the hash value associated with portable session management device 114.

Alternative to parcels of 64 bytes, files are divided into parcels from 1 to 65,535 bytes. The encrypted parcels are then sent to computer 102 and in a save stage 2008 the parcels are saved onto memory storage 412.

In a stage 2010 a file is constructed from the parcels that arrived through computer 102. In a stage 2012 the file is decrypted using the hash value associated with portable session management device 114. At this time, unless the restore list is empty, the next file name on the list is read and the process continues as described above.

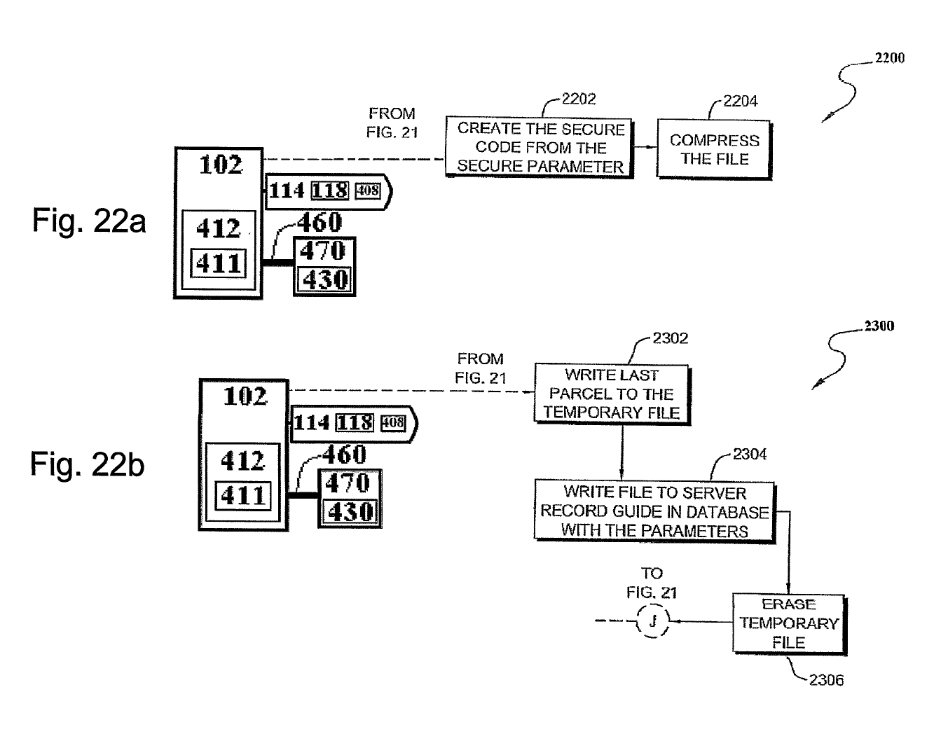

In embodiments, when secure vault 411 is opened, as seen in a flowchart portion 2100 (FIG. 21), a file watcher stage 2102 is activated that automatically or semi-automatically backs up any changes to the content of secure vault 411 as selected by the user. This is a continuous process wherein the list of files or folders to watch and backup to storage in server 470 are read in stage 2102, and changes to the file list or new files are added to the file list for restore. File watcher 2102 is deactivated when secure vault 411 is closed.

In a suspension stage 2106, if the continuous process of stages 2102 and 2104 has been suspended for any reason, a stage 2108 begins the process again.

In a stage 2110 access module 118 waits for Windows to read the parameters of a given file and provide notification that the file to restore has been changed, added, or deleted. The file is prepared for processing in a stage 2114 and transferred to a create stage 2202 in FIG. 22. Changed file parameters that are monitored are additionally monitored for, inter alia, file location, size and save data.

A flowchart portion 2200 (FIG. 22A) shows stage 2202 in which the file compression algorithm is performed using the hash value associated with portable session management device 114. In a stage 2204 the file is compressed with the hash value as a part of the compression.

The compression optionally uses the WinZip compression algorithm from the WinZip International LLC, Mansfield, Conn., US. Persons skilled in the art will appreciate that other compression algorithms can be employed in similar manner.

In a temporary stage 2116 (FIG. 21) a temporary work file is prepared on server 470 to buffer the parcels of data arriving to server 470. In a stage 2118 the arriving parcels of data are read. In a parcel stage 2122, the parcels are written onto a temporary work file. Once the last parcel from a given file has been written, the file is sent to server 470 and a record of the temporary file is added to a database storing all the names of the files stored in connection with the portable session management device 114.

A flowchart portion 2300 (FIG. 22B) shows a record stage 2304 wherein the record states the file name, path, and associated computer 102. In a stage 2306, the temporary file is then erased and a junction 2124 of FIG. 21 is highlighted.

Persons skilled in the art will appreciate that file watcher 2102 (FIG. 21), may be a part of access module 118 or an independent computer program or module optionally executed and kept resident in the random access memory of computer 102 associated with portable session management device 114.

### Parent Device Setup

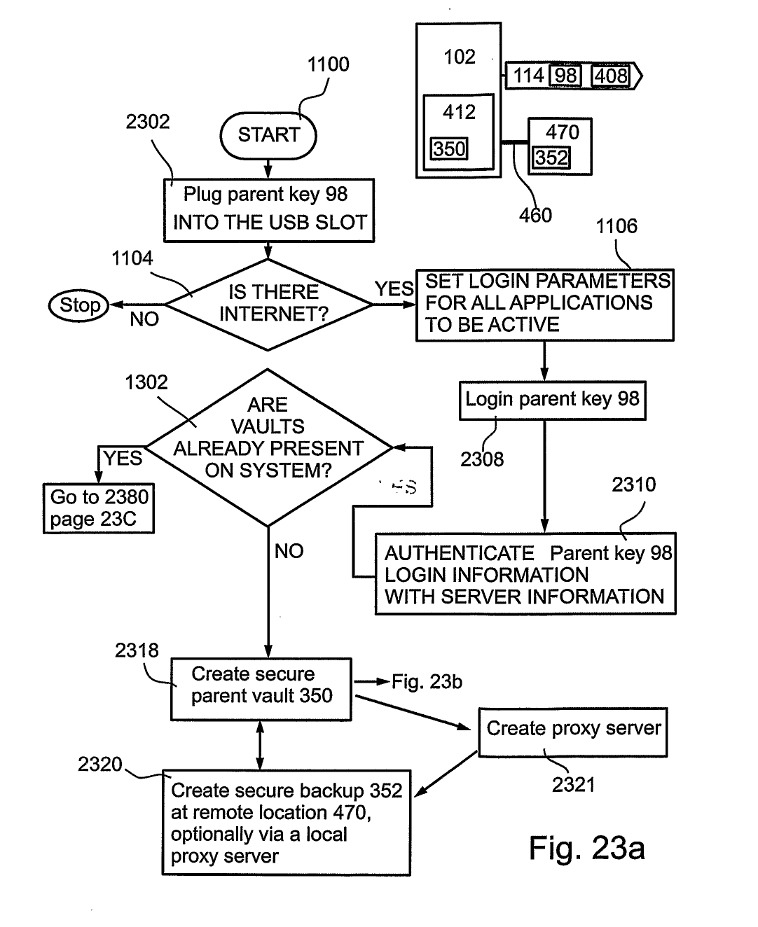

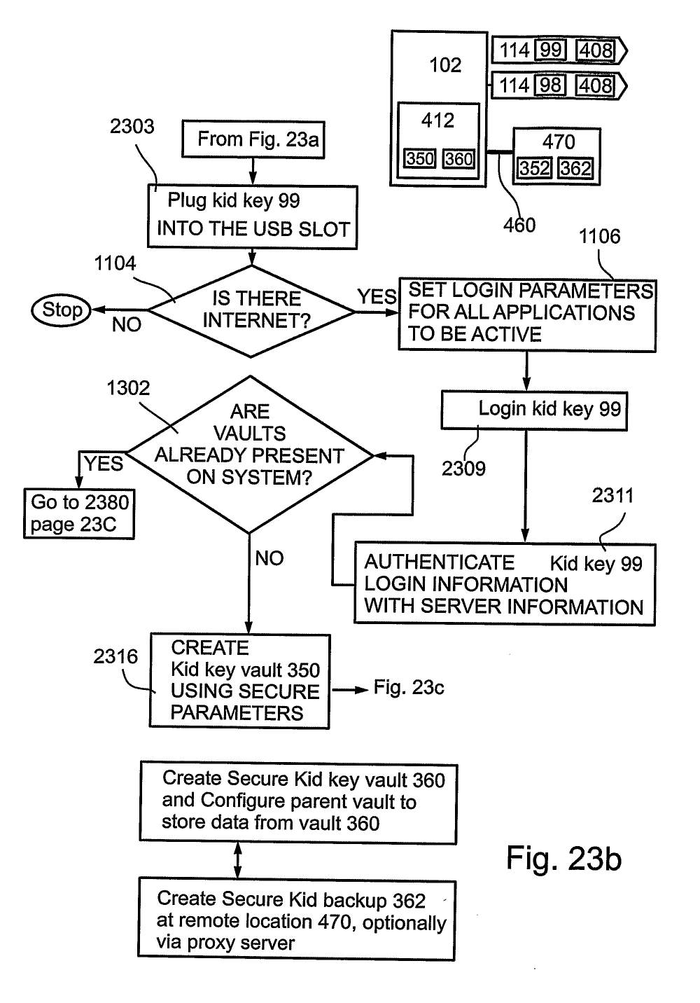

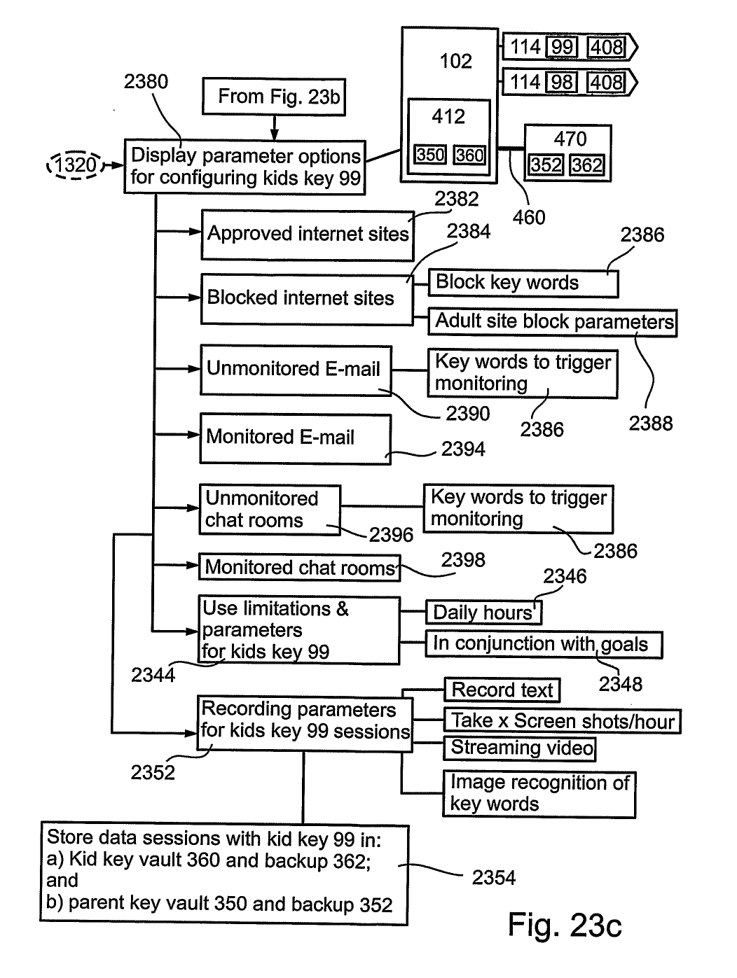

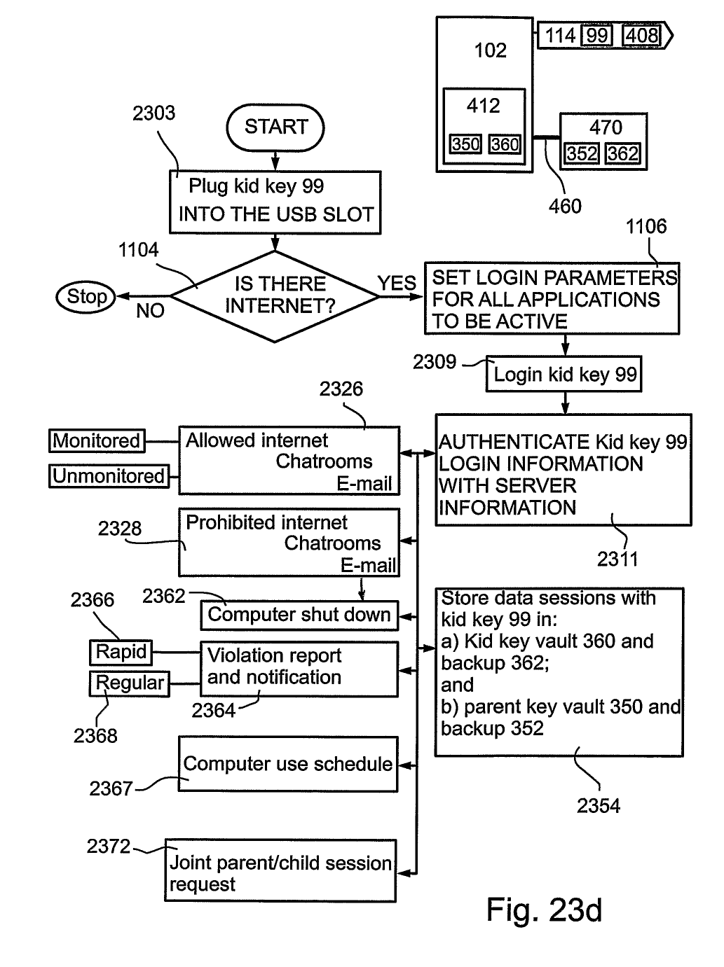

FIG. 23A is a flowchart portion showing set up of a portable parent session management device 98, alternatively referred to herein as parent device 98. The parent puts parent device 98 into computer 102 and progresses through an “Internet connection” stage 1104 and activation of an “applications stage” 1106, as described with respect to flowchart 1190 (FIG. 11). At a login stage 2308, parent device 98 is logged into computer 102.

Following login authentication of parent device 98, alternatively referred to herein as authentication of parent device 98, login takes place as described with respect to flowchart 1190 (FIG. 11). The parent then proceeds to a vault query stage 1302, as described in flowchart 1300 (FIG. 13). At a “vault stage” 2318, a parent vault 350 is created on computer memory 412. At a “backup stage” 2320 a parent backup 352 is created on remote memory in server 470.

Additionally, or alternatively, backup stage 2320 may backup data through use of a proxy stage 2321, to a proxy server.

As used herein a proxy server refers to a server that receives requests intended for another server and that acts on the behalf of the client, as the proxy, to obtain the requested service. A proxy server is optionally a gateway server that separates an enterprise network from an outside network, protecting the enterprise network from outside intrusion.

In embodiments, proxy stage 2321 caches information on a web server that acts as an intermediary between the user and the web server; of particular importance when there is a slow link to the Internet and/or to server 470.

It is understood that as used herein, any reference of backup or services associated therewith, to server 470 and/or communication via any Internet-based protocol are optionally configured to use a proxy server. The methods and protocols for configuration between embodiments of the instant invention and a proxy server are well known to those familiar with the art.

Following creation of backup 352, the process proceeds to FIG. 23B beginning with plugging into computer 102 a child device 99, alternatively referred to herein as portable child session management device 99. Following child device login stage 2309, and an authentication stage 2311, a child vault 360 is created on computer memory 412 and a child backup 362 is created on remote memory in server 470.

The process proceeds to a “parameter stage” 2380 shown in FIG. 23C in which parent device 98 configures the various parameters and safeguards guiding use of computer 102 that will be linked to child device 99.

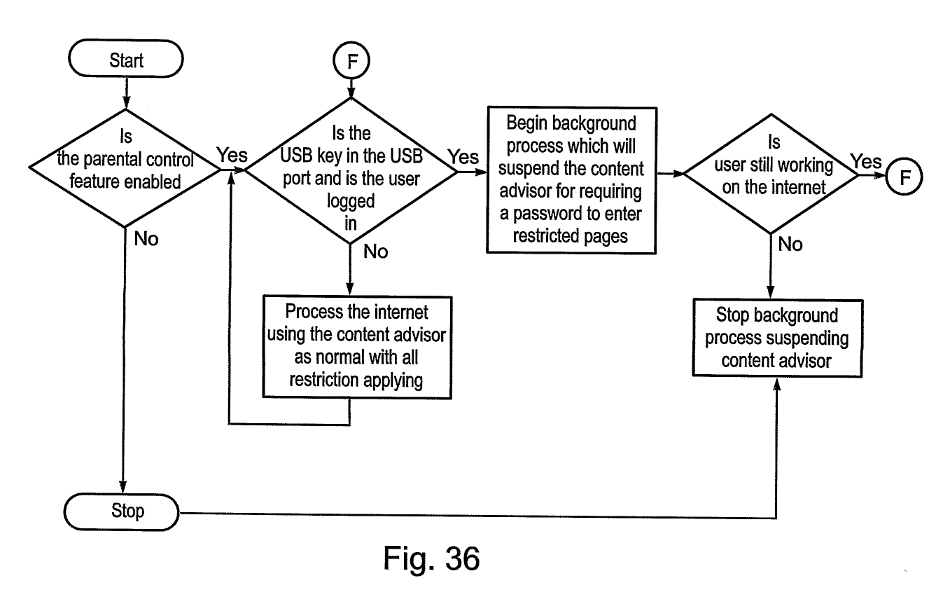

If parameters have already been established, for example through Windows content advisor, upon insertion of parent device 98, a background process temporarily suspends the content advisor, as will be explained with respect to FIG. 36. During the suspension period, parent device 98 is optionally used to change parameters.

Suspension of Windows content adviser continues until the parent device 98 is logged out and removed from computer 102. Following logout, for example following embedding of protocols by parent device 98 on computer 102, the Windows content advisor returns to providing all restrictions indicated.

In embodiments, child device 99 remains in computer 102 at the same time as parent device 98 and child device 99 and is directly linked to parent device 98 during setup of programmed vault 360 and backup 362. Alternatively, child device 99 is removed from computer 102 and at the next login with child device 99, parameters and configuration of vault 360 and backup 362 are uploaded into child device 99.

In still other embodiments, child device 99 is used only for login; such that all parameters are stored in vault 360 and backup 362 and the parameters are uploaded onto computer 102 with each login of child device 99. The many interaction protocols and methods to provide parameters and interactions between child device 99, vault 360 and backup 362 are well known to those familiar with the art.

In embodiments, there is an option to prohibit computer access, in general, unless child device 99 is plugged into computer 102. In this manner, the child cannot simply turn on computer 102 and, without child device 99, access the Internet, chat rooms, blogs, or e-mail without guidance by parameters.

As used herein, the term “blog” refers to a Web site that contains, inter alia, an online personal journal comprising reflections and/or comments provided by a writer associated with the Web site.

In embodiments, following configuration of child device 99, changes to parameters associated with child device 99 are only made with parent device 98, preventing child device 99 from being used to tamper with computer 102. In embodiments, a first parent device 98 allows a second parent device 98 privileges to modify specific parameters associated with child device 99.

In embodiments, an additional level of protection is provided against bypassing devices 98 and 99 by causing all Internet surfing and/or other parameters options 2380 to be provided through a dedicated secure proxy server, associated with devices 98 and 99.

### Internet Access Control

Following logon of parent device 98 and child device 99, parent device 98 optionally accesses a list of “Approved Internet Sites” 2382 wherein the parent chooses child accessible sites from a list of Internet sites, for example sites relating to science and education.

Additionally or alternatively to limiting Internet access to Approved Internet sites 2382, the parent has the option to enter a “block stage” 2384 and block Internet sites.

In conjunction with block stage 2384, the parent may enter a “Device word” stage 2386 and enter device words that cannot be used by the child. Blocked words are optionally tailored to specific situations. For example, the words “suicide” and “euthanasia” will be optionally blocked from a child that has been diagnosed with a terminal illness.

Additionally, at an “adult stage” 2388, the parent optionally blocks words or phrases that are associated with adult sites, for example “must be 18” to enter this site.

To prevent access to adult web sites, sites including checkboxes asking a user to click to confirm he is over 18 or including wording such as “must be 18” are optionally blocked. Additionally, devices 98 and 99 are optionally configured with graphic interface recognition protocols such that wording similar to “must be 18”, appearing in a graphic format will also be blocked.

Ignoring blocked key words and/or entering blocked web sites optionally causes shutdown of computer 102 or closing of the Internet link. Alternatively, a warning message is issued to the parent, for example, via a wide area network, an Internet channel, computer 102, server 470 and/or a proxy server; and the parent has the option to communicate with the child and/or shut down computer 102.

Optionally there are multiple levels of key words, for example words that shut off computer 102, words that shut off the Internet connection, words that trigger a warning on the display of computer 102 and an immediate message to the parent, and/or words that merely alert the parent without warning the child.

In addition to words from a web site in text or graphic format, computer shutdown and/or warnings are optionally triggered by child input of text, key words, passwords, and requests to visit a secondary Internet site that is reached via a primary Internet site.

The parent has the option to insert parent device 98 at any time, for example when the user of child device 99 is at school, and change Internet surfing parameters. Upon insertion of child device 99 into computer 102, the approved sites 2382, blocked sites 2384, block key words 2386 and/or adult parameters 2388 are updated to provide new parameters for the next child computer session.

### Blocked Sites

In embodiments the list of blocked sites 2384 is provided wholly, or in part, by a software program, for example Spector Pro by SpectorSoft Corporation of Vero Beach, Fla.

In embodiments, computer 102, parent device 98 and/or child device 99 are configured to receive automatic downloads of sites that have been tagged for blockage by Internet rating services.

In an “Unmonitored E-mail” stage 2390, and “Unmonitored Chat Rooms” stage 2396, parent device 98 has the option to specify e-mail addresses and chat rooms that are specifically un-monitored. For example, an unmonitored e-mail address may include an address of a divorced parent wherein monitoring of e-mail could present an embarrassment to the child.

There are several options for excluding chat rooms and/or e-mails from being monitored. In one option, agreements are made and/or modified only with by mutual agreement of parent and child, for example with both devices 98 and 99 in computer 102.

Alternatively, the parent changes the agreement without participation and/or agreement of the child, but a notification of the change is sent to the child via computer 102. In other options, the parent makes changes without the child agreeing and the child is not notified of the change.

In “key word block phase” 2386, parent device 98 may add key words, in addition to those entered for the Internet, that trigger blockage or warnings associated with e-mail addresses and/or chat rooms. For example, if the child writes or receives a message containing the word “porn”, the e-mail address involved is optionally prohibited from further communication.

In a “monitored e-mail” phase 2394 and a “monitored chat room” phase 2398, parent device 98 is additionally used to specify specific e-mail addresses and chat room sites that are prohibited, for example sites and/or addresses that encourage the child to make purchases.

In a “user limitation” phase 2344, parent device 98 is configured to provide parameters for use of device 99. For example in a “daily hours” phase 2346, hourly, daily, weekly or monthly schedules for permitting usage of computer 102 are entered.

In a “goals phase” 2348, parent data session management device 98 configures computer 102 and/or child device 99 with goal parameters whose attainment allows child device 99 to activate a reward from the group comprising, for example, extended computer use, access to designated computer games, and/or access to an Internet game site. Such goal parameters optionally include, for example, mathematics, reading comprehension, social studies, writing, and attaining a favorable assessment on at least one predetermined task.

Proceeding to a “recording parameters” phase 2352, parent device 98 optionally specifies how child device 99 and/or usage of computer 102 are to be recorded. Recording parameters 2352 optionally includes a series of screen shots, full-time video streaming, and image recognition.

In embodiments, recording phase 2352 optionally includes lists of chat sites and/or chat site conversations, instant messages, and emails. In embodiments, recording phase 2352 optionally includes lists of web sites visited, topics that were searched, and activities performed on, for example, MySpace.

In embodiments, recording phase 2352 optionally includes pictures posted by the child, pictures viewed by the child, and all keystrokes entered into computer 102.

In embodiments, recording phase 2352 optionally records how long the child spent at each site, URL (Uniform Resource Locators) database, all questions answered by the child, and a list of all downloaded files.

In embodiments, downloaded file lists optionally include the link as to where the file was found, and where, in computer 102, the child saved the file.

### Recording Computer Sessions

Additionally, in embodiments, video and/or audio streaming includes information on the link through which the video was located.

With reference to e-mails, recording phase 2352 optionally records technical information of the email servers, including inter alia, simple mail transfer protocol (SMTP). Additionally, recording phase 2352 records post office protocols (POP) for retrieval of e-mail from a remote server over a TCP/IP (Transmission Control Protocol of the Internet Protocol suite) through which connections and exchange of data streams takes place.

The many types of activities and protocols that are optionally recorded in recording phase 2352 are well known to those familiar with the art and a priori include all future activities and protocols that will be invented in the future.

In embodiments, data from recording parameters phase 2352 are stored in a “store” phase 2354 in parent device vault 350 or backup 352. Additionally, storage may be made in child device vault 360, child backup 362, with child access blocked.

FIG. 23D shows a typical session with child device 99 plugged into computer 102. Following “authentication” stage 2311, an “allowed” phase 2326 pops up on the screen and the child user chooses an allowed Internet site, chat site, and/or e-mail address.

Should child device 99 enter into an activity prohibited by a “prohibited” phase 2328, device 99 responds, for example, with a “notification” phase 2364, wherein computer 102 displays a warning that prohibited phase 2328 has been entered. Optionally computer 102 reverts back to allowed phase 2326 wherein allowed options are presented.

Alternatively, computer 102 enters a “shut down” phase 2362, wherein computer 102 is shut down pending, for example, input of parent device 98.

### Parent Notification

In addition to the above, a “rapid notification” phase 2366 is optionally activated so that a rapid notification 2366 is sent to the parent, for example via a wide area network, an Internet channel, a local server, and a proxy server. In embodiments, a message is displayed on a parent cell phone or other personal communication device (not shown) to alert the parent to communicate with the child.

Additionally or alternatively, for example following shut down phase 2362, the child is responsible for contacting the parent so that the parent activates computer 102.

In exemplary embodiments, child data session management device 99 is configured to enter a “request” phase 2372 to request a change in parameters that is sent to parent device 98. Request phase 2372 optionally sends the request via a wide area network, an Internet channel, host computer 102, server 470 and/or a proxy server.

In embodiments shown, parent device 98 and/or child device 99 are portrayed as being dedicated solely to computer monitoring functions. To those familiar with the art, it is easily understood that portable session management device 114 as described with respect to FIG. 1A, is optionally configured with protocols that are similar to protocols described above for parent device 98 and/or child device 99. In this manner portable session management device 114 is configured to provide a full range of encryption services, in addition to the many child guidance parameters presented above.

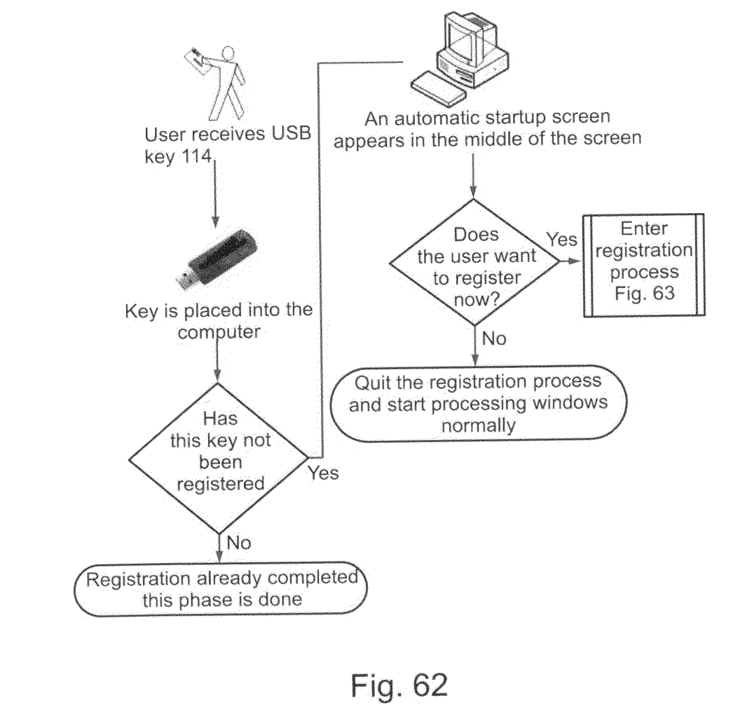

In embodiments shown, parent device 98 and/or child device 99 are portrayed as being dedicated solely to computer monitoring functions established between a parent and child. In alternative embodiments, multiple child devices 99 are issued to multiple, possibly adult, users. The users being, for example, members of a church while parent device 98 is issued to a group administrator, for example a religious leader. Parent device 98 is then used to establish computer use parameters that are consonant with, for example, religious belief and/or parochial school hours. In group usage of devices 98 and 99, the administrator optionally inputs special parameters, for example prohibiting web sites that promote witchcraft. Further details of group parameter establishment and usage of computer 102 are presented with respect to FIGS. 62-73.

### Additional Device Applications

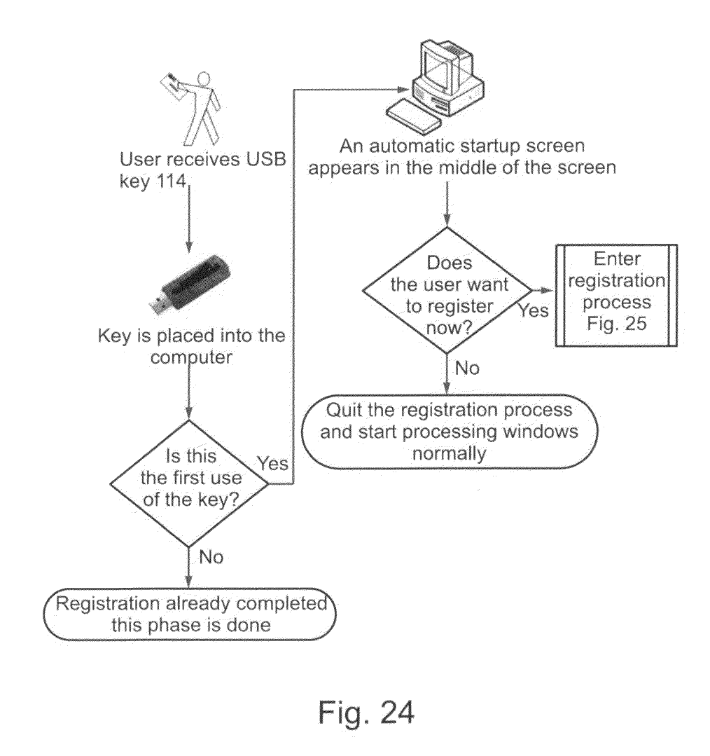

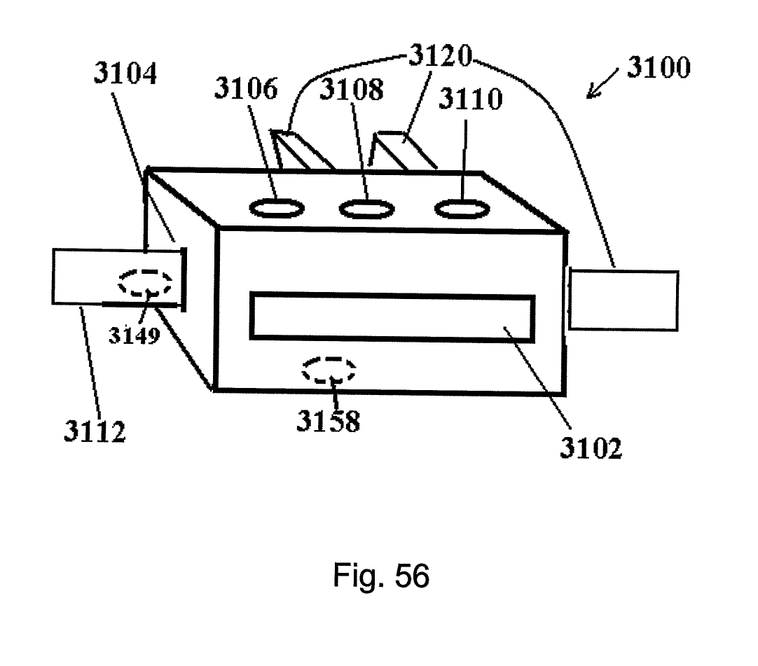

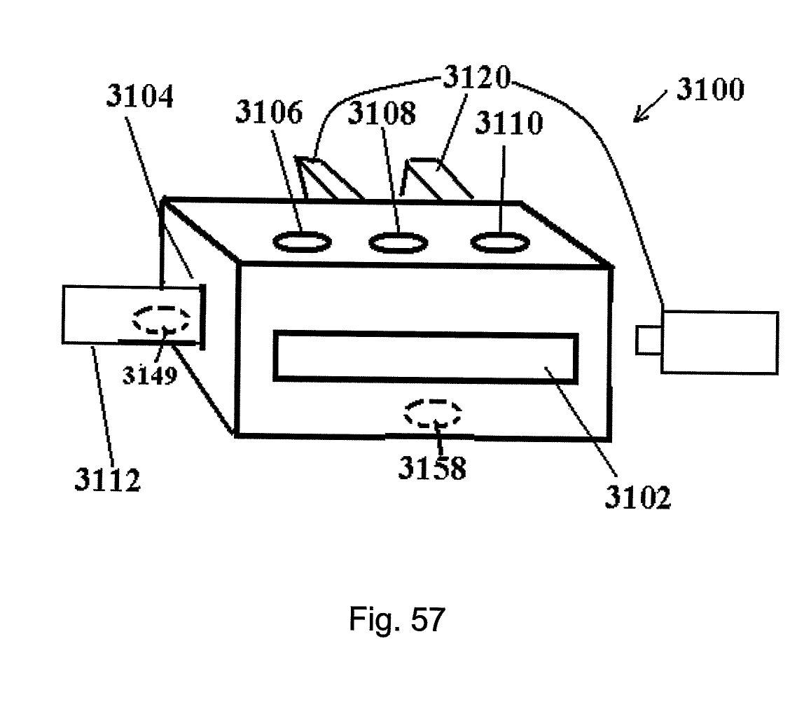

Additional applications of portable session management device 114 will be presented, including safe purchasing, parental control, and safe messaging. FIGS. 24 through 73 include a review of some of the previously presented processes, as well as processes that serve as operating platforms for additional applications that will be described below.

FIG. 24 shows receipt of portable session management device 114 thru the registration process. The user receives portable session management device 114, inserts portable session management device 114 into a USB port found on the computer and is prompted to make a decision as to continue on to the registration process.

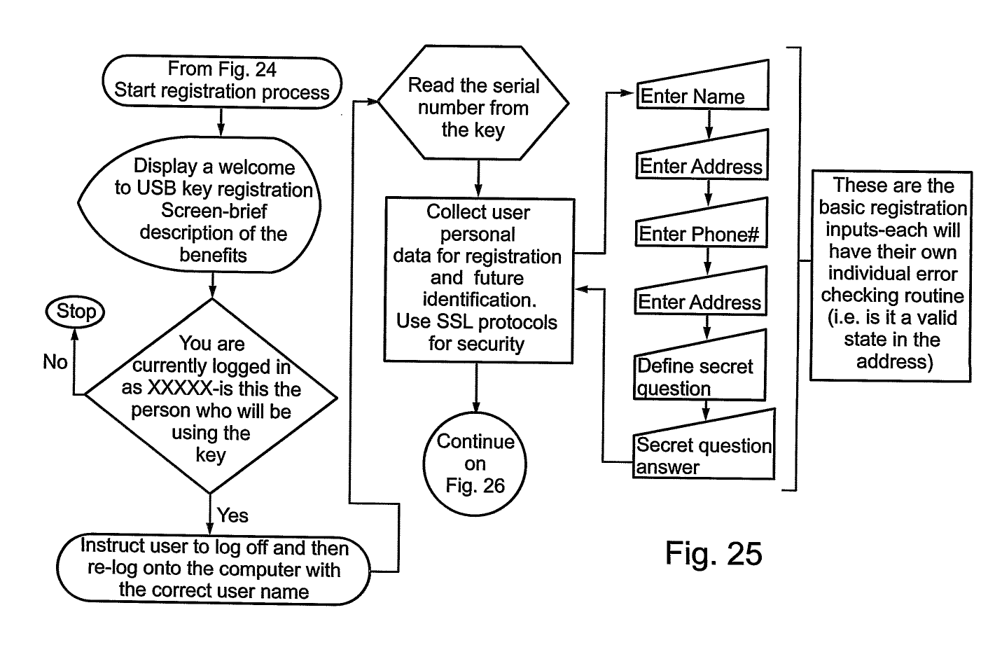

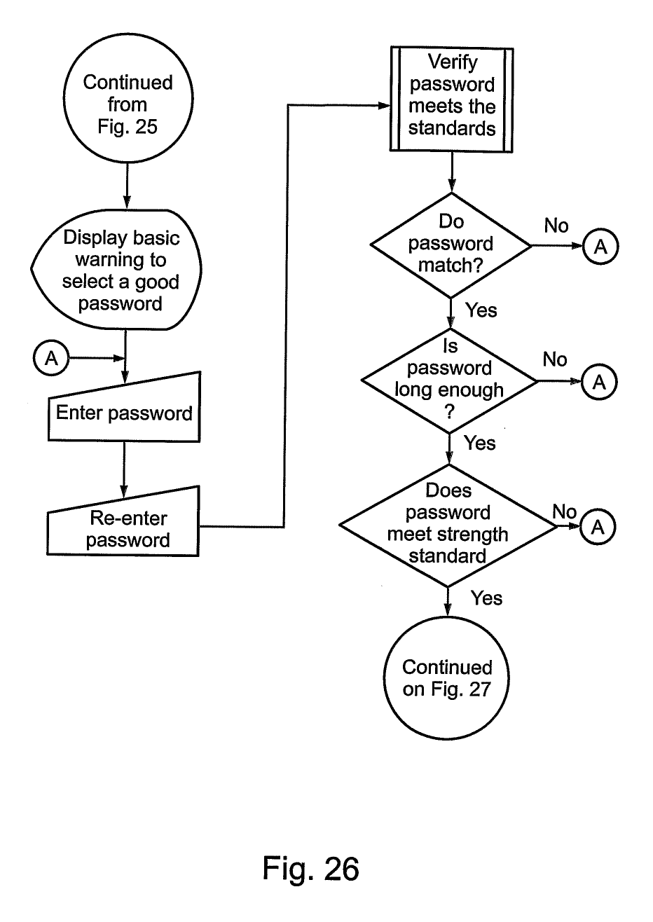

FIGS. 25-30 show the continuation of the registration process and user selection of desired functions, for example backup (FIG. 31), the end of the registration process.

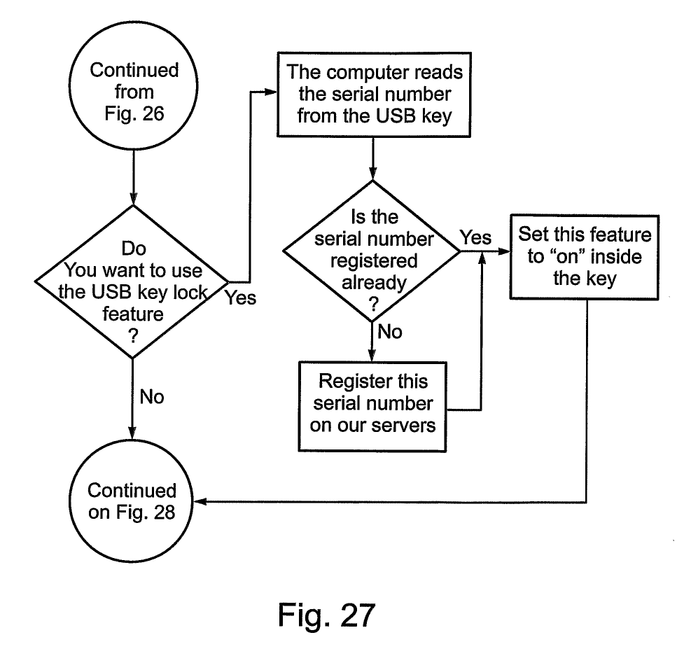

FIG. 25 shows user identity authentication that is used in the future to recover lost or damaged portable session management device 114s. In FIG. 26, the user selects a login of sufficient length and strength necessary to meet the minimum requirements, for example as dictated by company and/or government policy.

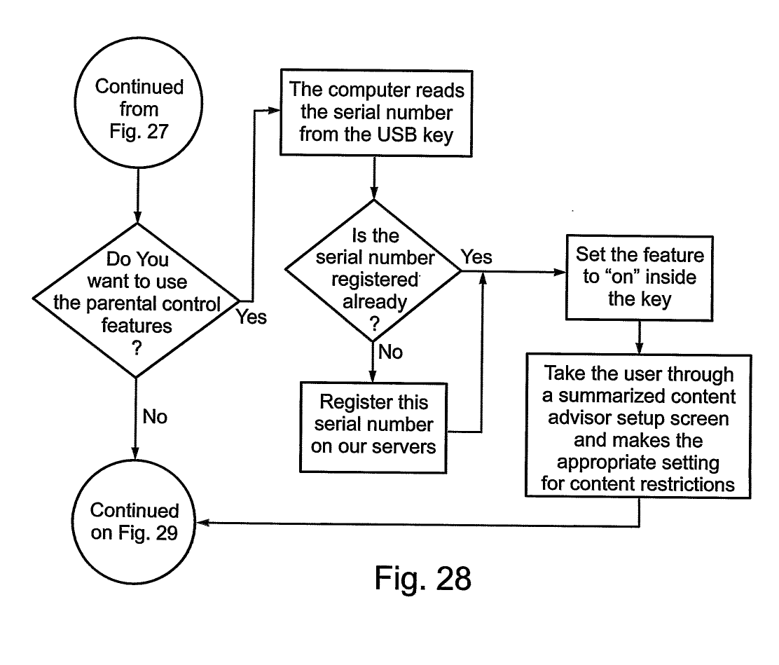

FIG. 27 shows the process by which the host computer reads the serial number of portable session management device 114 and authenticates through the Internet that this portable session management device 114 has not already been registered to another person.

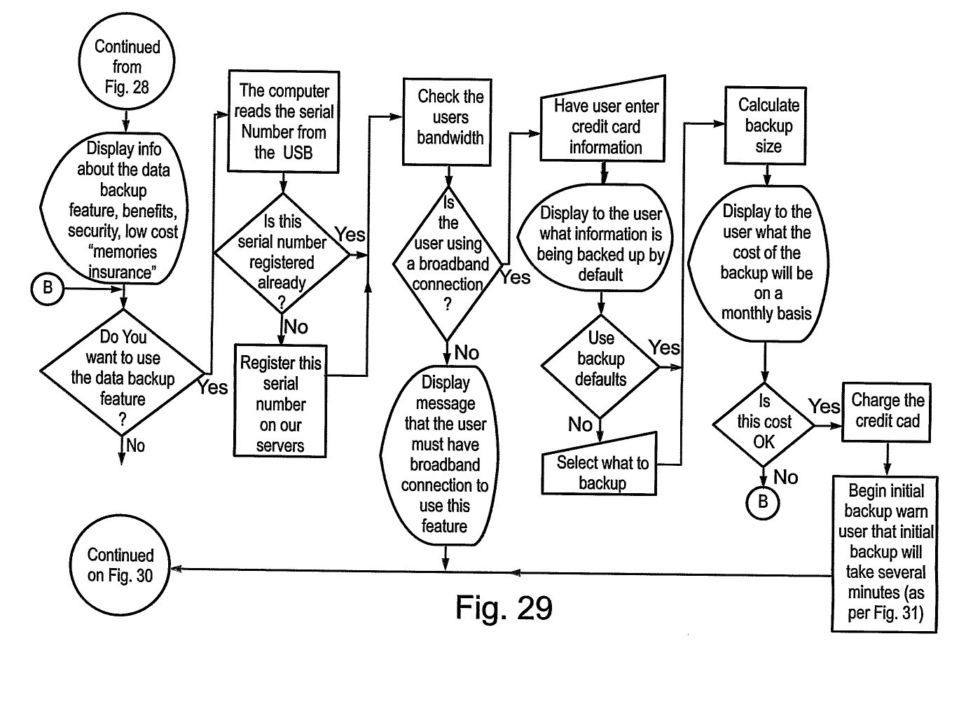

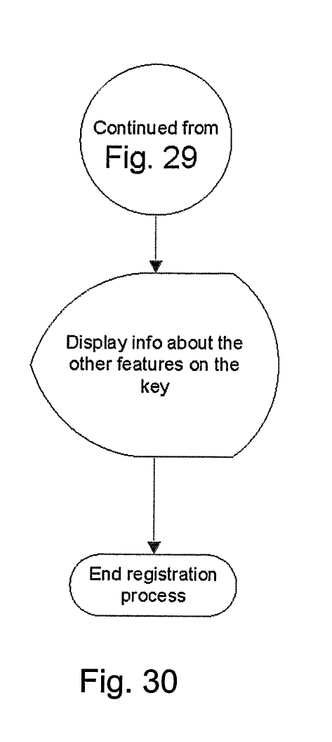

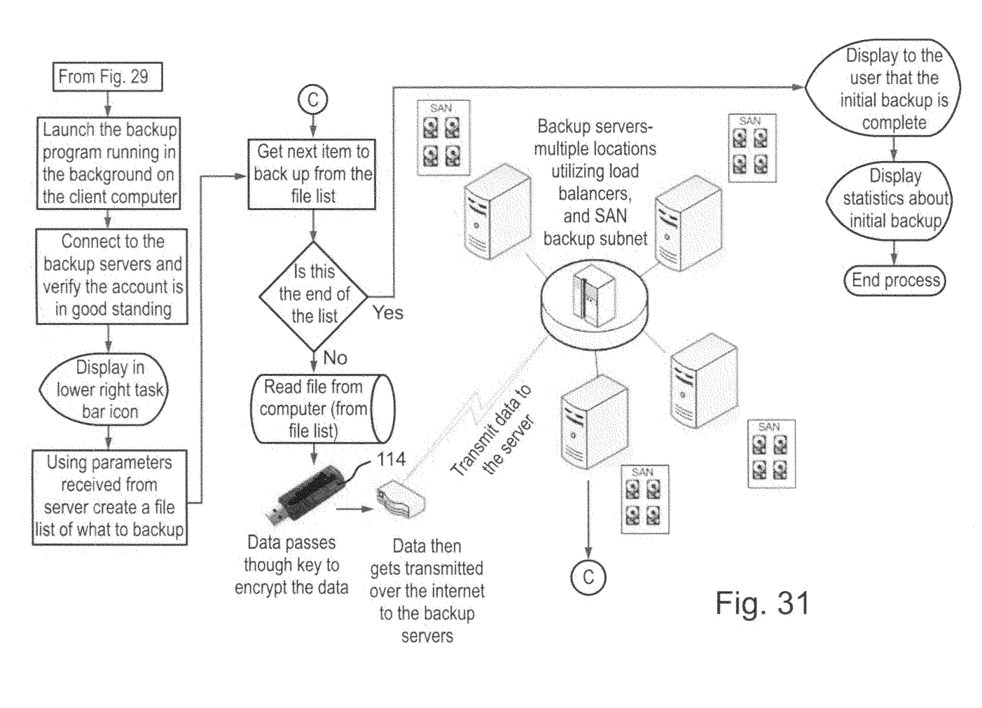

If portable session management device 114 has not been previously registered, as seen in FIGS. 28-29 the functionality selection continues. In FIG. 30 a summary is shown to the user about which features they have selected and the process ends.

During functionality selection, the user has the option to select remote backup, the selection of which causes the backup to work in the background, as seen in FIG. 31.

To initiate remote backup, the user begins by creating a list of directories and files that are to be backed-up. Data on portable session management device 114 is automatically included in the backup by default.

Typically, the file list is processed sequentially and encrypted prior to transfer over the Internet. Each encrypted file includes the serial number of portable session management device 114 as well as information as to the encryption process used. The encryption process for a given user is optionally selected according to company and/or government parameters. Backup continues until all files on the file list have been processed.

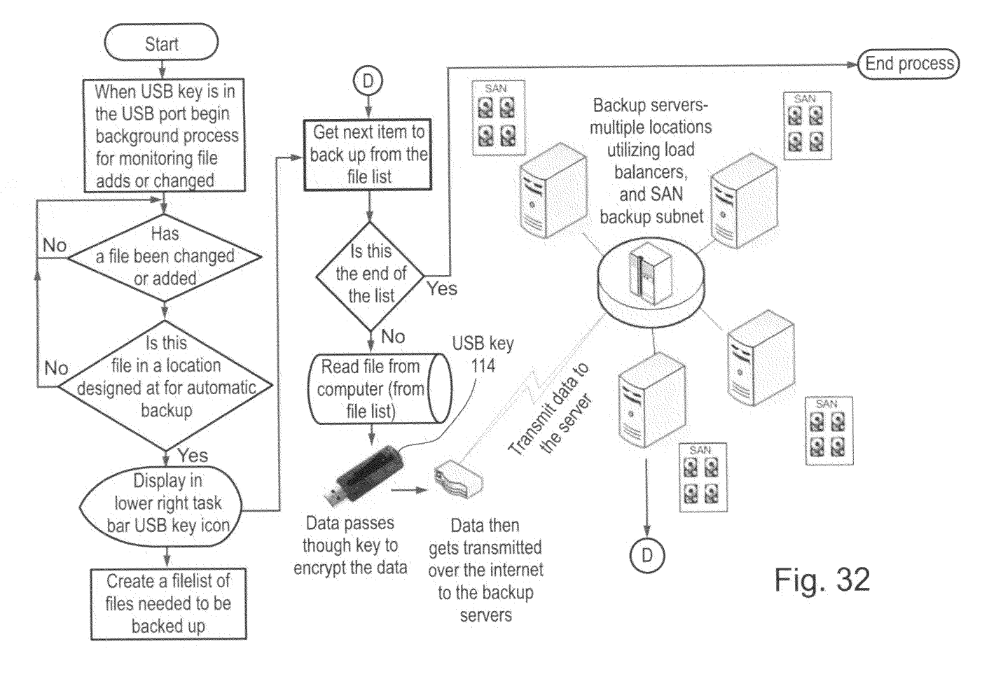

FIG. 32 shows the process that is initiated when the user chooses incremental backup. Upon introduction of portable session management device 114 into a USB port, a background process begins which retrieves the account information for this device to determine whether the user is participating in the remote backup feature. If the user is shown to be participating then a list of those locations being remotely backed up will be created. The directories found on this list that had been created will be monitored, and any file added or changed while portable session management device 114 is in the USB port; and if something has been added or changed when there is a broadband connection to the Internet, will be copied to the remote servers.

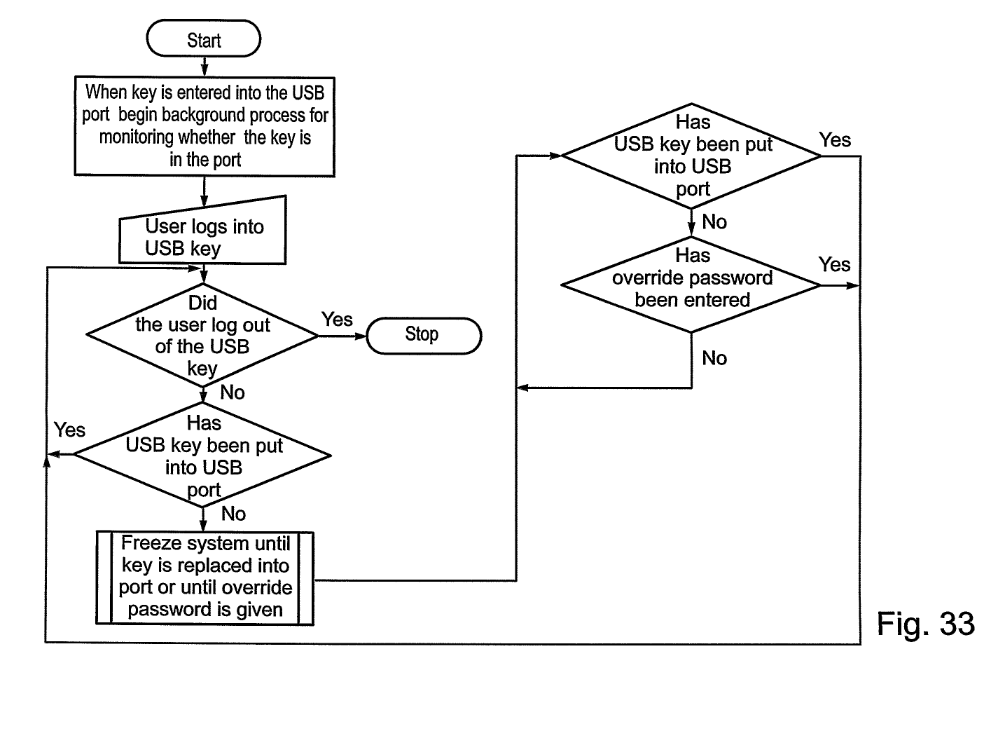

FIG. 33 shows the startup and functions of the Secure PC lock. If this feature is selected to be used during the registration, then when portable session management device 114 is placed into a USB port and the user logs into portable session management device 114, a background process will begin and continue monitoring the USB port to see if portable session management device 114 has been removed. When portable session management device 114 is removed, the system will bring up the screen saver and require the user to log back into the computer prior to being able to process.

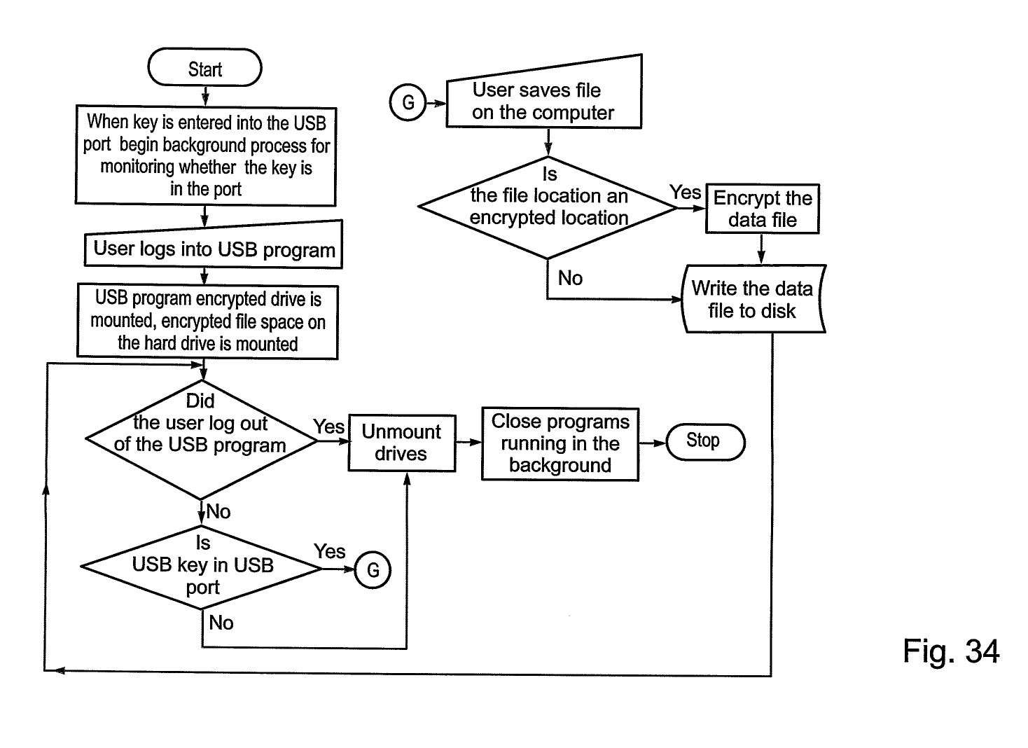

FIG. 34 shows startup and functions of the encryption available thru portable session management device 114, whether stored on portable session management device 114 or on a computer memory storage device.

When portable session management device 114 is placed into the USB port on the computer, the area of the hard drive and portable session management device 114 that were selected to be encrypted are mounted and do not show up as available devices. Any files written to these mounted areas will be encrypted automatically.

Any encrypted files stored in these locations are decrypted automatically upon selection by the associated application. The encryption and decryption processes continue until the user logs out of portable session management device 114 or removes portable session management device 114 from the USB port.

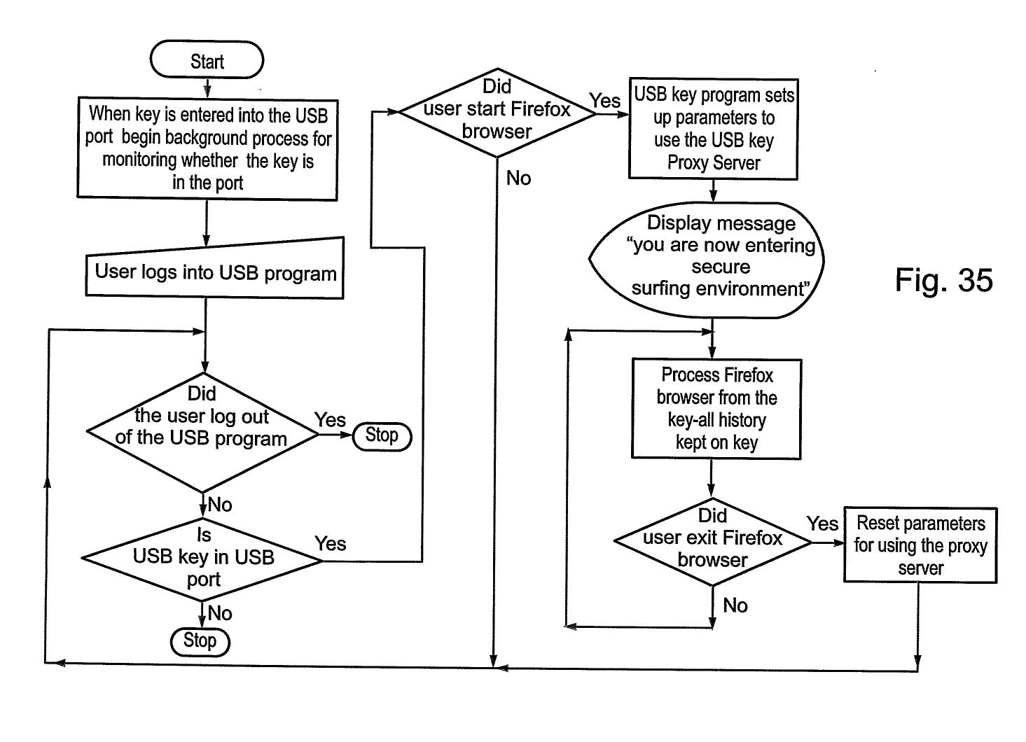

FIG. 35 shows set up and functions of the anonymous surfing of the Internet feature. While portable session management device 114 is in the USB port and the user is logged on, the user browses with, for example a Firefox browser.

In embodiments, portable session management device 114 sets up the browser to use portable session management device Internet-based proxy server that is run from portable session management device 114. Portable session management device 114 collects file and temporary files associated with using the Internet browser that has been loaded onto the device. Optionally, the Internet browser loaded on the hard drive is not used. File collection continues while the user is using the Firefox browser, portable session management device 114 is in the USB port and the user is logged with portable session management device 114.

### Parental Control Device

FIG. 36 shows a parental control lock feature in which a user is logged into portable session management device 114 and the Windows content advisor has been enabled. Upon insertion of the parent control device, a background process temporarily suspends the content advisor. Suspension continues until the parent control portable session management device is removed from the USB port or the user is logged out of that portable session management device 114. Following logout, the Windows content advisor will return to providing all restrictions indicated.

### Anonymous Subscription Service

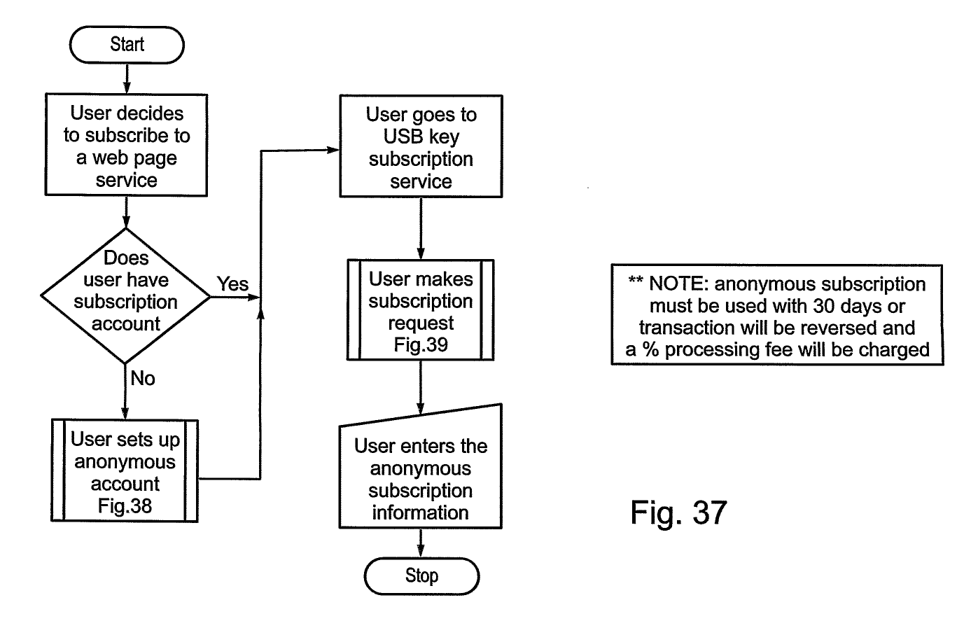

FIGS. 37-39 show a simplified pictorial illustration of the setup, functionality and use, including account set up, of the anonymous subscription service.

FIG. 37 shows that after having made the decision to subscribe anonymously to a web-based service, the user accesses the web services with the aid of portable session management device 114.

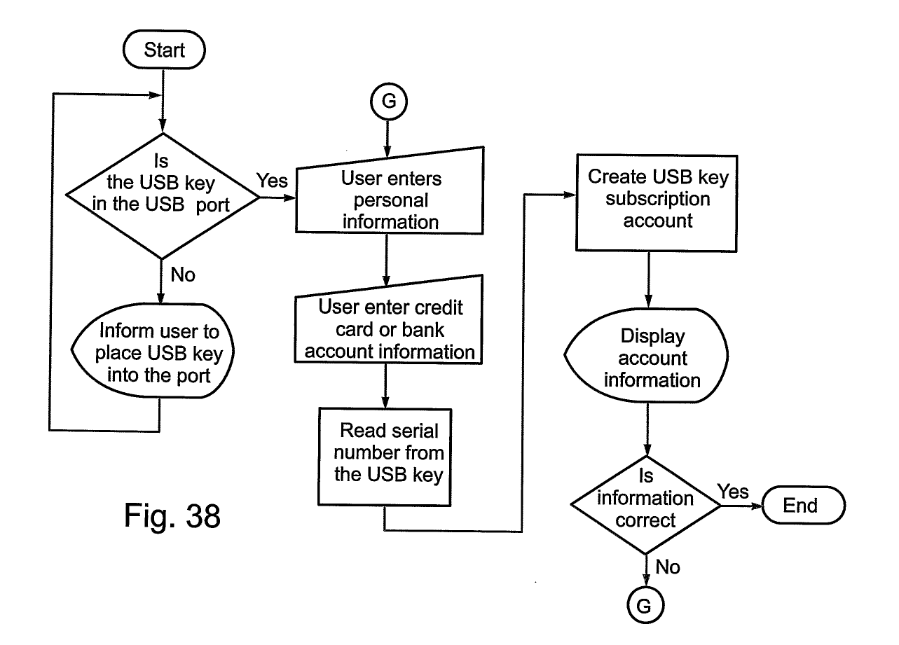

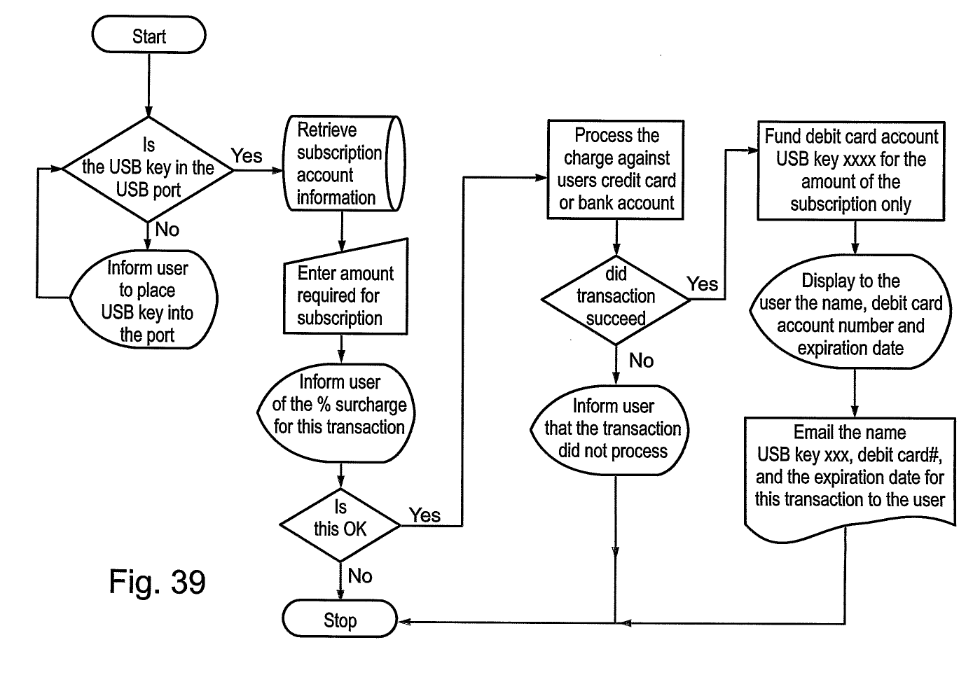

If the user does not have an anonymous subscription account set up, the user will have the ability to do this in FIG. 38. Using the information received from the subscription request made to portable session management device Internet Proxy Server as received from FIG. 39, the user subscribes anonymously to the web-based service, as long as portable session management device 114 is plugged into the USB port of the computer.

In FIG. 38 the user has the ability to set up an anonymous portable session management device Internet Proxy Server subscription account. The user enters information needed to process charges against a credit card or a bank account by which the subscription is anonymously made. All information is cataloged and stored based upon the serial number located on portable session management device 114.

In FIG. 39, the user makes a request to portable session management device Internet Proxy Server to subscribe to a web service anonymously. Using portable session management device 114 to look up the account information, the user is prompted to enter the cost of the web service requested. After the user accepts purchase charge and processing service charge, the total charge is processed against their credit card or bank account.

After receiving approval from the user's bank for the charge, a debit card is initialized for the user with the amount requested, and the user is given the anonymous information required (account name, account number, expiration date, etc) to sign up for the web service.

### Anonymous Purchasing

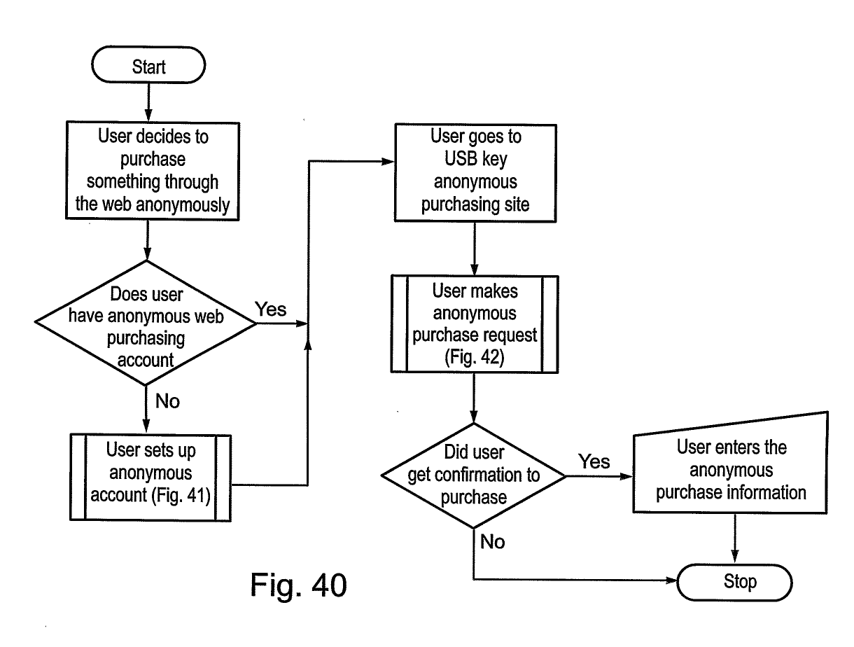

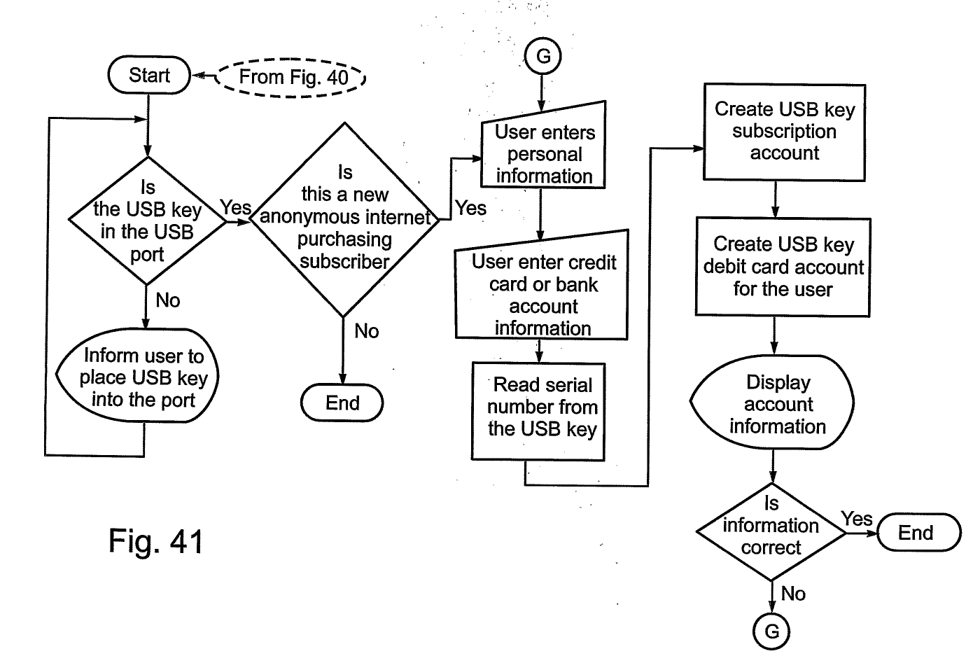

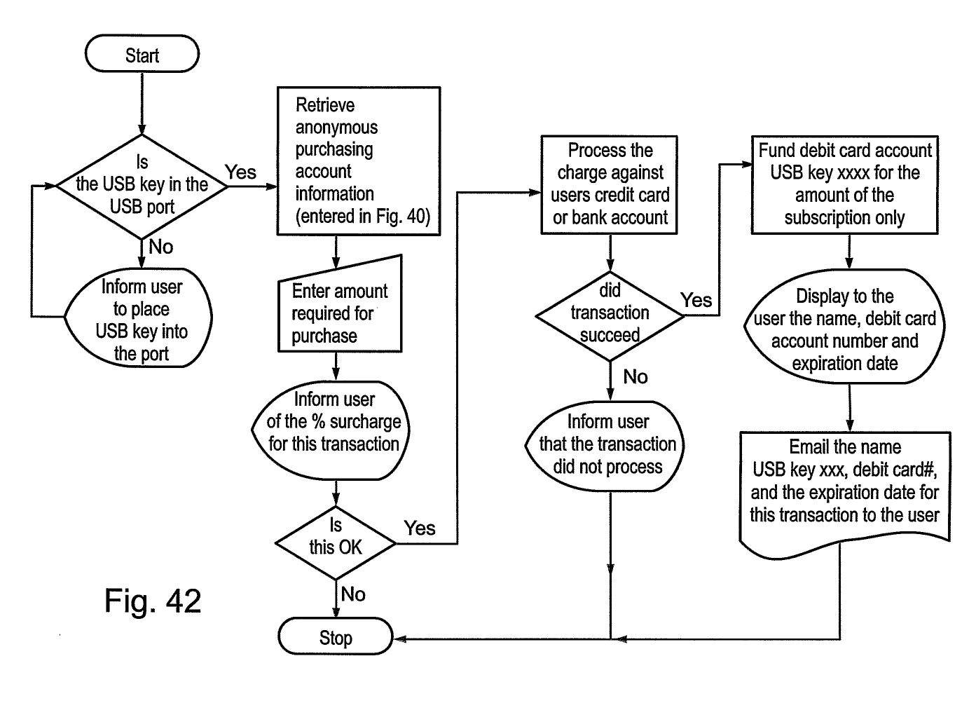

FIGS. 40-42 show anonymous Internet purchasing service account setup and use. FIG. 40 shows that after having made the decision to purchase something thru the Internet anonymously, the user uses portable session management device 114.

If the user does not have an anonymous purchasing account set up, the user has the option to set up such an account as shown in FIG. 41 where the user enters information needed to process charges against their credit card or bank account; information that is encrypted along with serial number 118.

Using the information received from the purchasing request made to portable session management device Internet Proxy Server, as seen in FIG. 42, the user makes the anonymous purchase and may continue to purchase anonymously as long as portable session management device 114 is in the USB port of the computer.

FIG. 42, a continuation of FIG. 40 shows the user making a request to portable session management device Internet Proxy Server to purchase anonymously. Using portable session management device 114 to look up the account information, the user is prompted to enter the cost of the item to purchase.

After the user authenticates that he will accept the purchase and service charges, the charge is charged against the user's credit card or bank account. Following approval from the user's bank or credit card, a portable session management device debit card is initialized for the user with the amount requested. Additionally the user is given the anonymous information required (account name, account number, expiration date, etc) to purchase the item anonymously.

### Secure Instant Messaging

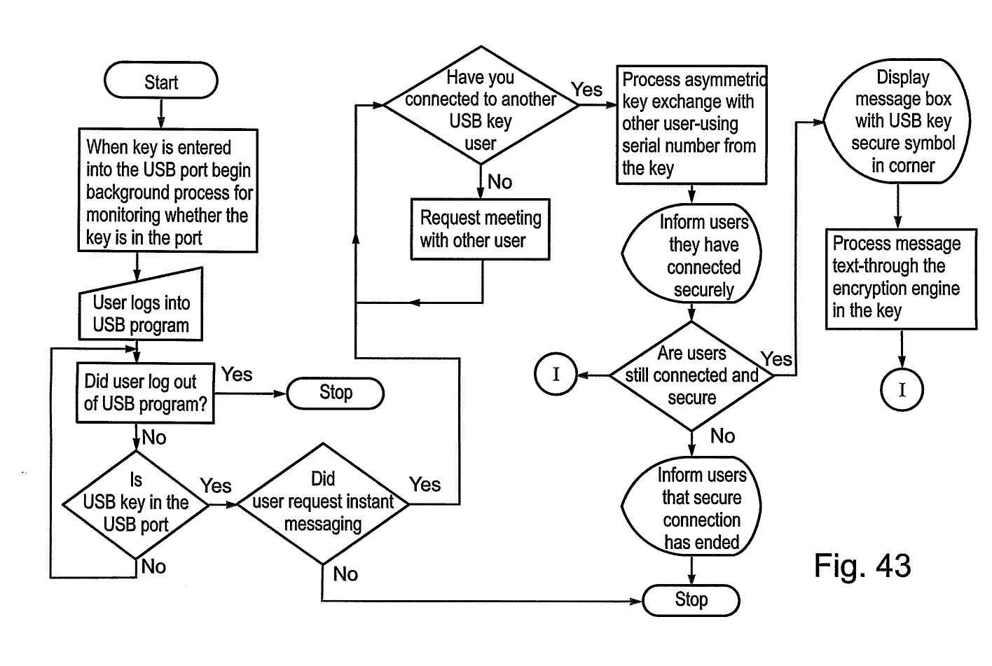

FIG. 43 shows a simplified pictorial illustration of the set up and functionality of the secure instant messaging feature. While portable session management device 114 is in the USB port and the user is logged into portable session management device 114 and optionally initiates an instant messaging session with another user of portable session management device.

While both of the users have portable session management devices 114 in USB ports of their computers and are logged onto their respective portable session management devices 114, the instant messaging session continues and remains secure. Each message is encrypted at the message initiation site and decrypted at the message-receiving site.

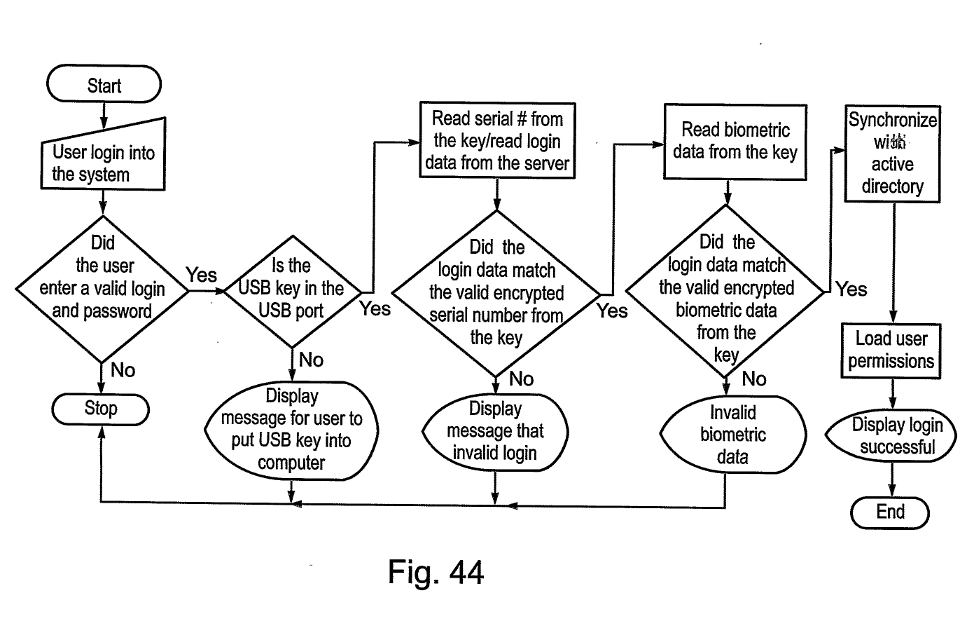

FIG. 44 shows a simplified pictorial illustration of the setup implementation of a multi-factor authentication in a Windows server environment using portable session management device 114. Portable session management device 114 typically includes at least one additional security level in the form of positive authentication for the person logging into the computer and/or the network.

Additionally, second and third additional security levels are included, each additional security level requiring additional authentication parameters. Multi-factor authentication is optionally integrated into the Windows server environment.

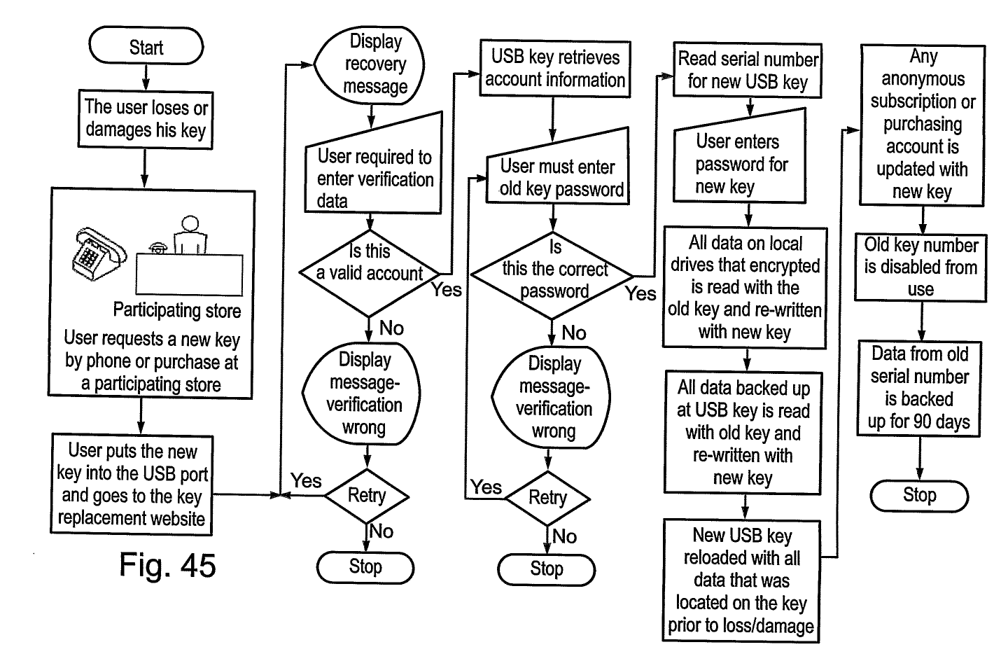

FIG. 45 shows a simplified pictorial illustration of the procedure for the user to receive and activate a new portable session management device 114 upon the loss or destruction of the user current portable session management device 114.

FIG. 45 shows that the replacement process begins after portable session management device 114 is either lost or rendered unusable by damage. The process includes authentication of ownership of the lost or damaged portable session management device 114. After authentication, a new registration record for new portable session management device 114 is created. The data on old portable session management device 114 is decrypted and the decrypted data encrypted and stored on the new session management device.

In addition, the serial number of the damaged or lost portable session management device 114 is then flagged and disabled, to prevent future misuse, for example by a person who has stolen device 114, or has managed to repair portable session management device 114.

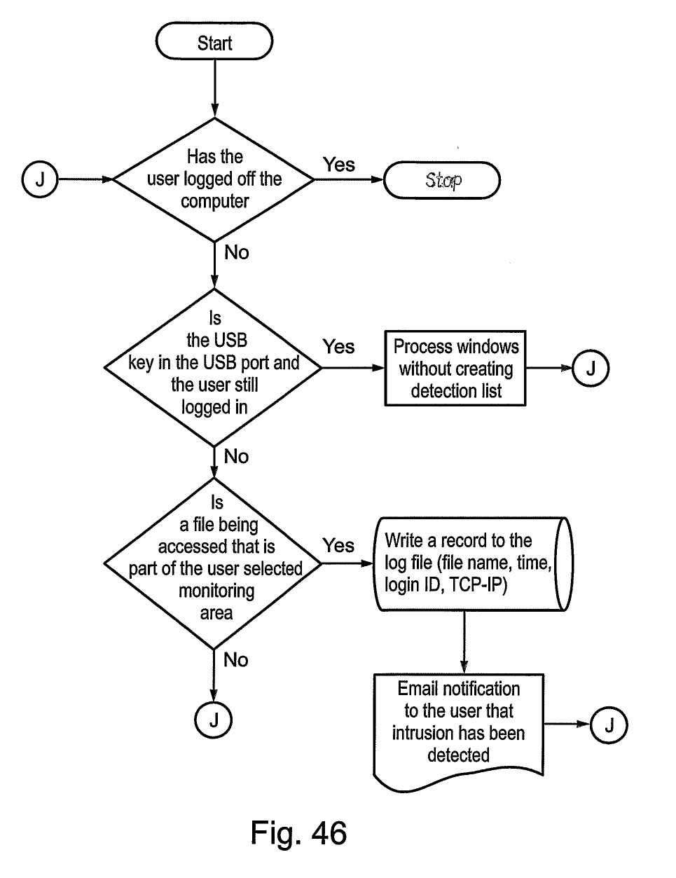

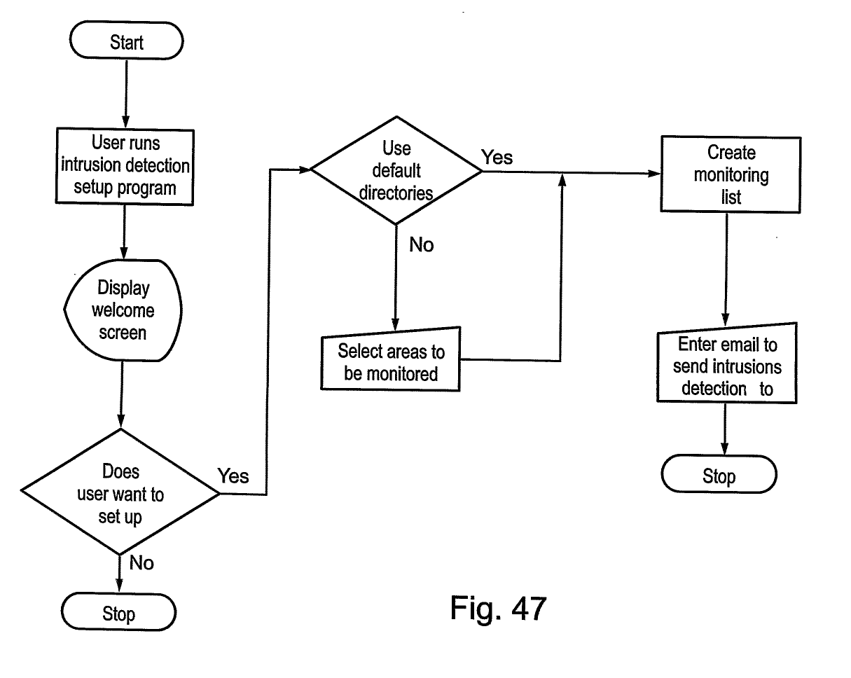

FIGS. 46-47 show how portable session management device 114 alerts the user if files are accessed or modified without user knowledge. FIG. 46 shows the flow of the process whereas use of portable session management device 114 enhances security. For example, if portable session management device 114 is not in the computer USB port and an intruder enters one of the directories selected for monitoring during setup, referenced in FIG. 47. Any intruder access, additions or changes to any file cause a log entry to be created and the user is e-mailed.

The e-mail address is typically recorded during the functional setup (FIG. 47). Additionally or alternatively, immediate notification of intrusion takes place via a hand held device such as a PDA or cellular telephone.

In embodiments, the user sets up a custom system for monitoring intrusions, for example specific to files or hardware areas to monitor. Alternatively, the user opts to accept the default monitoring supplied with portable session management device 114.

### Secure Group Member Communication

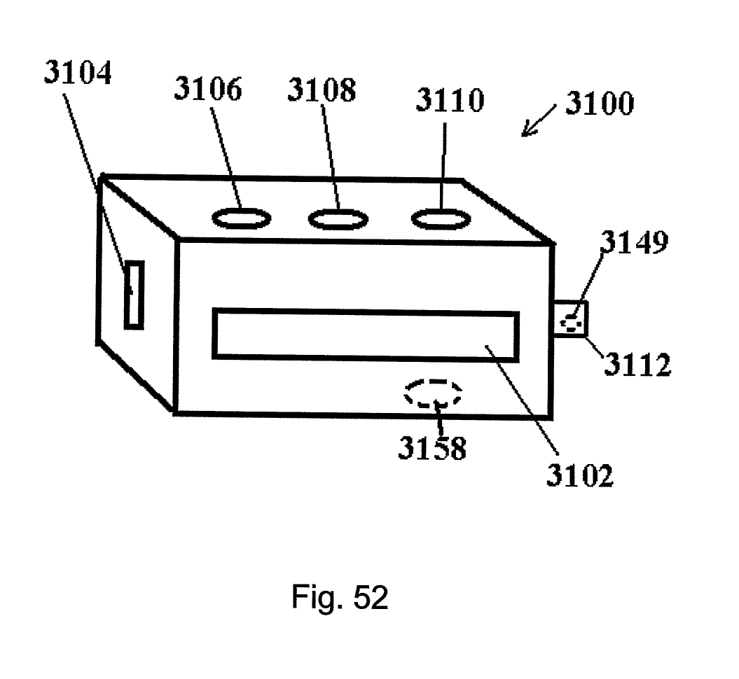

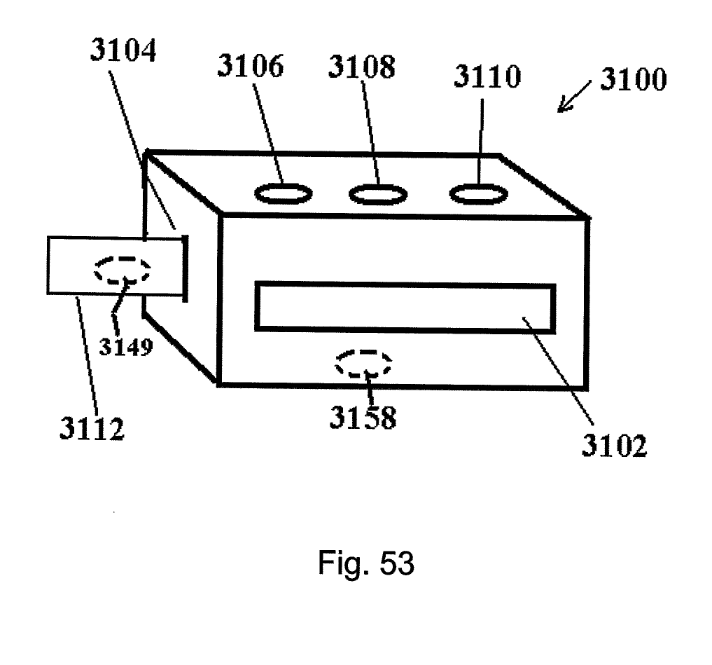

FIG. 52 shows a coupling device 3100 having an administrator input 3104 that, as seen in FIG. 53, has an administrator session management device 3112 inserted therein. Typically, administrator session management device 3112 includes an administrator session management engine.

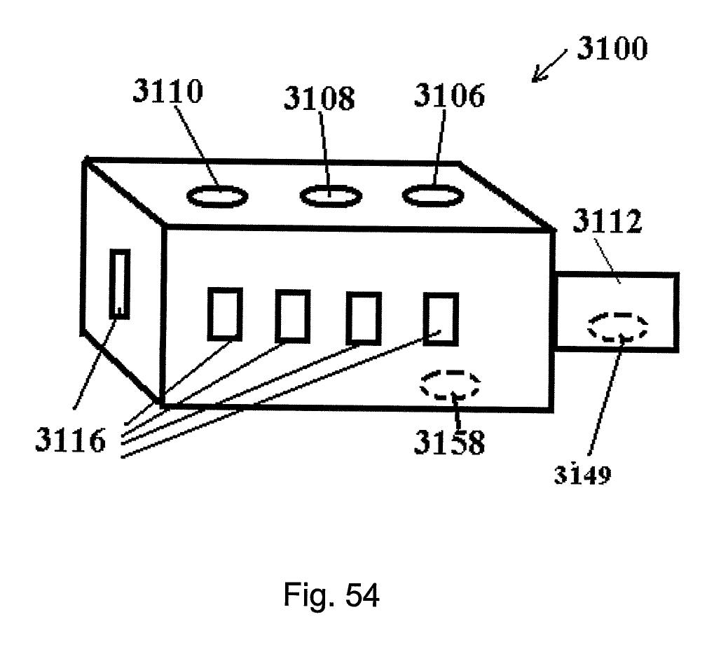

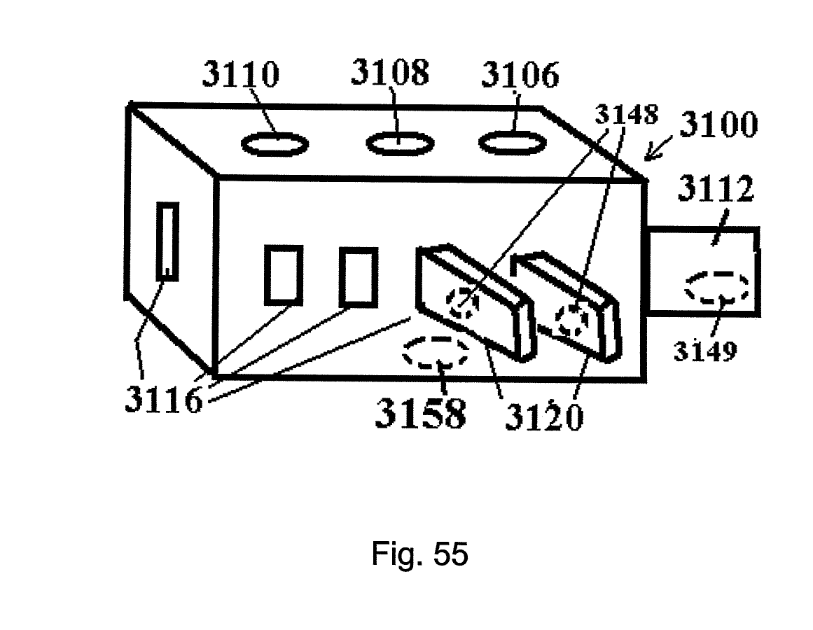

As seen in FIG. 54, coupling device 3100 includes a multiplicity of group input ports 3116 and, as seen in FIG. 55, multiple group session management devices 3120 have been inserted into input ports 3116.

Each of group session management devices 3120 includes a concealed encryption engine 3148 that is responsive to a concealed administrator encryption engine 3149.

As seen in FIG. 55, after input of devices 3112 and 3120, a first session begins, and a random button 3108 is pushed that creates a randomly derived common encryption setting. Typically a display 3102, controlled by a display control button 3106 is pressed and a visual signal is transmitted confirming that the random encryption setting is ready for transmittal.

Upon pushing a record button 3110, all devices 3120 in ports 3116 receive the common encryption setting created by coupling device 3100 on encryption engines 3148 and 3149. The encryption engine typically includes a six digit meeting number indicating, for example, the date of the meeting.

Following completion of the reception, coupling device 3100 removes and/or renders invisible any trace of the common encryption setting from coupling device engine 3158.

Each of group session management devices 3120 is removed from input 3116 and taken by respective members of the group.

At a future date and time, group session management devices 3120 and administrator session management device 3112 are input into remote devices, for example cellular telephones and/or computing devices (not shown).

Upon start of communication, encryption engines 3148 and 3149 communicate directly with each other without being inscribed in the memory of the remote devices, thereby preventing contamination of devices 3120 or 3112, for example with a Trojan horse. Additionally, direct communication prevents detection and/or interception of encryption codes contained on encryption engines 3148 and 3149.

During a given session, devices 3112 and 3120 are able to communicate with each other, for example encrypting data for safe transfer directly between devices 3112 and 3120.

Optionally, following completion of a given session of data transfer from the remote locations, at least one of devices 3120 generates a new common encryption setting to all devices 3112 and 3120. The new encryption setting provides the ability for devices 3112 and 3120 to communicate directly at another session.

In alternative embodiments, administrator session management device 3112 issues the changed encryption code to group devices 3120 (FIG. 55).

In embodiments, administrator session management device 3112 is capable of running several remote meetings between different users belonging to different groups. For example, a user group having group session management devices 3120, group “A” are optionally computer software programmers from a certain company while another group, group “B” comprises physicists employed by the same company. Group “A” transfers data with administrator device 3112 and between members of group “A”. Group “B” transfers data with administrator device 3112 and between members of group “B”. However, group “A” devices 3120 cannot exchange information remotely with devices 3120 of group “B”.

Optionally, communication between session management devices 3112 and 3120 occurs via a wide area network, an Internet channel, a local server and/or a proxy server.

In embodiments, group session management devices 3120 comprise USB or flash drives and are input into ports 3116.

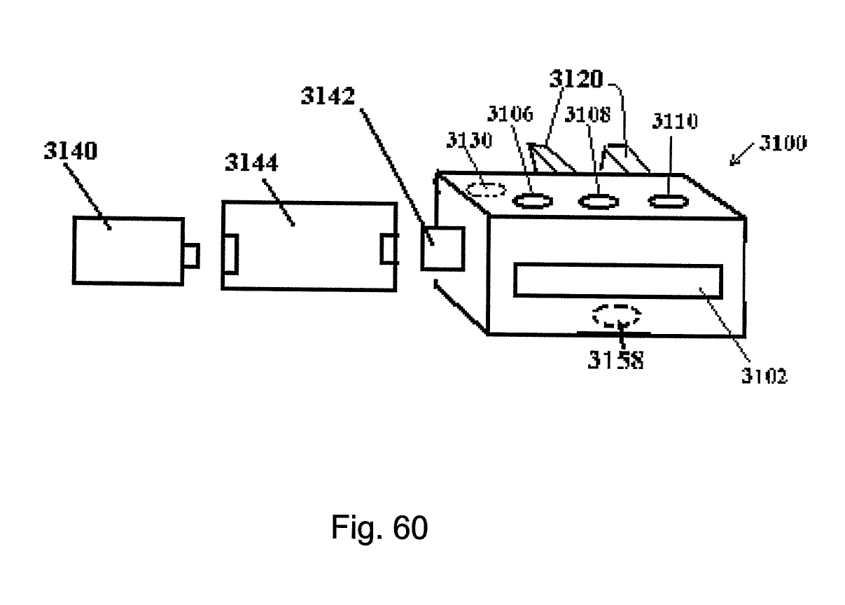

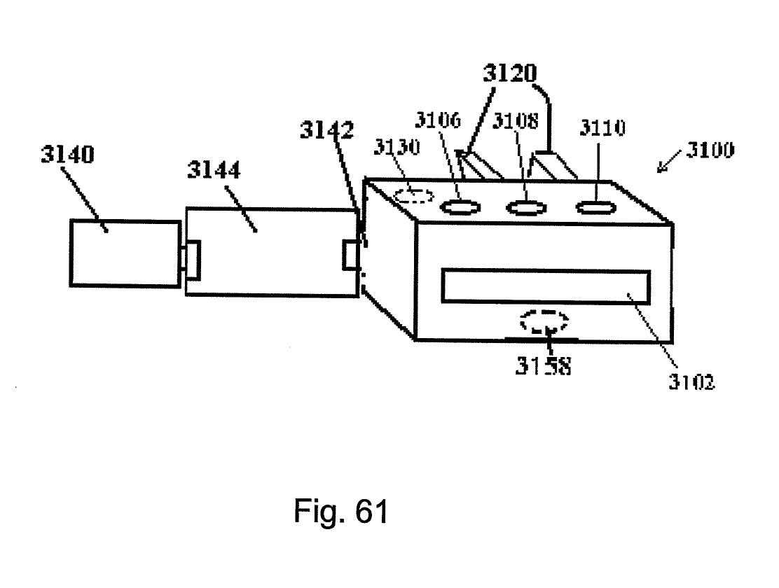

FIGS. 60 and 61 show coupling device 3100 in which a rechargeable battery 3130 is being recharged by a charger 3140. In embodiments, coupling device 3100 includes a charger connection 3142 and an adapter 3144, which is used to connect charger 3140 to coupling device 3100, thereby charging battery 3130.

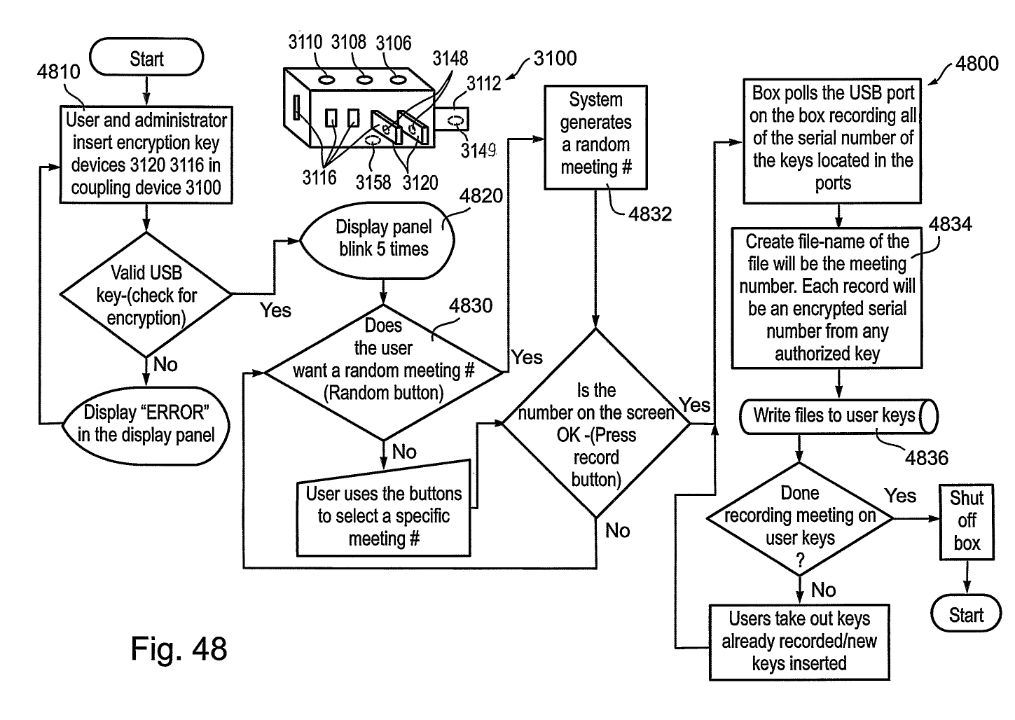

FIG. 48 shows a flowchart 4800 of the process of using coupling device 3100 to provide encryption codes to team members that are loaded onto encryption engines. In a stage 4810, the system manager, also referred to herein as the system administrator, and the users, input portable session management devices with box 3100, also referred to herein as coupling device 3100.

In a stage 4820, display panel 102 (not shown) provides a signal, for example a light that blinks, to signal that all session management devices 3120 and 3112 are in coupling device 3100. In stages 4830 and 4832, a random meeting number is created to provide to all session management devices 3120 and 3112. In stages 4834 and 4836, encryption engine codes are created and recorded on each session management device 3120 and 3112.

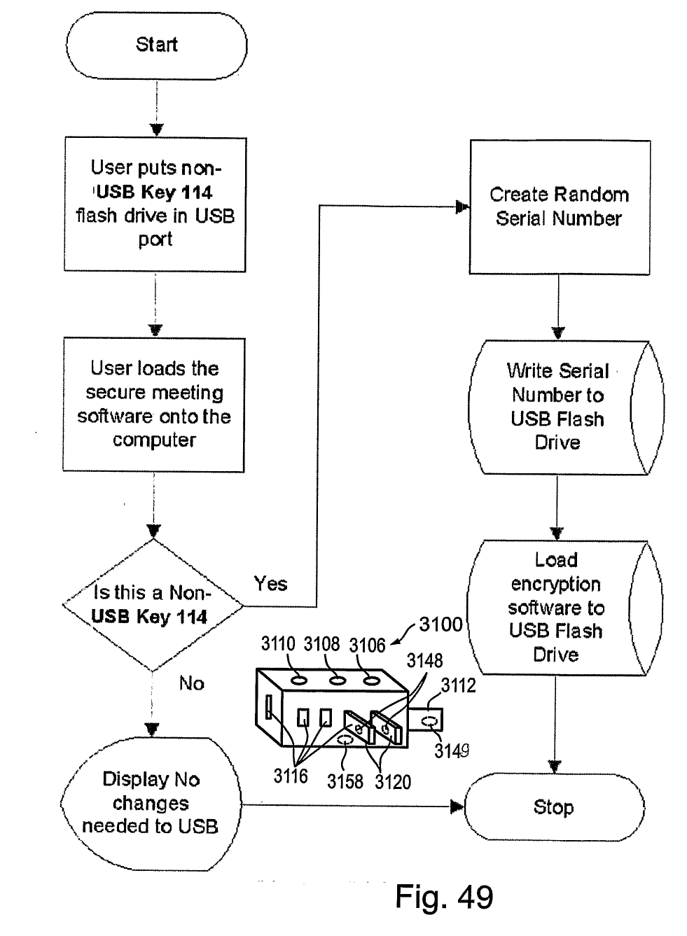

FIG. 49 shows a flowchart of implementation of a non-USB flash drive device used like portable session management device 114 of the present invention that plugs into a USB port. A software encryption program is optionally provided with coupling device 3100 (FIG. 52). The non-USB flash drive device is issued a serial number and the encryption engine is input into one of inputs 3116.

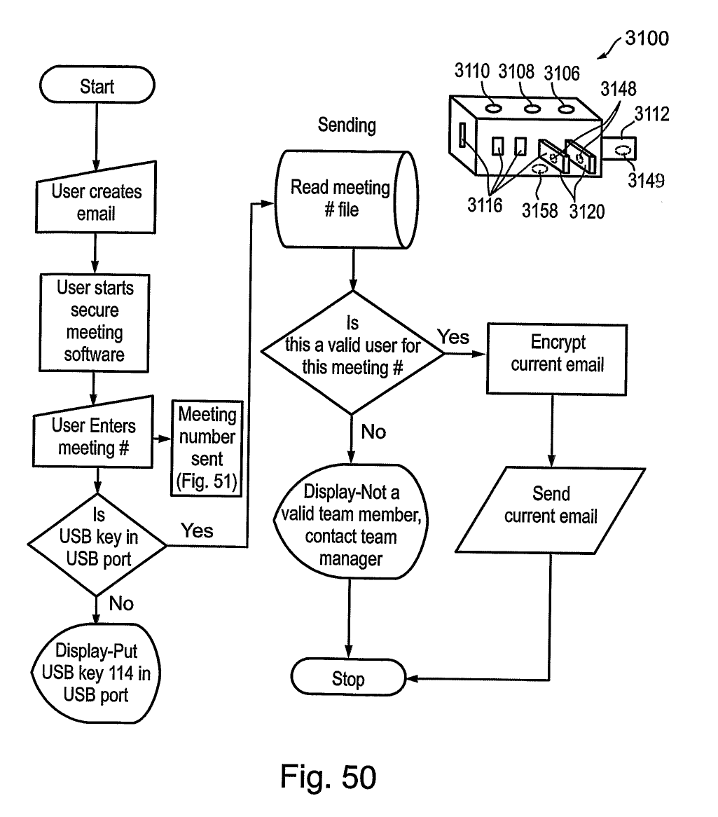

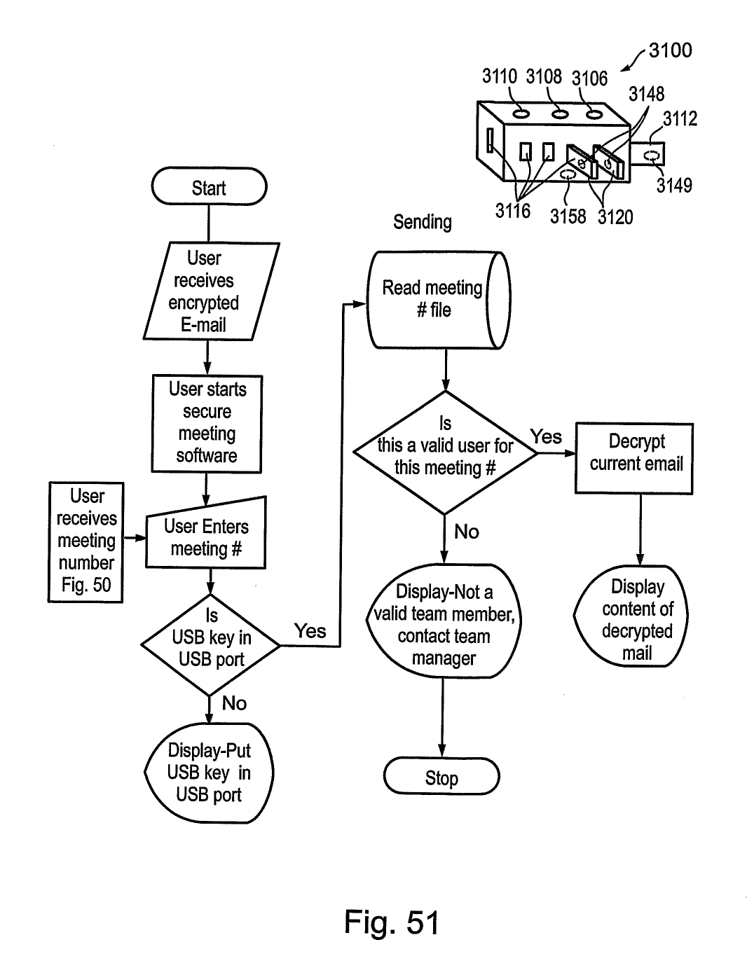

FIG. 50 shows a protocol for sending e-mail on the session management devices 3112 from remote locations. FIG. 51 shows a protocol for receiving e-mail messages using devices 3112 at remote locations.

### Anti Spam

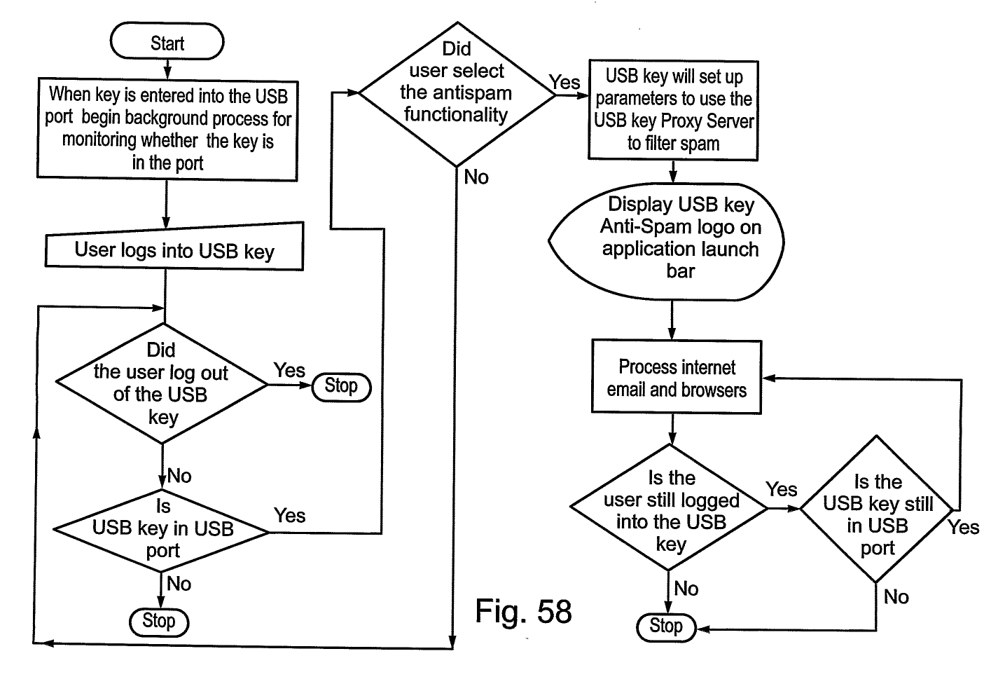

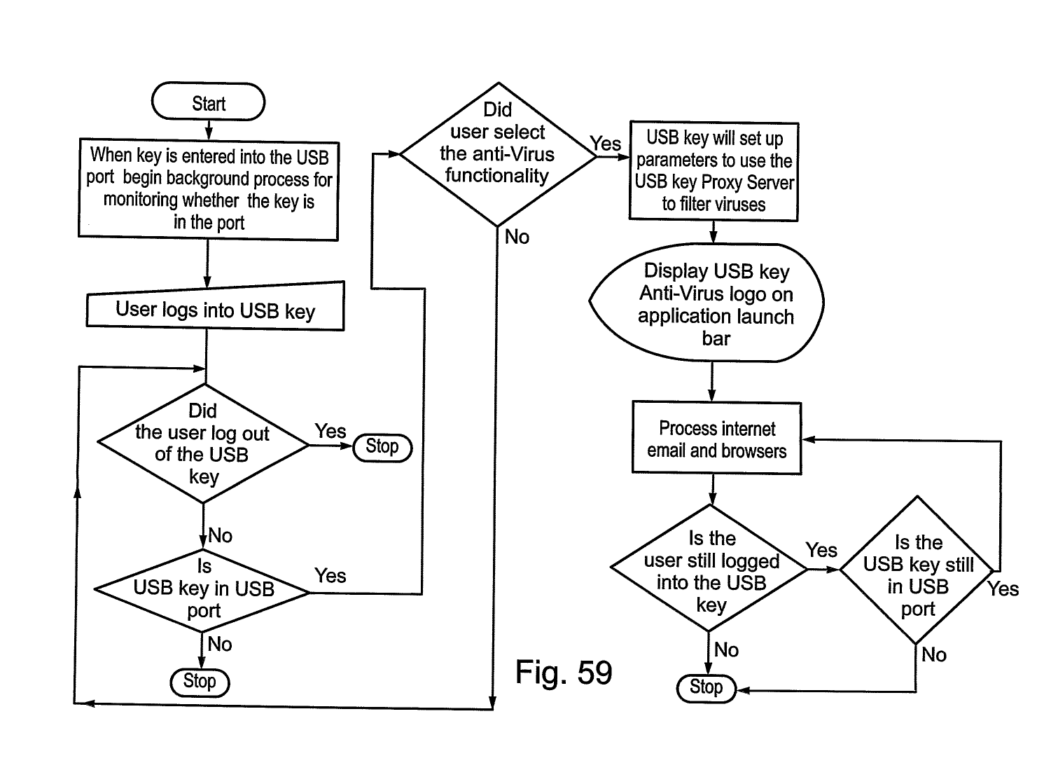

FIG. 58 shows anti-spam features found in portable session management device 114. FIG. 59, shows anti-virus features found in portable session management device 114. The anti-spam and anti-virus features, for example, comprise any of the many spam and virus protection that are readily available today and well known to those familiar with the art.

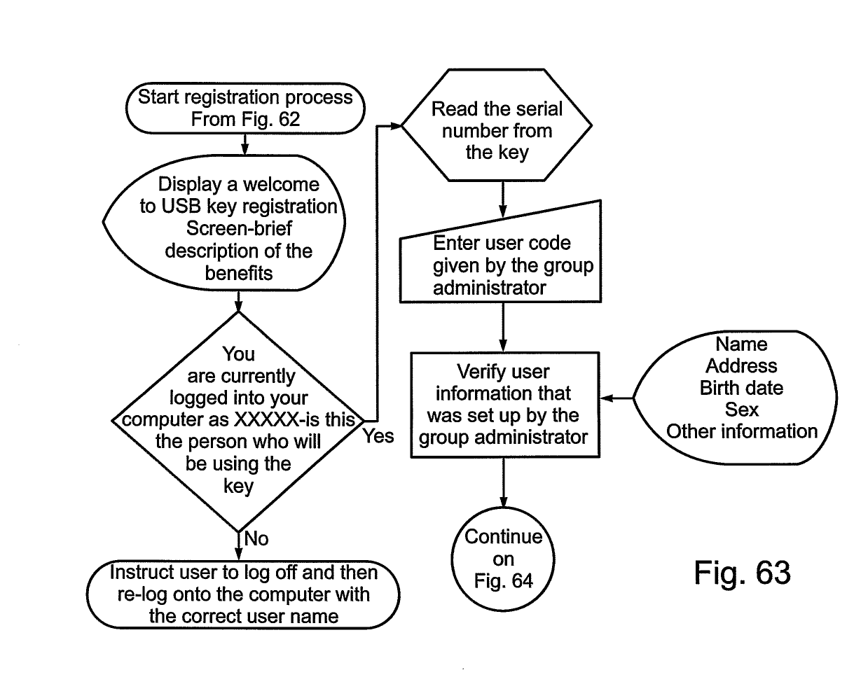

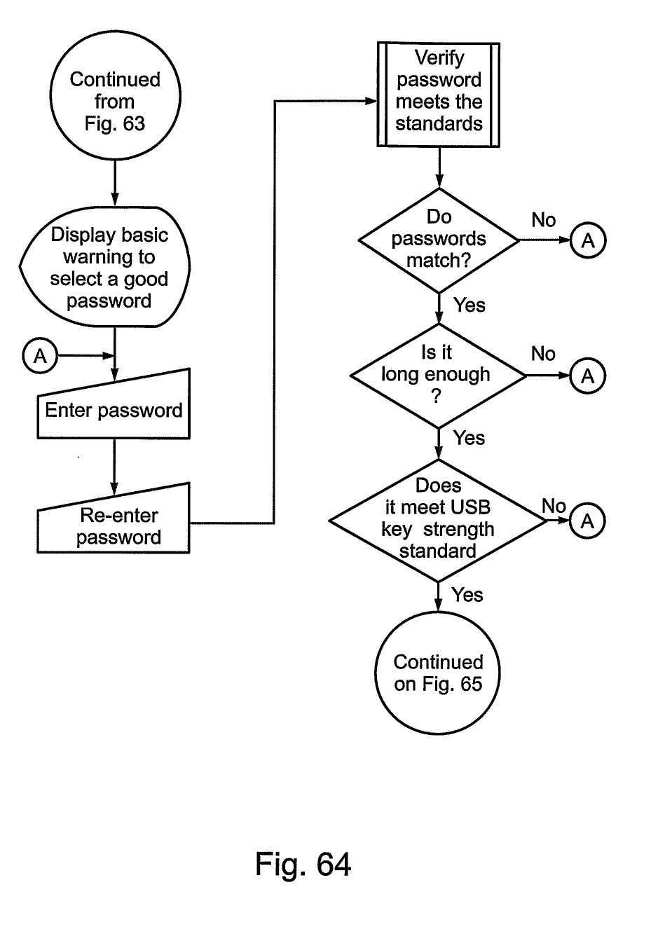

FIG. 62 shows receipt of portable session management device 114 and registration process. The user inserts portable session management device 114 into a USB port found on the computer and is prompted to make a decision as to continue on to the registration process as seen in FIG. 63.

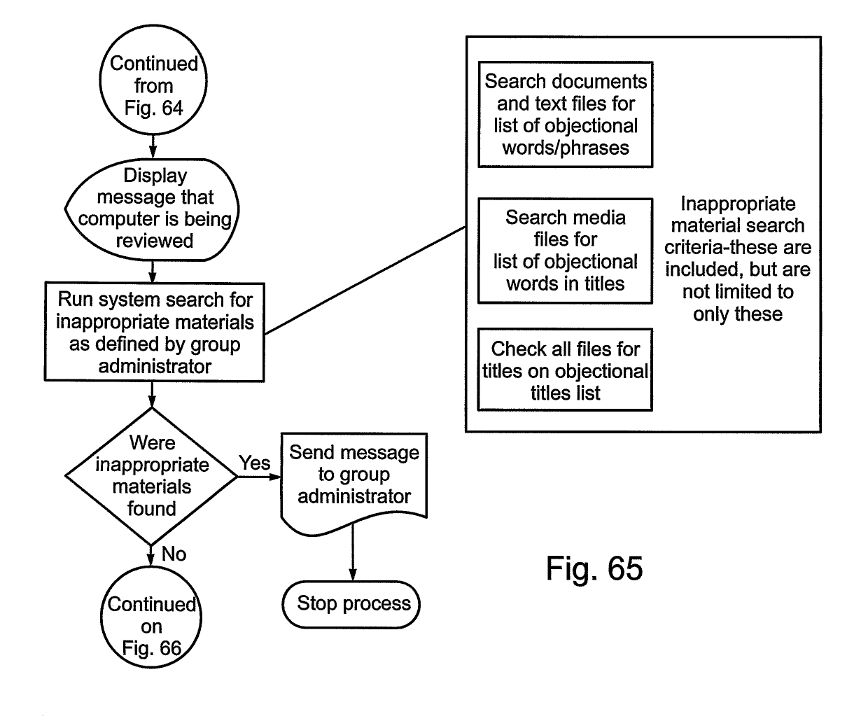

In FIG. 64, registration authenticates the identity of the user and the user selects a login of sufficient length and strength necessary to meet the minimum requirements required by either company policy or federal regulation.

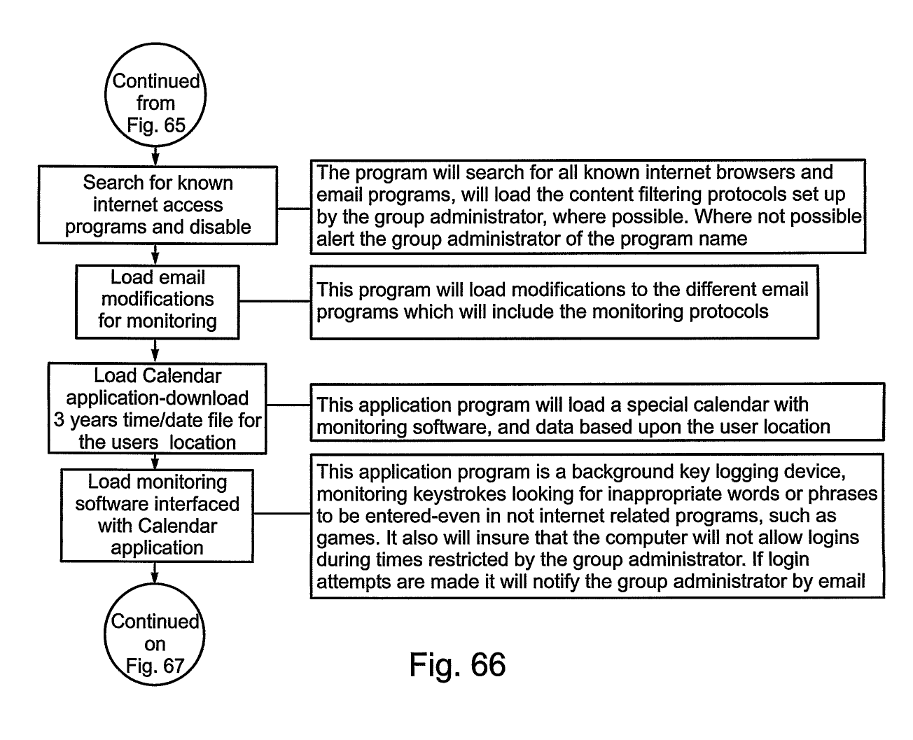

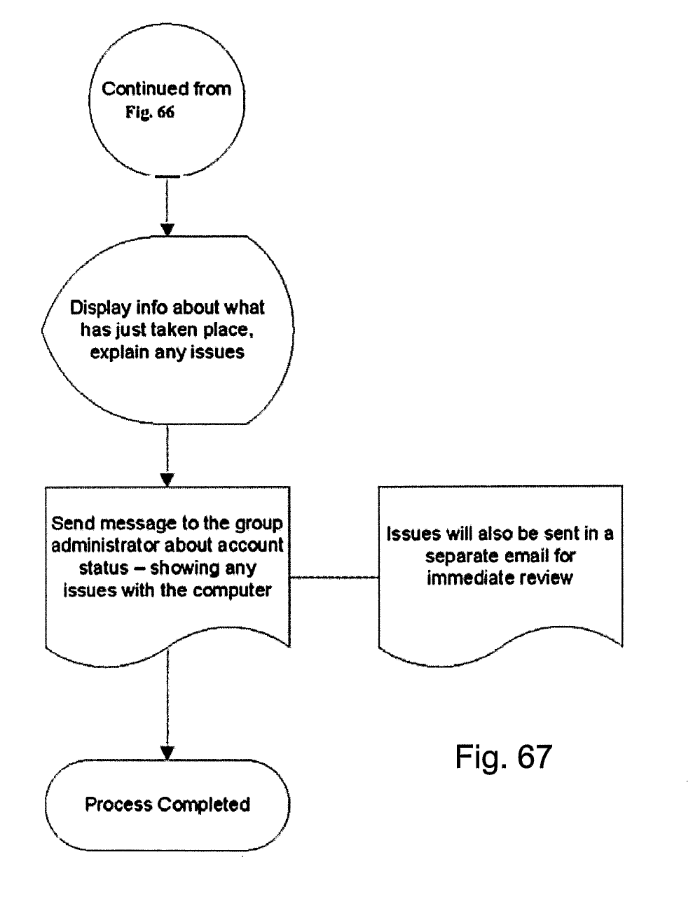

In FIG. 65 the process of searching the system and authenticating that the system is without inappropriate materials is completed. In FIG. 66 the process of loading background services and base computer modifications is completed, these services and modifications are necessary in the complete monitoring and securing of the computer.

In FIG. 67 a summary is shown to the user about the features that have been included on the USB flash drive and the registration process ends.

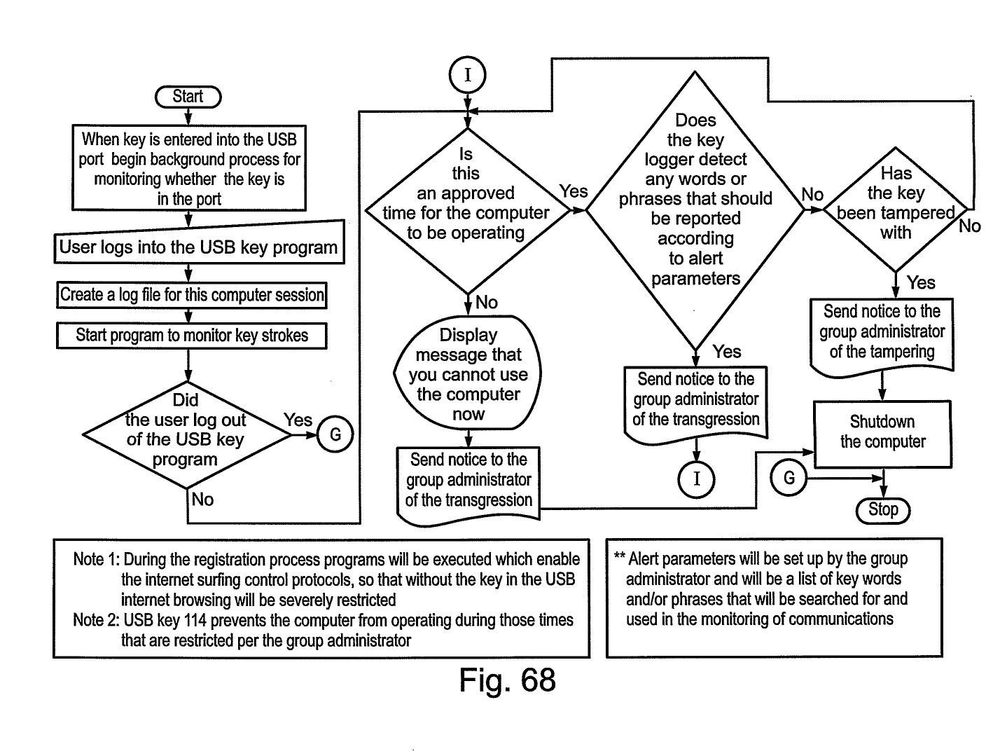

FIG. 68 shows a procedure for monitoring the user computer by a system administrator, for example on a school-based network, for inappropriate use; either in content or in a manner that it is not a proper time to use it according to the group administrator.

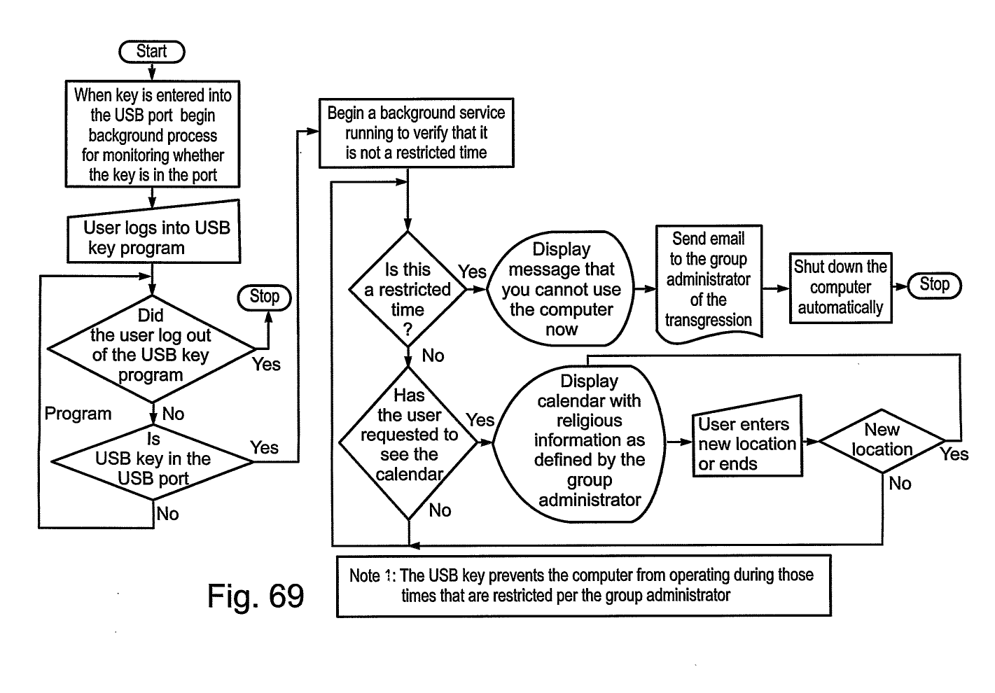

FIG. 69 shows a procedure for implementing a calendar found on the USB flash drive that is interfaced with the operating system to authenticate that it is a proper time to use the computer and optionally provides the user with multiple time zones around the world.

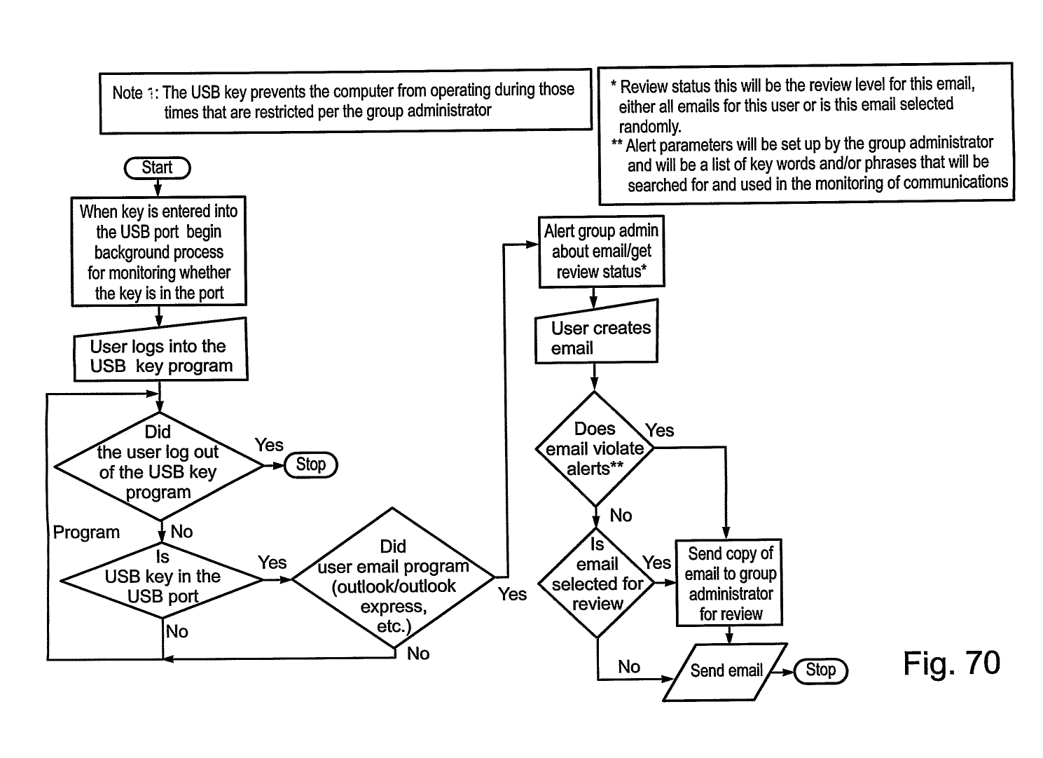

FIG. 70 shows a procedure for monitoring e-mail for improper content as determined by the group administrator. The group administrator optionally monitors e-mail on a specific individual or on a random basis.

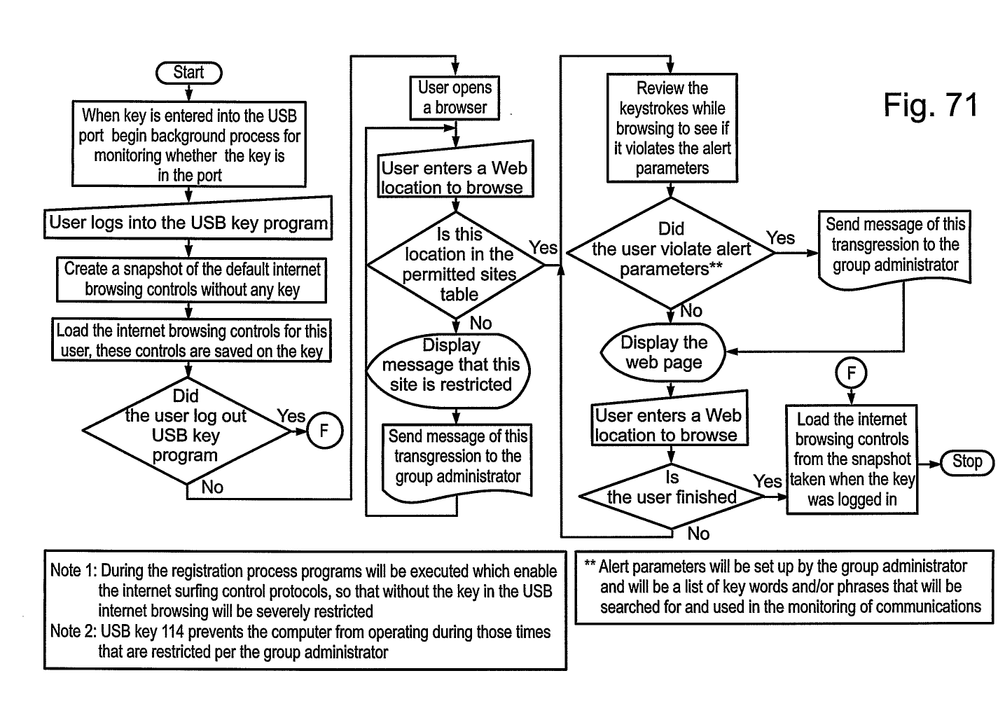

FIG. 71 shows a procedure for controlling where a user in a group of users may browse on the Internet, based upon privileges granted by the group administrator.

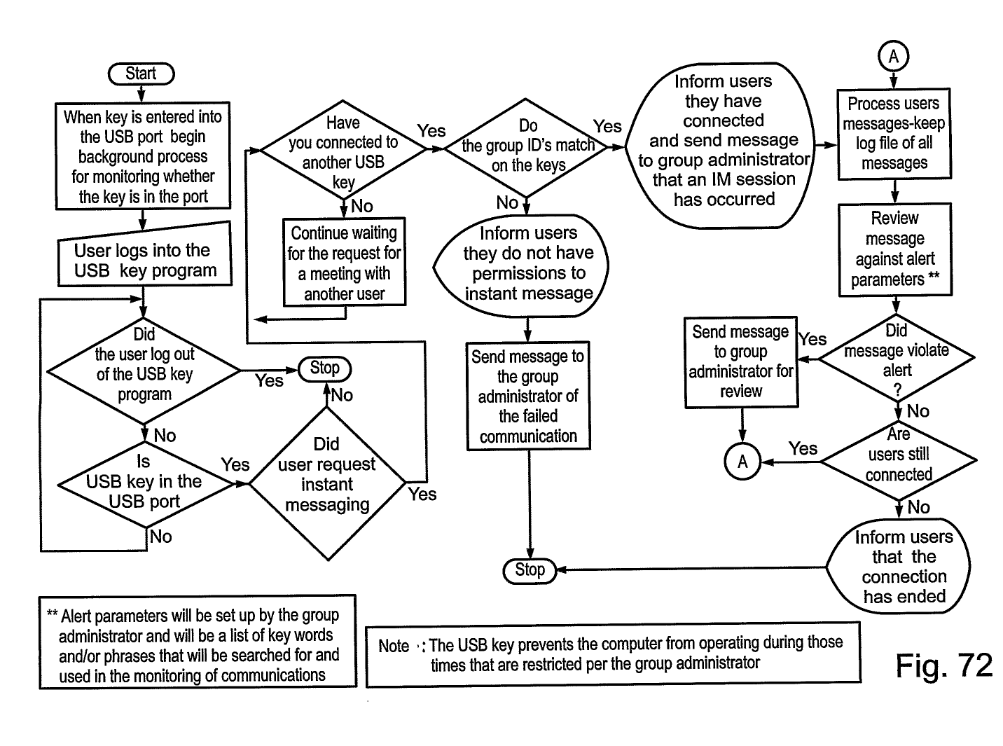

FIG. 72 shows a process of engaging in an instant messaging session with members of a designated group as well as monitoring the instant messaging for proper content by the group administrator.

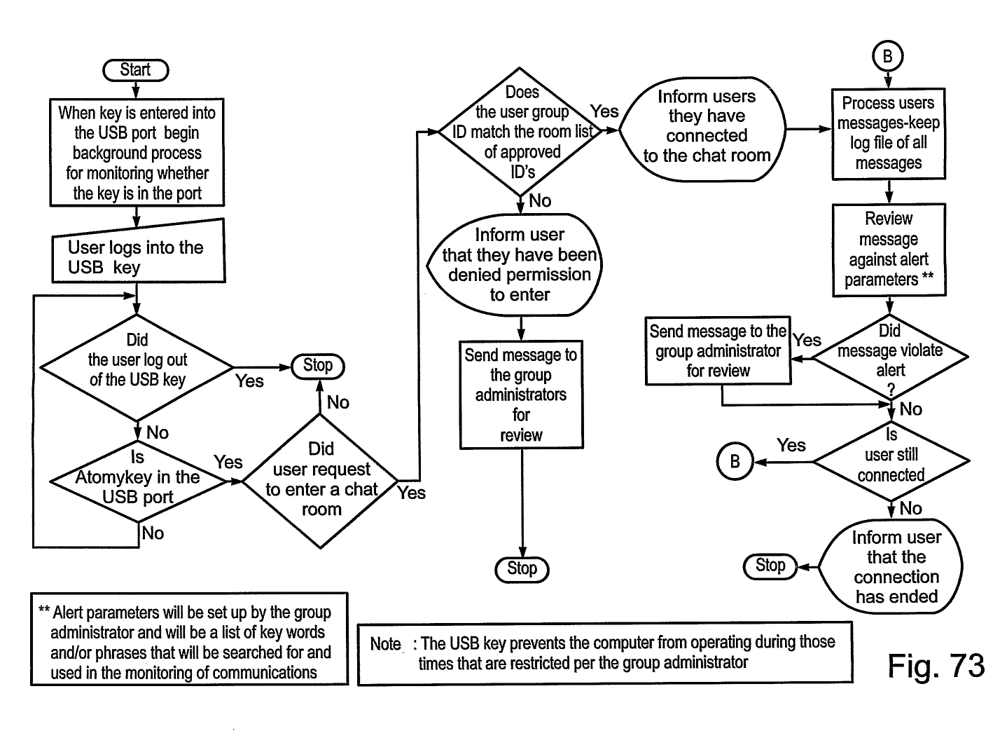

FIG. 73 shows a process of engaging in a chatting session with members of a designated group as well as monitoring the chatting sessions for proper content by the group administrator.

It is expected that during the life of this patent, many relevant portable session management devices, USB key devices and/or alternative digital data transfer mechanism will be developed and the scope of the terms “portable session management device” and “USB key” is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-64. (canceled)

65. A portable session management device configured for insertion into an input on a host computer, the portable session management device comprising:
i) an authentication unit configured to obtain authentication of a user portable session management device with respect to said host computer;
ii) a safe access unit operatively associated with said authentication unit and configured to facilitate safe access to at least one computer-based application in conjunction with said host computer; and
iii) a concealing engine configured to operate with said host computer and configured to conceal a portion of data thereon after expiration of authentication by said authentication unit.

66. The portable session management device according to claim 65, configured to reveal said concealed portion upon re-authentication.

67. The portable session management device according to claim 65, wherein said concealed portion of data comprises a data partition configured by said device.

68. The portable session management device according to claim 65, further comprising a concealed encryption engine configured to encrypt at least a portion of said portion of data.

69. The portable session management device according to claim 68, wherein said at least a portion of said portion of data is encrypted.

70. The portable session management device according to claim 69, configured to unencrypt said encrypted data on said host computer provided said user authentication is in force.

71. The portable session management device according to claim 65, including a backup manager configured, conditionally upon said user authentication, to open communication with a remote server through the host computer to allow data backup operations on the remote server.

72. The portable session management device according to claim 65, including a backup manager configured, conditionally upon said user authentication, to open communication with a server through the host computer to allow data backup operations on the server.

73. The portable session management device according to claim 71, wherein said backup is continuous while said authentication is in force.

74. The portable session management device according to claim 71, wherein said data backup operations are based upon user-selected parameters.

75. The portable session management device according to claim 74, wherein said at least a portion of said data backup operations are provided incrementally.

76. The portable session management device according to claim 65, configured to establish a connection with a proxy server.

77. The portable session management device according to claim 71, wherein said server is located at a remote location with respect to said host computer.

78. The portable session management device according to claim 77, configured to communicate with said server at said remote location using at least one of:
a) a wide area network;
b) an Internet channel;
c) a server; and
d) a proxy server.

79. The portable session management device according to claim 65, wherein said authentication includes a digital string comprising at least one of:
a) a session management device identifier;
b) a user login name; and
c) a user password.

80. The portable session management device according to claim 79, configured to hash said digital string on at least one of:
a) said portable session management device;
b) said host computer;
c) a proxy server; and
d) said server.

81. The portable session management device according to claim 79, wherein said portable session management device is configured to register said digital string with a registration entity.

82. The portable session management device according to claim 81, wherein said device authentication is configured to be optionally invalidated by said registration entity.

83. The portable session management device according to claim 65, further configured to conceal a session of Internet surfing from an inspection carried out from said host computer.

84. The portable session management device according to claim 65, further configured to authorize payment for at least one item to be purchased electronically using funds from a digital banking station.

85. The portable session management device according to claim 84, further configured to provide at least one of:
a) fund a digital banking station with funds from a user-designated digital funding source; and
b) supply a physical location to receive shipment of said at least one item.

86. The portable session management device according to claim 65, configured to shut down said host computer when said authentication is not obtained.

87. The portable session management device according to claim 65, configured to maintain a record of access when said authentication is not obtained.

88. The portable session management device according to claim 87, wherein said record is maintained on at least one of:
a) a portable session management device;
b) said host computer;
c) a proxy server; and
d) a server.

89. A method of providing session management, comprising the steps of:
i) plugging a portable session management device into a host computer;
ii) obtaining authentication that said portable session management device is allowed to access said host computer;
iii) accessing at least one computer-based application using said host computer, conditionally upon said authentication and
iv) concealing a portion of data on said host computer.
